(19) United States
(12) Patent Application Publication
(10) Pub. No.: US 2026/0238484 A1
(43) Pub. Date: Aug. 13, 2026

(54) BLOCKCHAIN-AUTHENTICATED DYNAMIC AUTHORIZATION FOR ARTIFICIAL INTELLIGENCE AGENTS

(71) Applicant: TOKENFORM LLC, Denver, CO (US)

(72) Inventors: Jeffrey Binder, Denver, CO (US); Charles Hasek, Denver, CO (US); Lindsay Gardner, West Hollywood, CA (US)

(21) Appl. No.: 19/650,248

(22) Filed: Apr. 16, 2026

Related U.S. Application Data
(63) Continuation-in-part of application No. 18/221,620, filed on Jul. 13, 2023.
(60) Provisional application No. 63/389,633, filed on Jul. 15, 2022.

(51) Int. Cl. H04L 9/32; G06Q 20/36; H04L 9/08

(52) U.S. Cl. CPC H04L 9/3213; G06Q 20/36; H04L 9/088; G06Q 2220/00

(57) ABSTRACT

Control of artificial intelligence agents uses dynamic authentication. Dynamic authorization for artificial intelligence agents may use non-fungible tokens and/or blockchain for authentication. The blockchain-authenticated dynamic authorization may combine a variety of different techniques. These may include, but are not limited to, cryptographic session binding, dual-layer enforcement architecture, kernel-level runtime integration, multi-chain token verification across public, private, and hybrid blockchain networks, large language model (LLM) -powered permission parsing, dual verification requirements, atomic token reissue, fail-closed operation, hierarchical delegation, temporal and geographic permission scoping, permission composition, privacy-preserving verification, cross-agent permission inheritance, and/or other mechanisms.

### CROSS-REFERENCE TO RELATED APPLICATION

This application is a continuation-in-part patent application of U.S. application Ser. No. 18/221,620, filed Jul. 13, 2023 and titled “Non-Fungible Token Authentication”, and claims the benefit of U.S. Provisional Patent Application No. 63/389,633, filed Jul. 15, 2022, and titled “Non-Fungible Token Authentication,” the contents of which are incorporated herein by reference in their entirety.

### FIELD

The described embodiments relate generally to authorization and access control in artificial intelligence computing environments. More specifically, the present embodiments relate to blockchain-based permission token systems.

### BACKGROUND

A blockchain is a distributed ledger that is shared among nodes of a decentralized computer network. Blockchains are similar to databases in that they store information electronically in digital format. However, unlike a database, blockchains collect information together in groups, known as blocks. As blocks are filled they are closed, timestamped, and linked to a previously filled block. This data structure inherently makes an irreversible timeline of data when implemented in a decentralized nature.

One use of blockchains is to store non-fungible tokens (NFTs). NFTs are cryptographic assets on a blockchain with unique identification codes and metadata that distinguish them from each other. NFTs are typically used to represent rights to real world assets, such as artworks. NFTs are associated with a smart contract stored on the blockchain that controls transactions that can be performed with the NFTs and who can perform them. NFTs are accessible using private and/or public keys stored in a local and/or cloud-based token wallet assigned to the owner of the respective NFT, and ownership is tracked on the blockchain.

### OVERVIEW

The present disclose relates to blockchain-authenticated dynamic authorization for artificial intelligence (AI) agents. The blockchain-authenticated dynamic authorization may combine cryptographic session binding, dual-layer enforcement architecture, kernel-level runtime integration, multi-chain token verification across public, private, and hybrid blockchain networks, large language model (LLM)-powered permission parsing, dual verification requirements, atomic token reissue, fail-closed operation, hierarchical delegation, temporal and geographic permission scoping, permission composition, privacy-preserving verification, and/or cross-agent permission inheritance.

In various embodiments, a system for authorizing actions of an artificial intelligence agent includes a permission access token stored as a non-fungible digital asset on at least one blockchain network, the permission access token encoding a permission schema defining a scope of authorized actions for the artificial intelligence agent, the permission access token further encoding an agent session identifier and an agent wallet address, the agent session identifier being cryptographically bound to the permission access token by a digital signature such that the permission access token is non-transferable to a different agent session; an enforcement proxy interposed between the artificial intelligence agent and one or more protected resources that intercepts a request from the artificial intelligence agent directed to at least one of the one or more protected resources; verifies, via the at least one blockchain network, that the agent wallet address is associated with a current session of the artificial intelligence agent associated with the permission access token; verifies that the agent session identifier encoded in the permission access token corresponds to the current session of the artificial intelligence agent by performing a signature challenge-response verification; determines whether the request is within the scope of authorized actions defined by the permission schema; authorizes the request at least when the agent wallet address is associated with the current session of the artificial intelligence agent associated with the permission access token, the agent session identifier encoded in the permission access token corresponds to the current session of the artificial intelligence agent, and the request is within the scope of authorized actions defined by the permission schema; and denies the request at least when the agent wallet address is not associated with the current session of the artificial intelligence agent associated with the permission access token, the agent session identifier encoded in the permission access token does not correspond to the current session of the artificial intelligence agent, or the request is not within the scope of authorized actions defined by the permission schema; and an audit module that records verification events and authorization events as immutable transactions on the at least one blockchain network.

In some examples, the enforcement proxy implements a hard enforcement layer that enforces data rules at the enforcement proxy external to the artificial intelligence agent, the data rules being non-bypassable by the artificial intelligence agent, and a soft enforcement layer that injects behavioral directives into data responses provided to the artificial intelligence agent. In a number of implementations of such examples, the data rules of the hard enforcement layer include at least one of field-level return filtering specifying fields to include or exclude from the data responses; redaction patterns applied to the data responses; an allowed recipients list limiting recipients to which the artificial intelligence agent may direct communications; a blocked recipients list prohibiting the artificial intelligence agent from directing communications to specified recipients; rate limits specifying a maximum number of requests within a defined time window; or a maximum results threshold limiting a quantity of records returned in a single response. In various implementations of such examples, the behavioral directives of the soft enforcement layer include at least one of a purpose statement defining an authorized purpose for use of data accessed by the artificial intelligence agent; an allowed behaviors list specifying permitted actions; a forbidden behaviors list specifying prohibited actions; a disclosure text requirement for inclusion in agent-generated output; or an audit level specification. In some implementations of such examples, the data rules of the hard enforcement layer are enforced at the enforcement proxy.

In a number of examples, the system further includes a token verification module embedded within a runtime execution layer of the artificial intelligence agent that intercepts tool calls generated by a large language model of the artificial intelligence agent and performs on-chain verification of the permission access token prior to execution of the tool calls. In various implementations of such examples, the tool calls intercepted by the token verification module include at least one of a file read operation; a file write operation; a shell command execution; a network request; a message transmission; a browser control action; and a sub-agent spawning. In some implementations of such examples, the artificial intelligence agent operates in a sandboxed environment in which the large language model lacks direct access to an operating system of a host computing device; the runtime execution layer of the artificial intelligence agent is an exclusive interface between the large language model and the operating system; and secure shell access to an operating system user account under which the runtime execution layer of the artificial intelligence agent executes is unavailable to the artificial intelligence agent. In a number of implementations of such examples, the runtime execution layer of the artificial intelligence agent performs a binary integrity self-check at startup by computing a cryptographic hash of a binary executable of the runtime execution layer of the artificial intelligence agent; retrieving an expected hash value from the at least one blockchain network; and terminating the runtime execution layer of the artificial intelligence agent prior to executing any agent operations responsive to a lack of correspondence between the cryptographic hash and the expected hash.

In various examples, the at least one blockchain network includes multiple blockchain networks and the system further includes a chain-agnostic verification proxy that interfaces with multiple blockchain-specific adapter modules, each of the multiple blockchain-specific adapter modules implementing chain-specific verification logic for a respective blockchain network of the multiple blockchain networks and presenting a unified verification interface to the enforcement proxy regardless of which of the multiple blockchain networks stores the permission access token. In some implementations of such examples, the multiple blockchain networks include at least two of a public blockchain network, a private blockchain network, a permissioned blockchain network and a hybrid blockchain network including both public and private components; and each of the multiple blockchain networks supports non-fungible digital asset creation with metadata encoding capability. In a number of implementations of such examples, the permission schema encoded in the permission access token has an identical format in the multiple blockchain networks. In various implementations of such examples, the multiple blockchain networks include at least one private blockchain network or permissioned blockchain network that operates a consensus mechanism among a defined set of validator nodes and the chain-specific verification logic implemented by a blockchain-specific adapter module for the at least one private blockchain network or permissioned blockchain network of the multiple blockchain-specific adapter modules includes authentication with an access control layer of the at least one private blockchain network or permissioned blockchain network. In a number of implementations of such examples, the multiple blockchain networks include a hybrid blockchain architecture in which permission access token minting and revocation transactions are recorded on a public blockchain network and permission schema content and verification events are recorded on a private blockchain network or a permissioned blockchain network.

In some examples, the system further includes a hierarchical delegation module that receives, from a first permission access token holder, a delegation request specifying a subset of a first permission schema of a first permission access token; mints a second permission access token encoding the subset of the permission schema of the first permission access token as a delegated permission schema, the second permission access token further encoding a reference to the first permission access token as a parent token identifier; transfers the second permission access token to a second agent wallet address of a second artificial intelligence agent; and enforces that the delegated permission schema of the second permission access token is a strict subset of the first permission schema of the first permission access token. In various implementations of such examples, the hierarchical delegation module implements cascading revocation where revocation of the first permission access token invalidates the second permission access token and any further descendant permission access tokens in a delegation chain.

In a number of examples, the permission schema further encodes temporal constraints including at least one of a time-of-day restriction specifying hours during which the permission access token is valid; a day-of-week restriction specifying days during which the permission access token is valid; and a temporal window defining a start time and end time between which the permission access token is active; wherein the enforcement proxy denies the request responsive to a timestamp source independent of the artificial intelligence agent indicating that a current time is outside the temporal constraints. In various examples, the permission schema further encodes geographic constraints or jurisdictional constraints specifying at least one of permitted jurisdictions from which data may be accessed; data residency requirements restricting where response data may be processed or stored; and network origin restrictions specifying permitted IP address ranges or geographic regions; wherein the enforcement proxy denies the request responsive to a violation of the geographic constraints or the jurisdictional constraints. In some examples, the artificial intelligence agent is associated with permission access tokens issued by different issuing authorities; the enforcement proxy computes an effective permission scope by applying a composition policy to the permission access tokens, the composition policy being one of an intersection policy or a union policy, and authorization events are recorded against a respective permission access token of the permission access tokens. In a number of examples, the system further includes a privacy-preserving verification module that generates a zero-knowledge proof demonstrating that the permission access token authorizes a specific requested action and verifies the zero-knowledge proof at the enforcement proxy to authorize the request or deny the request based at least on the validity of the zero-knowledge proof.

In various examples, the system further includes a cached verification module that stores, in a local cache at the enforcement proxy, a time-bounded verification result including a cached permission schema and a time-to-live value, the time-to-live value being set by an issuing authority and being non-modifiable by the artificial intelligence agent; for subsequent requests within the time-to-live value, authorizes the request or denies the request based at least on the cached permission schema without querying the blockchain network; and invalidates the cached verification result responsive to receipt of a revocation event from the blockchain network or expiration of the time-to-live value. In some examples, the artificial intelligence agent spawns one or more sub-agents and the system further includes a cross-agent permission inheritance module that derives, from a spawning agent permission access token of the artificial intelligence agent, a respective sub-agent permission access token for each of the one or more sub-agents, the respective sub-agent permission access token encoding a subset permission schema that is a subset of a spawning agent permission schema of the spawning agent; links the respective sub-agent permission access token to the spawning agent permission access token via a parent token reference on the blockchain network; and records, in the audit module, a linked audit trail associating actions of each of the one or more sub-agents with the spawning agent's permission access token.

In some examples, the system further includes a large language model-powered permission parsing module that receives a natural language description of permissions from an administrator; processes the natural language description using a large language model to generate a structured permission schema in a machine-readable format; and encodes the structured permission schema into the permission access token on the at least one blockchain network. In various implementations of such examples, the large language model-powered permission parsing module presents the structured permission schema to the administrator prior to encoding the structured permission schema into the permission access token.

In a number of examples, the permission schema is stored on-chain within the permission access token on the at least one blockchain network and off-chain at off-chain storage associated with the at least one protected resource; wherein the enforcement proxy denies the request responsive to lack of correspondence between the permission schema stored on-chain and the permission schema stored off-chain. In some implementations of such examples, the permission schema stored on-chain is updatable independently of the permission schema stored off-chain.

In various examples, the system further includes an atomic reissue module that updates the permission schema by executing an atomic transaction group on the at least one blockchain network, the atomic transaction group including a revocation transaction revoking the existing permission access token and a minting transaction minting a new permission access token encoding an updated permission schema. In some examples, the enforcement proxy denies the request responsive to any of the at least one blockchain network being unreachable; a failure to find the permission access token on the at least one blockchain network or of the signature challenge-response verification; a parse error in the permission schema; or an unexpected error condition. In a number of examples, the at least one blockchain network supports a native clawback mechanism and the system further includes an instant revocation module that revokes the permission access token by executing a clawback transaction that transfers the permission access token from the agent wallet address to an issuer address, the clawback transaction being executable without consent of the artificial intelligence agent. In various examples, for each of the authorization events the audit module creates recorded authorization events by recording at least an actor identity; a timestamp attested by the at least one blockchain network; an action description; and a result indication; wherein the recorded authorization events are independently verifiable by a third party having access to the at least one blockchain network without requiring records from an operator of the system. In a number of examples, the enforcement proxy is deployable in a plugin mode where the enforcement proxy operates as a middleware layer external to a runtime environment of the artificial intelligence agent or a kernel mode where a token verification module is embedded within the runtime environment of the artificial intelligence agent; wherein the permission access token format and the permission schema are identical in both the plugin mode and the kernel mode.

In some embodiments, a method for authorizing actions of an artificial intelligence agent includes minting a permission access token as a non-fungible digital asset on a blockchain network, the permission access token encoding a permission schema defining a scope of authorized actions and an agent session identifier cryptographically bound to the permission access token by a digital signature; transferring the permission access token to an agent wallet address associated with a session of the artificial intelligence agent; intercepting, at an enforcement proxy interposed between the artificial intelligence agent and one or more protected resources, a request from the artificial intelligence agent directed to at least one of the one or more protected resources; verifying, by the enforcement proxy via the blockchain network, that the agent wallet address is associated with the permission access token and that the agent session identifier corresponds to the session of the artificial intelligence agent; determining, by the enforcement proxy, whether the request is within the scope of authorized actions defined by the permission schema; responsive to successful verification and the request being within the scope of authorized actions, authorizing the request and forwarding the request to the at least one of the one or more protected resources; responsive to failed verification or the request being outside the scope of authorized actions, denying the request; and recording the verifying and the authorizing as at least one immutable transaction on the blockchain network.

In various examples, the method further includes applying, by the enforcement proxy, hard enforcement data rules to the request and a response from the at least one of the one or more protected resources, the hard enforcement data rules being applied at the enforcement proxy external to the artificial intelligence agent and being non-bypassable by the artificial intelligence agent and injecting, by the enforcement proxy, soft enforcement behavioral directives into an artificial intelligence agent response prior to providing the artificial intelligence agent response to the artificial intelligence agent. In a number of implementations of such examples, applying the hard enforcement data rules includes at least one of filtering fields from the response from the at least one of the one or more protected resources according to a field-level filter specification; redacting data from the response matching one or more redaction patterns; denying the request responsive to a specified recipient being on a blocked recipients list or not on an allowed recipients list; and denying the request responsive to a rate limit being exceeded.

In some examples, the method further includes intercepting, at a token verification module embedded within a runtime execution layer of the artificial intelligence agent, tool calls generated by a large language model of the artificial intelligence agent; for each respective tool call of the tool calls, performing on-chain verification of the permission access token prior to execution of the respective tool call; and denying the respective tool call responsive to the on-chain verification failing. In various implementations of such examples, the method further includes at startup of the runtime execution layer of the artificial intelligence agent, computing a cryptographic hash of a binary executable of the runtime execution layer of the artificial intelligence agent; retrieving an expected hash value from the blockchain network; and terminating the runtime execution layer of the artificial intelligence agent prior to executing any agent operations responsive to the cryptographic hash not corresponding to the expected hash.

In a number of examples, the method further includes receiving, from an administrator, a natural language description of permissions; processing the natural language description using a large language model to generate a structured permission schema; and encoding the structured permission schema into the permission access token on the blockchain network. In various examples, the method further includes storing the permission schema on-chain within the permission access token and off-chain at an off-chain storage associated with the at least one of the one or more protected resources and denying the request responsive to the permission schema stored on-chain not corresponding to the permission schema stored off-chain. In some examples, the method further includes updating the permission schema by executing an atomic transaction group on the blockchain network including a revocation of the permission access token and a minting of a new permission access token encoding an updated permission schema. In a number of examples, the method further includes denying the request responsive to the blockchain network being unreachable. In various examples, the method further includes revoking the permission access token by executing a clawback transaction on the blockchain network that transfers the permission access token from the agent wallet address to an issuer address without consent of the artificial intelligence agent.

In a number of embodiments, a non-transitory computer-readable medium stores instructions that, when executed by one or more processors, cause the one or more processors to mint a permission access token as a non-fungible digital asset on a blockchain network, the permission access token encoding a permission schema defining a scope of authorized actions for an artificial intelligence agent and an agent session identifier cryptographically bound to the permission access token by a digital signature; intercept a request from the artificial intelligence agent directed to a protected resource; verify, via the blockchain network, that the permission access token is associated with a session of the artificial intelligence agent and that the agent session identifier corresponds to the session of the artificial intelligence agent; apply a hard enforcement layer that enforces data rules at a proxy layer external to the artificial intelligence agent, the data rules being non-bypassable by the artificial intelligence agent; apply a soft enforcement layer that injects behavioral directives to the artificial intelligence agent; authorize or deny the request based on at least the permission schema and verifying that the permission access token is associated with the session of the artificial intelligence agent and that the agent session identifier corresponds to the session of the artificial intelligence agent; and record authorization of the request as an immutable transaction on the blockchain network.

In various examples, execution of the instructions by the one or more processors further causes the one or more processors to embed a token verification module within a runtime execution layer of the artificial intelligence agent to cause tool calls generated by a large language model of the artificial intelligence agent to pass through on-chain token verification prior to execution and the artificial intelligence agent operates in a sandboxed environment lacking direct operating system access. In some examples, execution of the instructions by the one or more processors further causes the one or more processors to receive a natural language description of permissions from an administrator; process the natural language description using a large language model to generate the permission schema; and encode the permission schema into the permission access token. In a number of examples, execution of the instructions by the one or more processors further causes the one or more processors to deny the request responsive to occurrence of a failure condition that includes the blockchain network being unreachable or to find the permission access token; a signature verification failure; or a parse error in the permission schema.

In various embodiments, a system for maintaining tamper-proof integrity of electronic records using blockchain tokenization includes an encryption module configured to encrypt an electronic document; a hashing module configured to compute a hash of the electronic document; a signature module configured to generate, using a submitting party key pair of a submitting party, a submitter signature and the hash of the electronic document and generate, using an authorized receiving party key pair of an authorized receiving party, an authorized submitter signature and the hash of the electronic document; and a tokenization module configured to mint a blockchain token on a blockchain network, the blockchain token encoding at least one of the hash of the electronic document, the submitter signature, the authorized submitter signature, a block timestamp attested by consensus of the blockchain network, and a record type classification.

In some examples, the system further includes a verification module configured to retrieve the blockchain token from the blockchain network; decrypt the electronic document; compute a computed hash of the decrypted document; compare the computed hash of the decrypted document to the hash of the electronic document encoded in the blockchain token; and output a verification result indicating whether the electronic document has been modified since tokenization. In a number of examples, the block timestamp is derived from a consensus mechanism of the blockchain network. In various examples, the record type classification is one of a death certificate; a financial statement; a medical record; a legal filing; or a regulatory submission. In some examples, the blockchain token, the submitter signature, and the authorized submitter signature collectively establish a chain of custody that is independently verifiable by a third party having access to the blockchain network.

### BRIEF DESCRIPTION OF THE DRAWINGS

The disclosure will be readily understood by the following detailed description in conjunction with the accompanying drawings, wherein like reference numerals designate like structural elements.

FIG. 1A depicts an example non-fungible token authentication system.

FIG. 1B depicts a flow of using creation and minting of a smart contract and non-fungible token. The flow may be performed by the system of FIG. 1A.

FIG. 1C depicts a list of backend services. The backend services may support and/or be provided by the system of FIG. 1A.

FIG. 1D depicts mint-print-manage functions. The mint-print-manage functions may be performed and/or supported and/or provided by the system of FIG. 1A.

FIG. 2 depicts a flow chart illustrating a first example method for operating a non-fungible token authentication system. This method may be performed by the system of FIG. 1A.

FIG. 3 depicts example relationships among example components that may be used to implement the system of FIG. 1A.

FIG. 4 depicts a flow chart illustrating a second example method for operating a non-fungible token authentication system. This method may be performed by the system of FIG. 1A.

FIG. 5 depicts a flow chart illustrating a third example method for operating a non-fungible token authentication system. This method may be performed by the system of FIG. 1A.

FIG. 6 depicts a flow chart illustrating a fourth example method for operating a non-fungible token authentication system. This method may be performed by the system of FIG. 1A.

FIG. 7 depicts a flow chart illustrating a fifth example method for operating a non-fungible token authentication system. This method may be performed by the system of FIG. 1A.

FIG. 8 depicts a flow chart illustrating a sixth example method for operating a non-fungible token authentication system. This method may be performed by the system of FIG. 1A.

FIG. 9 depicts a flow chart illustrating a seventh example method for operating a non-fungible token authentication system. This method may be performed by the system of FIG. 1A.

FIG. 10 depicts a flow chart illustrating an eighth example method for operating a non-fungible token authentication system. This method may be performed by the system of FIG. 1A.

FIG. 11 is a system architecture diagram illustrating the overall system including the AI agent, enforcement proxy, blockchain network, protected resources, and administrative interface.

FIG. 12 is a detailed diagram illustrating the Permission Access Token (PAT) data structure, including embedded agent session identifier, wallet address, permission schema, signature fields, and blockchain-specific metadata.

FIG. 13 is a sequence diagram illustrating the AI agent session binding process, including session initialization, PAT minting with embedded session identifier, and subsequent session-bound verification.

FIG. 14 is a block diagram illustrating the dual-layer enforcement architecture, showing the separation between hard enforcement (data rules) at the proxy layer and soft enforcement (agent directives) injected to the agent.

FIG. 15 is a flowchart illustrating the request verification process at the enforcement proxy, including PAT ownership verification, permission scope verification, dual verification check, and fail-closed decision logic.

FIG. 16 is a block diagram illustrating the kernel-level runtime integration, showing the AI agent's LLM, the tool execution layer with embedded token verification, the sandbox boundary, and the operating system interface.

FIG. 17 is a diagram illustrating the binary integrity self-check process performed at runtime startup, including hash computation, on-chain hash retrieval, and comparison.

FIG. 18 is a block diagram illustrating the multi-chain verification architecture, showing the chain-agnostic verification proxy interfacing with public, private, and hybrid blockchain networks via blockchain-specific adapter modules.

FIG. 19 is a sequence diagram illustrating the LLM-powered permission parsing workflow, from natural language input through LLM processing to structured permission schema generation and on-chain encoding.

FIG. 20 is a sequence diagram illustrating the atomic reissue process, showing the atomic transaction group including the burn of the old PAT and the minting of the new PAT.

FIG. 21 is a block diagram illustrating the dual verification architecture, showing on-chain permission storage, off-chain endpoint configuration, and the comparison logic.

FIG. 22 is a diagram illustrating the clawback-based or burn-based instant revocation mechanism, including the revocation transaction and ownership transfer or destruction.

FIG. 23 is a sequence diagram illustrating the comprehensive on-chain audit trail, showing various authorization events being recorded as blockchain transactions.

FIG. 24 is a block diagram illustrating the dual product architecture (plugin mode vs. kernel mode), showing deployment configurations and the shared token format.

FIG. 25 is a data flow diagram illustrating the document integrity system showing encryption, hashing, tokenization, and subsequent verification processes.

FIG. 26 is a diagram illustrating the fail-closed decision tree, showing all failure conditions and the default-deny outcome for each.

FIG. 27 is a block diagram illustrating the hierarchical token delegation architecture, showing parent permission access tokens, delegated child tokens, permission subset enforcement, and cascading revocation paths.

FIG. 28 is a diagram illustrating temporal and geographic permission scoping, showing time-window constraints, day-of-week restrictions, and jurisdictional boundaries applied to a permission access token.

FIG. 29 is a block diagram illustrating permission composition, showing an agent holding multiple permission access tokens from different issuers and the computation of effective permissions via intersection or union policies.

FIG. 30 is a sequence diagram illustrating privacy-preserving verification using zero-knowledge proofs, showing proof generation, transmission, and verification without revealing the complete permission schema.

FIG. 31 is a block diagram illustrating cached verification with time-bounded local authorization, showing the local cache, time-to-live management, blockchain synchronization, and revocation event invalidation.

FIG. 32 is a flowchart depicting cross-agent permission inheritance for multi-agent workflows, showing a spawning agent deriving sub-agent tokens with inherited permission subsets and linked audit trails.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, apparatuses, and computer program products that embody various elements of the present disclosure. However, it should be understood that the described disclosure may be practiced in a variety of forms in addition to those described herein.

The proliferation of artificial intelligence (AI) agents in enterprise, government, and regulated industries has created an urgent need for robust authorization frameworks. AI agents—autonomous software systems powered by large language models (LLMs) and capable of executing tool calls, accessing data, and performing actions on behalf of human principals—present authorization challenges fundamentally distinct from those addressed by traditional identity and access management (IAM) systems.

Traditional authorization systems, including OAuth 2.0, RBAC (Role-Based Access Control), and ABAC (Attribute-Based Access Control), were designed for human users interacting through well-defined application interfaces. These systems assume that the authorized entity (a human) will respect the spirit of granted permissions and that the application interface constrains the entity's actions. AI agents violate both assumptions: they may be “jailbroken” or manipulated through prompt injection to attempt actions beyond their intended scope, and they interact with computing resources through flexible tool-calling interfaces rather than constrained application user interfaces (UIs).

Existing approaches to AI agent authorization suffer from several critical deficiencies. First, most systems enforce permissions within the agent's own runtime, meaning a compromised or manipulated agent can potentially bypass its own permission checks. Second, permission revocation in conventional systems suffers from propagation delays due to token caching, session management, and distributed system eventual consistency. Third, there is no immutable, independently verifiable audit trail of authorization decisions. Fourth, existing systems lack mechanisms to cryptographically bind a permission grant to a specific agent instance, allowing token theft or replay attacks across agent sessions.

Systems for NFT-based delegation of authority may use a non-fungible token and associated smart contract to encode a scope of delegated authority, store such on a blockchain, and provide such to a delegate's token wallet for subsequent verification during delegated transactions. While such systems may involve blockchain-tokenized delegation, the rapid evolution of AI agent architectures necessitates significant extensions to address the specific challenges of AI agent authorization, which may include session-level binding, dual-layer enforcement that operates independently of agent integrity, kernel-level runtime integration, multi-chain verification, natural language permission specification, and/or fail-closed architectures.

Blockchain technology provides unique properties that address the deficiencies of traditional authorization systems when adapted for AI agent governance. Specifically, blockchain provides: immutability (authorization records cannot be altered post-hoc); independent verifiability (third parties can audit without requesting records from the authorized party); atomic operations (permission grants and revocations execute as indivisible transactions); and, in certain blockchain implementations, native clawback or forced-transfer mechanisms enabling near-instantaneous revocation without the propagation delays inherent in distributed cache invalidation.

Accordingly, there exists a need for an authorization system purpose-built for AI agents that: (a) cryptographically binds permissions to specific agent sessions; (b) enforces permission boundaries at a layer external to and independent of the AI agent itself; (c) integrates verification into the agent's runtime at the tool-execution level; (d) operates across multiple blockchain networks including public, private, and hybrid chains; (e) enables natural language specification of complex permission schemas; (f) implements atomic permission updates without temporal gaps; (g) maintains fail-closed semantics under all failure conditions; (h) produces a comprehensive, immutable, independently auditable record of all authorization events; (i) supports hierarchical delegation across multi-agent workflows; and (j) enables temporal, geographic, and jurisdictional scoping of permissions.

The present disclosure relates to blockchain-authenticated dynamic authorization for AI agents. The blockchain-authenticated dynamic authorization may combine cryptographic session binding, dual-layer enforcement architecture, kernel-level runtime integration, multi-chain token verification across public, private, and hybrid blockchain networks, LLM-powered permission parsing, dual verification requirements, atomic token reissue, fail-closed operation, hierarchical delegation, temporal and geographic permission scoping, permission composition, privacy-preserving verification, and/or cross-agent permission inheritance.

In this way, the present disclosure may provide technological solutions to authentication issues, particularly technological solutions that arise from the technological problems introduced by attempting to perform authentication in a digital environment. A system and/or device using the techniques of the present disclosure may be able to perform authentication and/or other functions that the system and/or device would not previously have been able to perform absent the technology disclosed herein. This may enable the system and/or device to operate more efficiently while consuming fewer hardware and/or software resources as more resource consuming techniques may be omitted. Further, one or more databases and/or other components may be omitted while still enabling authentication and/or other functions, reducing unnecessary hardware and/or software components and providing greater system flexibility and security.

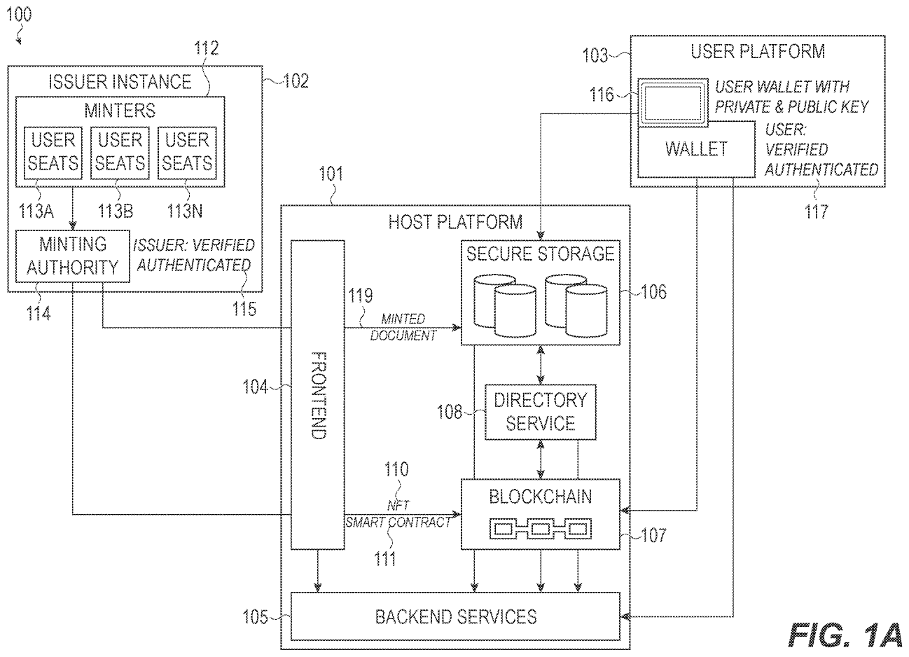

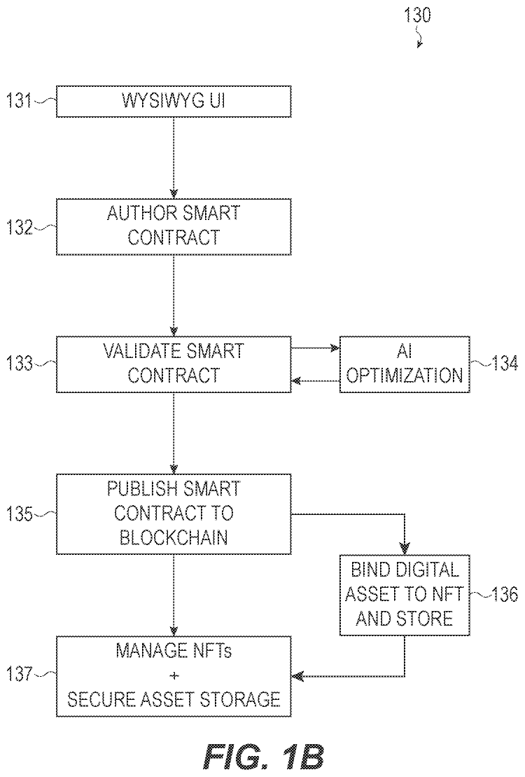

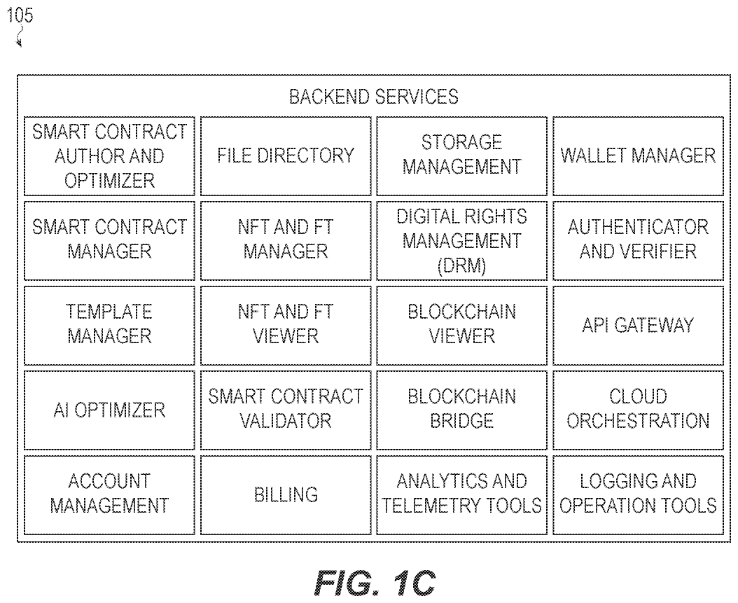

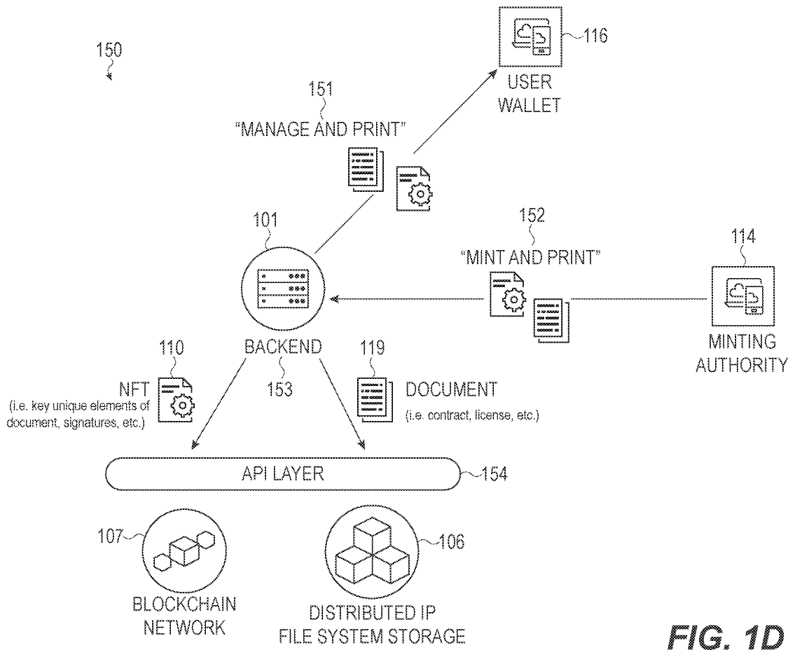

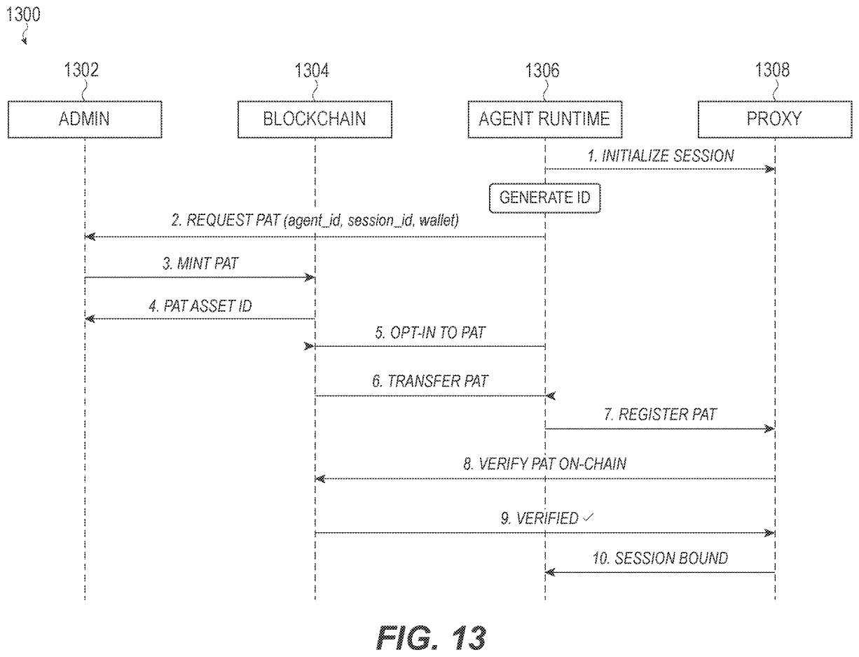

These and other embodiments are discussed below with reference to FIGS. 1A-32 . However, those skilled in the art will readily appreciate that the detailed description given herein with respect to these Figures is for explanatory purposes only and should not be construed as limiting.

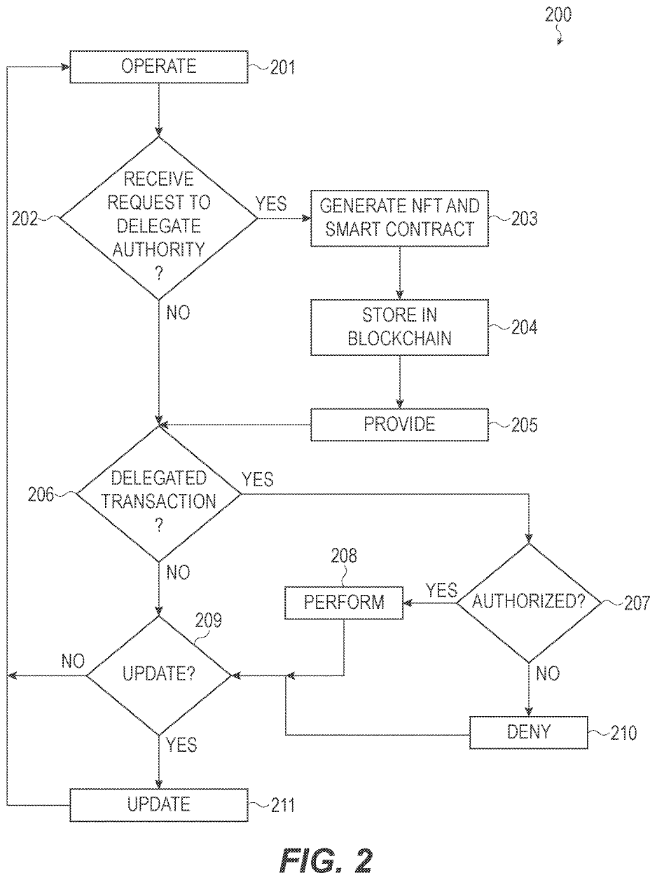

FIG. 1A depicts an example NFT authentication system 100. The system 100 may use NFTs for authentication. The system 100 may generate an NFT 110 and an associated smart contract 111 and store them on a blockchain for authority to be delegated to a delegate on behalf of a delegator. The system 100 may provide the NFT directly and/or indirectly to the delegate, who may use the NFT to authenticate himself in order to act on the delegated authority. Subsequently, the system 100 may allow the NFT to be transferred, revoked, marked expired, and/or otherwise controlled directly and/or indirectly by the delegator in order to control the authority delegated to the delegate. The actions that may be performed with the NFT may be controlled by the smart contract. Examples of such operations are discussed in detail below with respect to FIGS. 2 and 4-10.

The system 100 may include a host platform 101 that is operable to create and/or perform one or more transactions and/or other actions related to one or more NFTs 110, smart contracts 111, and/or minted documents 119 on behalf of and/or for one or more other entities, such as one or more issuer instances 102, user platforms 103, intermediaries (not shown), and so on. Creation of the NFTs 110 may involve creation of one or more smart contracts 111, storage of the smart contracts 111 and/or the NFTs 110 in one or more blockchains, automatic creation and/or maintenance of one or more local and/or cloud-based token wallets (an electronic repository associated with storage of at least one or more private keys associated with one or more NFTs 110 and/or other tokens associated with one or more blockchains), and so on. In some cases, the private keys for the NFTs 110 and/or other encrypted and/or unencrypted data (such as one or more public keys, copies of the NFTs 110, payloads, and so on) may be stored in one or more local and/or cloud-based token wallets. The NFT document platform may also be operable to mint one or more documents, such as one or more birth certificates, contracts and other signed documents, titles (such as house titles, car titles, and so on), prescriptions, licenses and/or identification documents, checks, money, gift cards, and so on. The smart contracts 111 and/or NFTs 110 may correspond to the one or more minted documents 119 and may even be created using data from and/or otherwise associated with the minted documents 119. The NFTs may be usable to authenticate the minted documents 119, as evidence of ownership of the minted documents 119, control the ability to perform transactions regarding the minted documents 119, and so on.

For example, an online tax preparation service may be a first issuer instance 102 and a streaming television and movie service may be a second issuer instance. The online tax preparation service may allow a customer using the user platform 103 to create one or more NFTs and/or associated smart contracts via the host platform 101 to delegate authority to a tax preparation professional to access stored tax information for the customer in order to review the customer's tax forms. The tax professional may not have a token wallet associated with the online tax preparation service. However, the host platform 101 may have automatically created a token wallet associated with the tax professional's email address for the tax professional's streaming television and movie service account in order to store NFTs that the tax professional uses to access streaming television and movie content from the streaming television and movie service. When the customer delegates authority to the tax professional, the customer may provide the tax professional's email address. The host platform 101 may recognize that a token wallet is already associated with that email address and may associate the NFT that is accordingly created with that token wallet. However, token wallets may include hidden areas. When the tax professional accesses the token wallet for the streaming television and movie service, the tax professional may not see the NFT for the online tax preparation service. However, when the online tax preparation service associates the NFT with the token wallet, the tax professional may be sent an email notifying the tax professional that the customer has delegated the authority. The email may include a link to access the customer's tax forms, which may both send a one-time password to the tax professional's email account and prompt the tax professional to enter the sent one-time password. When the tax professional provides the sent one-time password, the online tax preparation service may allow the tax professional to access the customer's tax forms. Various configurations are possible and contemplated without departing from the scope of the present disclosure.

Although the above example is described in the context of an online tax preparation service and a streaming television and movie service, it is understood that this is an example. In various implementations, the techniques of the present disclosure may be used with anything that uses credentials. Various configurations are possible and contemplated without departing from the scope of the present disclosure.

The host platform 101 may include one or more frontends 104 and/or one or more backend services 105. The frontend 104 may include one or more application programming interfaces or “APIs”. Similarly, the backend services 105 may be accessed using one or more APIs. The frontend 104 may be usable by one or more issuer instances 102 to request creation of and/or performance of one or more transactions and/or other actions related to one or more NFTs 110, smart contracts 111, and/or minted documents 119. The frontend 104 may interact with one or more unsecure and/or secure storages 106 and/or one or more blockchains 107 to store one or more NFTs 110, smart contracts 111, minted documents 119, and so on. A directory service 108 may by usable by the host platform 101 to associate assets in the one or more unsecure and/or secure storages 106 and/or one or more blockchains 107. The frontend 104 and/or the one or more blockchains 107 may be communicably connected to the backend services 105.

The issuer instance 102 may include one or more minters 112 that may include one or more user seats 113A-113N, a minting authority 114, an issuer 115, and so on. The issuer 115 may be verified and authenticated by the host platform 101, such as by communication over a verified connection, using multi-factor authentication (such as a login and/or password, a one-time password sent to a known email address and/or other communication address, one or more authenticator apps, and so on), and so on. The minting authority 114 and/or the issuer instance 102 may be communicably connected to the frontend 104.

The user platform 103 may include a user wallet 116 and a user 117. The user wallet 116 may be a token wallet. The user wallet 116 may store one or more private and/or public keys related to one or more NFTs. The user wallet 116 and/or the user platform 103 may be communicably connected to the one more unsecure and/or secure storages 106, one or more blockchains 107, and/or backend services 105. The user 117 may be verified and authenticated by the host platform 101, such as by communication over a verified connection, using multi-factor authentication (such as a login and/or password, a one-time password sent to a known email address and/or other communication address, one or more authenticator apps, and so on), and so on.

FIG. 1B depicts a flow 130 of using creation and minting of a smart contract and non-fungible token. The flow may be performed by the system 100 of FIG. 1A. A what you see is what you get (“WYSIWYG”) and/or other user interface 131 may be provided. The user interface 131 may be used to author one or more smart contracts 132. The authored smart contracts may be validated 133 and/or optimized using artificial intelligence (AI) 134. The validated and/or optimized smart contract (and/or any generated related one or more NFTs) may be published to one or more blockchains 135. A digital asset related to the smart contract may be bound to the one or more NFTs and stored 136. The one or more NFTs may then be managed and the digital asset may be securely and/or otherwise stored 137.

Although the flow 130 illustrates a particular flow, it is understood that this is an example. In other implementations, other flows of the same, similar, and/or different operations may be used. Various configurations are possible and contemplated without departing from the scope of the present disclosure.

FIG. 1C depicts a list of backend services 105. The backend services 105 may support and/or be provided by the system 100 of FIG. 1A. The list may include one or more smart contract authors and/or optimizers, file directories, storage management, wallet managers, smart contract managers, NFT and FT (fungible token) managers, digital rights management (DRM), authenticators and/or verifiers, template managers, NFT and/or FT viewers, blockchain viewers, API gateways, AI optimizers, smart contract validators, blockchain bridges, cloud orchestration, account management, billing, analytics and/or telemetry tools, logging and operation tools, and so on.

Although the list illustrates examples of backend services 105, it is understood that this is an example. In other implementations, other backend services 105 may be used. Various configurations are possible and contemplated without departing from the scope of the present disclosure.

FIG. 1D depicts mint-print-manage functions 150. The mint-print-manage functions 150 may be performed and/or supported and/or provided by the system of FIG. 1A. As shown, a host platform may communicate with a user wallet 116 and/or a minting authority 114 to perform manage and print functions 151 and/or mint and print functions 152. The host platform 101 may use a backend 153 and/or an API layer 154 to store one or more NFTs 110 (which may include key unique elements of one or more minted documents 119, signature, and so on) in one or more blockchain networks 107 and/or one or more minted documents 119 (such as one or more contracts, licenses, and so on) in a distributed internet protocol file system storage and/or other unsecure and/or secure storage 106.

Although the mint-print-manage functions 150 are illustrated and described with a particular configuration, it is understood that this is an example. In other implementations, other configurations of the same, similar, and/or different operations may be used. Various configurations are possible and contemplated without departing from the scope of the present disclosure.

Returning to FIG. 1A, although the system 100 is illustrated and described as including particular components arranged in a particular configuration, it is understood that this is an example. In a number of implementations, various configurations of various components may be used without departing from the scope of the present disclosure.

For example, the system 100 is illustrated and described as the user platform 103 including the user wallet 116. However, it is understood that this is an example. In various implementations, the system 100 may include host platform 101 that automatically generates and/or maintains one or more local and/or cloud-based token wallets, such as token wallets associated with one or more communication addresses (such as one or more email addresses, telephone numbers, social media messaging addresses, and so on) of one or more users. This may increase the likelihood that users will use the system 100 as the users do not have to know how to create token wallets, as well as simplifying user interfaces and improving the operation of computing devices used to implement the system 100. Various configurations are possible and contemplated without departing from the scope of the present disclosure.

FIG. 2 depicts a flow chart illustrating a first example method 200 for operating an NFT authentication system. This method may be performed by the system 100 of FIG. 1A.

At operation 201, an electronic device (such as one or more computing devices associated with the host platform 101 of FIG. 1A, the issuer instance 102 of FIG. 1A, the user platform 103 of FIG. 1A, and/or another device or system) may operate. The flow may proceed to operation 202 where the electronic device may determine whether or not a request to delegate authority is received. If a request to delegate authority is received, the flow may proceed to operation 203. Otherwise, the flow may proceed to operation 206.

At operation 203, after the electronic device determines a request to delegate authority is received, the electronic device may generate one or more NFTs and one or more associated smart contracts. Such an NFT may include and/or link to login details and/or other authorization information and/or permissions that enable one or more actions relating to the delegated authority.

The flow may proceed to operation 204 where the electronic device may store the NFT and/or the smart contract in one or more blockchains. The flow may then proceed to operation 205 where the electronic device may provide the NFT. For example, the electronic device may send the NFT to a local and/or cloud-based token wallet associated with the delegate. By way of another example, the electronic device may send the NFT to a local and/or cloud-based token wallet associated with the delegator, the requestor, and so on who may then transfer the NFT to a local and/or cloud-based token wallet associated with the delegate. The flow may then proceed to operation 206.

At operation 206, the electronic device determines whether or not one or more requests to perform one or more delegated transactions are received. A delegated transaction may be any action or task that requires use of the delegated authority. If one or more requests to perform delegated transactions are received, the flow may proceed to operation 207. Otherwise, the flow may proceed to operation 209.

At operation 207, after the electronic device determines that one or more requests to perform one or more delegated transactions are received, the electronic device may determine whether or not the one or more requests to perform the one or more delegated transactions are authorized. The electronic device may determine that the one or more requests to perform the one or more delegated transactions are authorized if an NFT corresponding to delegated authority for performing the one or more delegated transactions is assigned to a token wallet associated with the requestor and/or a device from which the request is received. If so, the flow may proceed to operation 208 where the electronic device performs the one or more delegated transactions before the flow proceeds to operation 209. Otherwise, the flow may proceed to operation 210 where the electronic device may deny the one or more requests to perform one or more delegated transactions before the flow proceeds to operation 209.

At operation 209, the electronic device may determine whether or not to update one or more NFTs. If updating the one or more NFTs is determined, the flow may proceed to operation 211 where the electronic device may update the one or more NFTs before the flow returns to operation 201 where the electronic device continues to operate. Otherwise, the flow may directly return to operation 201 where the electronic device continues to operate.

Such updating may include revoking one or more NFTs, replacing one or more NFTs, modifying one or more NFTs, and so on. Such updating may be performed at the request of the delegator, at the request of the delegate if the NFT provides such authority, and/or at the request of any other party that has authority under the smart contract to modify the NFT. Replacing one or more NFTs may revoke and/or otherwise mark the original NFT as unusable and may generate one or more new NFTs. Such new NFTs may be placed in one or more token wallets assigned to the person or entity who previously held the old NFT, in one or more token wallets assigned to the delegator who may then transfer, and so on.

By way of example of the method 200, an attorney may delegate authority to an assistant that allows the assistant to read emails in the attorney's email inbox and file the emails into one or more sub folders. However, the delegated authority may not enable the assistant to see emails in a FIRM BUSINESS sub folder or any files to which the attorney has access. This delegated authority may be more secure than the attorney simply providing the assistant the attorney's password, or simply logging onto the attorney's account and then stepping aside to allow the assistant to perform email related tasks. The attorney may submit a request to delegate the authority and the electronic device may generate an associated NFT and provide such, directly and/or indirectly, to the assistant.

The NFT in this scenario may be portable by the assistant in that the assistant may be able to take the NFT from device to device in order to be able to conveniently and securely perform one or more tasks associated with the delegated authority. However, it is understood that this is an example. In various examples, the attorney may specify any number of restrictions on the NFT and/or the assistant, such as an expiration date when the NFT will expire, limitations on and/or prevention of the ability to transfer the NFT, time and/or place limitations on the use of the NFT, restrictions on the authority delegated, and so on.

Alternatively, the NFT may not be directly accessible by the assistant. For example, in some implementations, a token wallet may be automatically generated (such as by a host platform) for the assistant when the NFT is assigned to the assistant. The token wallet may be automatically generated and associated with a communication address associated with the assistant, such as an email address, phone number, social media messaging address, and so on. By way of illustration, the attorney may provide the assistant's email address when assigning the NFT and a token wallet associated with that email address may be generated and a notification email may be sent to the assistant at that email address. The email address may include a link to the NFT. Alternatively, the NFT may be hidden from the assistant and the link may be usable by the assistant to utilize the delegated authority. Various configurations are possible and contemplated without departing from the scope of the present disclosure.

By way of another example, a streaming service and/or gaming service (or an airline site, a bank, or another password protected site or application) may delegate authority to use the streaming service and/or gaming service to a customer when the customer signs up for an account. The streaming service and/or gaming service may submit a request to delegate the authority and the electronic device may generate an associated NFT and provide such, directly and/or indirectly, to the customer.

The NFT may enable the customer to access content from the streaming service or the gaming service. The NFT may include information linking the NFT to the customer's account and/or the streaming service or gaming service and may maintain information in a database or other data store indicating which accounts correspond to which NFTs.

The customer may be able to use the NFT to configure one or more electronic devices (or a website or the like, associated with a token wallet to which the NFT is assigned) to be used with the streaming service or gaming service. The customer may do this by using another electronic device to obtain a code from an electronic device, determining that the NFT is assigned to a token wallet associated with the other electronic device, and submit an authorization request for the electronic device. By way of illustration, a smart phone may be used to scan a quick response or “QR” code displayed on the television by a streaming service or gaming service. The smart phone may then extract information from the QR code, determine that an NFT granting authority to configure the television to be used with the streaming service or gaming service is assigned to a token wallet associated with the smart phone, and submit an authorization request for the television to be configured to be used with the streaming service or the gaming service.

The customer may also be able to use the NFT to generate one or more child NFTs to which the NFT would be a parent NFT. By way of illustration, the streaming service or the gaming service may configure the NFT to allow the customer to generate up to five child NFTs. The customer may be able to generate child NFTs that can only access a subset of the streaming service or gaming service content that the parent NFT can access, such as only content with a PG-13 rating or lower. The child NFTs may have an expiration date and/or may otherwise be revoked or replaced, whether in response to a request from the customer, from the streaming service or the gaming service, and so on. When a child NFT expires and/or is otherwise revoked, a new NFT may be sent to a token wallet account associated with the customer, who may then transfer the new NFT to the same person and/or a different person from the expired and/or revoked child NFT. When a child NFT is replaced, the new NFT may be sent to a token wallet account associated with the previous holder of the child NFT or the customer, who may then transfer the new NFT to the same person and/or a different person from the replaced child NFT.

In a number of examples, a token may also be transferred with an expiration time, date and a set of rights delegated to a third party wallet attached to an app or website owned by the recipient which allows the recipient to log into to the target app or website and assume the identity of the first party without the first party having to share its user ID or password.

In various examples, this example method 200 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 200 is illustrated and described as including particular operations performed in a particular order, it is understood that this is an example. In various implementations, various orders of the same, similar, and/or different operations may be performed without departing from the scope of the present disclosure.

For example, the above illustrates and describes the electronic device as both receiving requests to delegate authority and requests to perform delegated transactions. However, it is understood that this is an example. In various implementations, different devices may receive requests to delegate authority and requests to perform delegated transactions. Various configurations are possible and contemplated without departing from the scope of the present disclosure.

By way of another example, the above illustrates and describes generating the NFT and the smart contract. However, it is understood that this is an example. In some implementations, the electronic device may generate the NFT and/or the smart contract by requesting generation of such, such as via one or more APIs of a device such as a computing device associated with the host platform 101 of FIG. 1A. Various configurations are possible and contemplated without departing from the scope of the present disclosure.

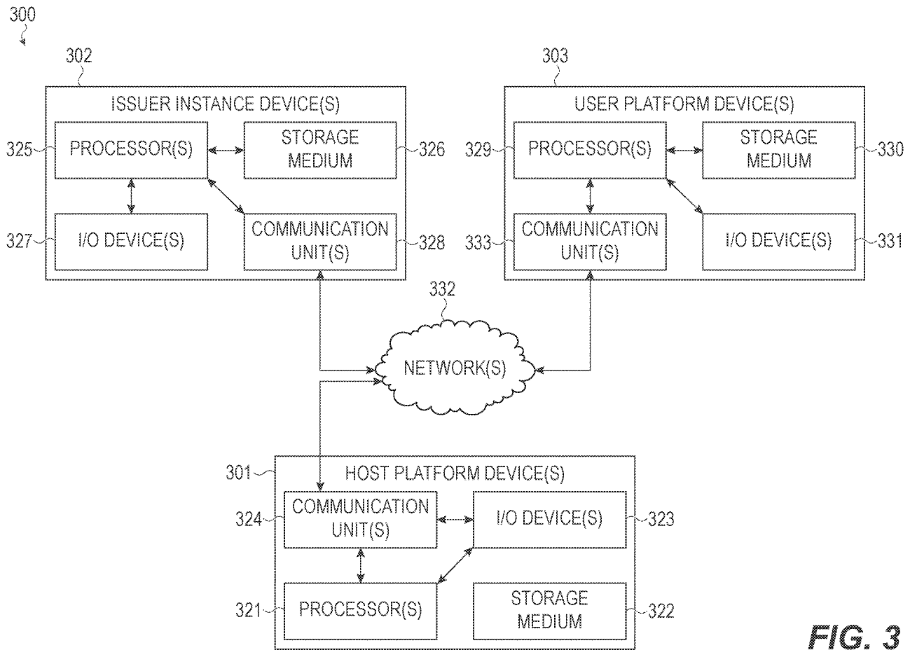

FIG. 3 depicts example relationships 300 among example components that may be used to implement the system 100 of FIG. 1A.

The host platform 101 of FIG. 1 may be implemented using one or more host platform devices 301. The host platform device 301 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The host platform device 301 may include one or more processors 321 and/or other processing units and/or controllers, one or more non-transitory storage media 322 (which may take the form of, but is not limited to, a magnetic storage medium; optical storage medium; magneto-optical storage medium; read only memory; random access memory; erasable programmable memory; flash memory; and so on), one or more communication units 324 (such as one or more network adapters and/or other devices used by a device to communicate with one or more other devices), one or more input and/or output components 323 (such as one or more displays, speakers, touch screens, computer mice, track pads, keyboards, printers, and so on) and/or one or more other components. The processor 321 may execute instructions stored in the non-transitory storage medium 322 to perform various functions. Such functions may include any of the functions discussed herein with respect to the host platform 101 of FIG. 1A; communicating with one or more issuer instance devices 302, user platform devices 303, and/or one or more other devices via one or more wired and/or wireless networks 332; and so on. Alternatively and/or additionally, the host platform device 301 may involve one or more memory allocations configured to store at least one executable asset and one or more processor allocations configured to access the one or more memory allocations and execute the at least one executable asset to instantiate one or more processes and/or services, such as one or more host platform services, and so on.

Similarly, the issuer instance 102 of FIG. 1A may be implemented using one or more issuer instance devices 302. The issuer instance device 302 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The issuer instance device 302 may include one or more processors 325 and/or other processing units and/or controllers, one or more non-transitory storage media 326 (which may take the form of, but is not limited to, a magnetic storage medium; optical storage medium; magneto-optical storage medium; read only memory; random access memory; erasable programmable memory; flash memory; and so on), one or more communication units 328 (such as one or more network adapters and/or other devices used by a device to communicate with one or more other devices), one or more input and/or output components 327 (such as one or more displays, speakers, touch screens, computer mice, track pads, keyboards, printers, and so on) and/or one or more other components. The processor 325 may execute instructions stored in the non-transitory storage medium 326 to perform various functions. Such functions may include any of the functions discussed herein with respect to the issuer instance 102 of FIG. 1A; communicating with one or more host platform devices 301, user platform devices 303, and/or one or more other devices via one or more wired and/or wireless networks 332; and so on. Alternatively and/or additionally, the issuer instance device 302 may involve one or more memory allocations configured to store at least one executable asset and one or more processor allocations configured to access the one or more memory allocations and execute the at least one executable asset to instantiate one or more processes and/or services, such as one or more issuer instance services, and so on.

Likewise, the user platform 103 of FIG. 1A may be implemented using one or more user platform devices 303. The user platform device 303 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The user platform device 303 may include one or more processors 329 and/or other processing units and/or controllers, one or more non-transitory storage media 330 (which may take the form of, but is not limited to, a magnetic storage medium; optical storage medium; magneto-optical storage medium; read only memory; random access memory; erasable programmable memory; flash memory; and so on), one or more communication units 333 (such as one or more network adapters and/or other devices used by a device to communicate with one or more other devices), one or more input and/or output components 331 (such as one or more displays, speakers, touch screens, computer mice, track pads, keyboards, printers, and so on) and/or one or more other components. The processor 329 may execute instructions stored in the non-transitory storage medium 330 to perform various functions. Such functions may include any of the functions discussed herein with respect to the user platform 103 of FIG. 1A; communicating with one or more issuer instance devices 302, host platform devices 301, and/or one or more other devices via one or more wired and/or wireless networks 332; and so on. Alternatively and/or additionally, the user platform device 303 may involve one or more memory allocations configured to store at least one executable asset and one or more processor allocations configured to access the one or more memory allocations and execute the at least one executable asset to instantiate one or more processes and/or services, such as one or more user platform services, and so on.

Additionally, FIG. 1A may involve one or more other devices not shown. Such other devices may be any kind of electronic device. Examples of such other devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The other devices may include one or more processors and/or other processing units and/or controllers, one or more non-transitory storage media (which may take the form of, but is not limited to, a magnetic storage medium; optical storage medium; magneto-optical storage medium; read only memory; random access memory; erasable programmable memory; flash memory; and so on), one or more communication units (such as one or more network adapters and/or other devices used by a device to communicate with one or more other devices), one or more input and/or output components (such as one or more displays, speakers, touch screens, computer mice, track pads, keyboards, printers, and so on) and/or one or more other components. The processor may execute instructions stored in the non-transitory storage medium to perform various functions. Such functions may include any of the functions discussed herein; communicating with one or more issuer instance devices 302, user platform devices 303, host platform devices 301, and/or one or more other devices via one or more wired and/or wireless networks 332; and so on. Alternatively and/or additionally, the other devices may involve one or more memory allocations configured to store at least one executable asset and one or more processor allocations configured to access the one or more memory allocations and execute the at least one executable asset to instantiate one or more processes and/or services, such as one or more other device services, and so on.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices and systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

Example information can include, but may not be limited to: personal identification information (e.g., names, social security numbers, telephone numbers, email addresses, physical addresses, driver's license information, passport numbers, and so on); identity documents (e.g., driver's licenses, passports, government identification cards or credentials, and so on); protected health information (e.g., medical records, dental records, and so on); financial, banking, credit, or debt information; third-party service account information (e.g., usernames, passwords, social media handles, and so on); encrypted or unencrypted files; database files; network connection logs; shell history; filesystem files; libraries, frameworks, and binaries; registry entries; settings files; executing processes; hardware vendors, versions, and/or information associated with a compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first-or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database. Whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

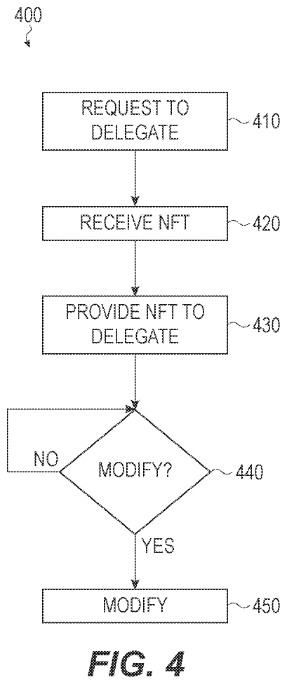

FIG. 4 depicts a flow chart illustrating a second example method 400 for operating an NFT authentication system. This method 400 may be performed by the system 100 of FIG. 1A.

At operation 410, an electronic device (such as one or more computing devices associated with the host platform 101 of FIG. 1A, the issuer instance 102 of FIG. 1A, the user platform 103 of FIG. 1A, and/or another device or system) may submit a request to delegate authority. The electronic device may submit the request to delegate the authority to a host platform, such as the host platform 101 of FIG. 1A. The electronic device may submit the request to delegate the authority on behalf of a delegator who instructs the electronic device to delegate the authority to a delegate.

At operation 420, the electronic device may receive an NFT associated with the delegated authority. The NFT may have been created in response to the request, associated with a smart contract (which may also have been created in response to the request), stored on a blockchain (with or without the smart contract), and so on. The electronic device receiving the NFT may include the electronic device actually receiving the NFT and/or may include the electronic device receiving an indication that the NFT was created and associated with a token wallet that may be accessible by and/or via the electronic device, such as a token wallet associated with the delegator.

The flow may proceed to operation 430 where the electronic device may provide the NFT to the delegate. The electronic device may provide the NFT to the delegate by transferring the NFT to a token wallet associated with the delegate. The electronic device may transfer the NFT to the token wallet associated with the delegate from a token wallet associated with the delegator. The electronic device may transfer the NFT to the token wallet associated with the delegate using the associated smart contract, which may control how the NFT may be transferred.

At operation 440, the electronic device may determine whether or not to modify the delegated authority. The electronic device may determine to modify the authority in response to receiving a request from the delegator to modify the authority, presuming the smart contract allows the delegator to modify the authority. Modification of the authority may include revoking the NFT, issuing a replacement NFT, modifying the smart contract, cancelling the smart contract, marking the NFT invalid, changing the delegated authority, and so on. If authority modification is determined, the flow may proceed to operation 450 where the electronic device may modify the delegated authority. Otherwise, the flow may return to operation 440 where the electronic device may again determine whether or not to modify the delegated authority.

By way of example, a hotel front desk employee may use a front desk computing device to assign a hotel room to a customer for 24 hours. As part of this, the hotel front desk employee may use the front desk computing device to request delegation of authority to use the hotel room to the customer. The request may provide an email address of the customer. The front desk computing device requesting the delegation of authority may result in creation of an NFT and an associated smart contract that delegates to the customer the authority to use the room for 24 hours, after which the NFT may expire. The NFT may be associated with a token wallet that may be automatically created and associated with the email address of the customer. When the NFT is associated with the token wallet, an email notifying the customer of the association may be sent to the email address. The email may include a link for the customer to use from a mobile computing device, which may open an app on the mobile computing device that the customer may use to unlock a door to the hotel room via Bluetooth™ and/or another wireless communication technology.

In various examples, the example method 400 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 400 is illustrated and described as including particular operations performed in a particular order, it is understood that this is an example. In various implementations, various orders of the same, similar, and/or different operations may be performed without departing from the scope of the present disclosure.

For example, the method 400 illustrates and describes the electronic device receiving the NFT. However, it is understood that this is an example. In various examples, the electronic device may neither receive the NFT and/or an indication that the NFT was created. Instead, in some implementations, the NFT may be associated with a token wallet accessible to the electronic device and the electronic device may then be used to provide the NFT to the delegate. Additionally, in a number of examples, the NFT may be provided to the delegate by the device or system that created the NFT without the electronic device being involved after requesting delegation of the authority. Various configurations are possible and contemplated without departing from the scope of the present disclosure.

Further, the method 400 illustrates and describes the electronic device determining whether or not to modify the delegated authority, delegating the authority, and so on. However, it is understood that this is an example. In various examples, one or more other devices may perform such functions and the electronic device may be uninvolved. Various configurations are possible and contemplated without departing from the scope of the present disclosure.

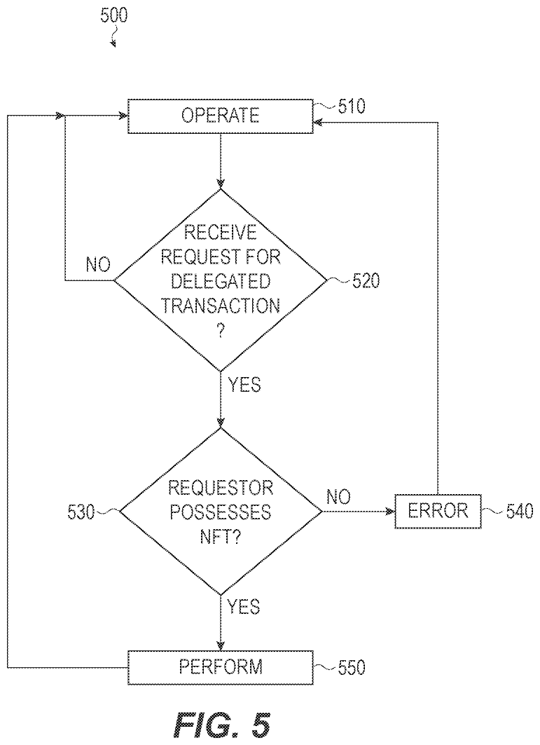

FIG. 5 depicts a flow chart illustrating a third example method 500 for operating an NFT authentication system. The method 500 may be performed by the system 100 of FIG. 1A.

At operation 510, an electronic device (such as one or more computing devices associated with the host platform 101 of FIG. 1A, the issuer instance 102 of FIG. 1A, the user platform 103 of FIG. 1A, and/or another device or system) may operate. At operation 520, the electronic device may receive a request for a delegated transaction. A delegated transaction may be a transaction that requires delegated authority associated with an NFT and/or smart contract in order to be performed. The delegated authority may be delegated in the smart contract by a delegator to a delegate associated with the NFT. The electronic device may receive a request to perform the delegated transaction from the delegate. If so, the flow may proceed to operation 530. Otherwise, the flow may return to operation 510 where the electronic device may continue to operate.

At operation 530, the electronic device receives a request for a delegated transaction, and the electronic device may determine whether or not a requestor associated with the request possesses an NFT associated with delegated authority to perform the delegated transaction. The electronic device may determine that the requestor possesses the NFT when the NFT is associated with a token wallet that is associated with the requestor, whether that token wallet is stored locally on a device from which the requestor submitted the request, whether the token wallet is a cloud-based token wallet to which the requestor has access, and so on. If it is determined that the requestor possesses the NFT, the electronic device may perform the transaction at operation 550 before the flow returns to operation 510 and the electronic device continues to operate. Otherwise, the electronic device may indicate that an error has occurred at operation 540 before the flow returns to operation 510 and the electronic device continues to operate.

For example, the electronic device may be a server computing device that administers a rewards program for a merchant. The rewards program may track customer purchases at a merchant and may issue NFTs enabling customers to claim $20 in merchant merchandise for every ten purchases that the customers make from the merchant. The server computing device may receive a request from a customer to claim $20 in merchant merchandise. In response, the server computing device may determine whether or not an NFT enabling the customer to claim the $20 in merchant merchandise is associated with a token wallet that is associated with the customer. If the determination is made that the enabling NFT is associated with the customer, the server computing device may allow the customer to claim the $20 in merchant merchandise. Otherwise, the server computing device may indicate that the customer does not have authority to claim the $20 in merchant merchandise.

Further in this example, the smart contract controlling the NFT may allow the customer to transfer the NFT enabling the customer to claim $20 in merchant merchandise to another customer for a $1 fee. In such implementations, the customer may request such a transfer and the server computing device may respond by deducting $1 from a payment method on file for the customer and transferring the NFT. Alternatively, the server computing device may revoke the NFT, replace the NFT with a new NFT entitling the customer to claim $19 in merchant merchandise, and transfer the new NFT to the other customer.

In some such examples, the other customer may not be a customer at the time of the transfer of the new NFT. Instead, the customer may provide an email address or other communication address of the other customer and a token wallet associated with the email address may be created for the other customer. The new NFT may then be transferred to the token wallet and a notification may be sent to the other customer at the email address letting the other customer know that they can claim $19 in merchant merchandise. This improves user interfaces and the operation of computing devices associated with NFT transfer as the other customer does not have to know how to set up a token wallet and/or does not have to interact with one or more computing devices to do so. Various configurations are possible and contemplated without departing from the scope of the present disclosure.

In various examples, this example method 500 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 500 is illustrated and described as including particular operations performed in a particular order, it is understood that this is an example. In various implementations, various orders of the same, similar, and/or different operations may be performed without departing from the scope of the present disclosure.

For example, the method 500 is illustrated and described as the electronic device performing the transaction. However, it is understood that this is an example. In various implementations, the electronic device may instead instruct another electronic device to perform the transaction. Various configurations are possible and contemplated without departing from the scope of the present disclosure.

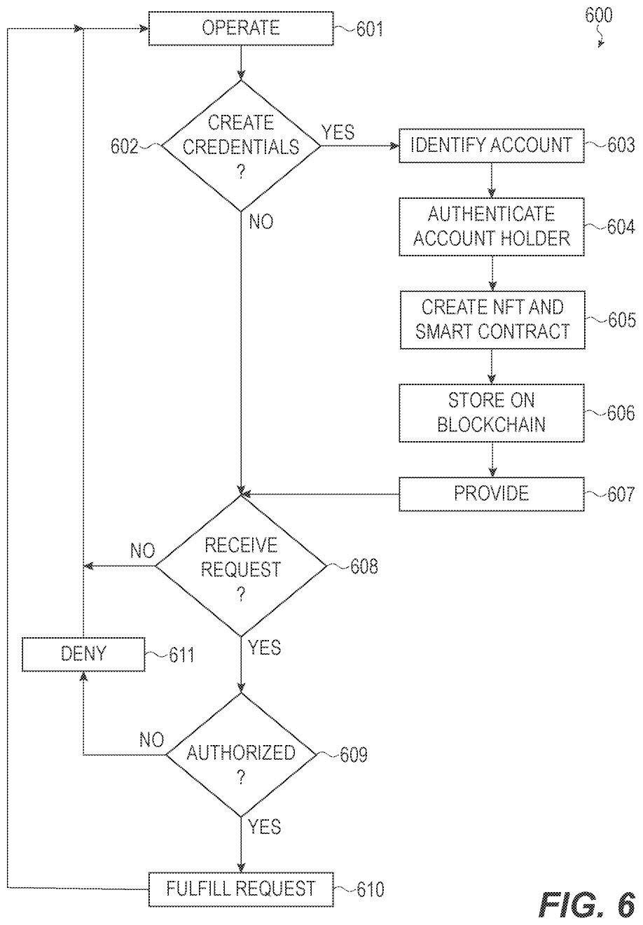

FIG. 6 depicts a flow chart illustrating a fourth example method 600 for operating an NFT authentication system. This method 600 may be performed by the system 100 of FIG. 1A.

At operation 601, an electronic device (such as one or more computing devices associated with the host platform 101 of FIG. 1A, the issuer instance 102 of FIG. 1A, the user platform 103 of FIG. 1A, and/or another device or system) may operate. At operation 602, the electronic device may determine whether or not to create one or more credentials. Such credentials may be used to prove authentication to perform actions related to an account (such as a frequent flyer account, a bank account, a content delivery system account, and so on). If the determination is to create one or more credentials, the flow may proceed to operation 603. Otherwise, the flow may proceed to operation 608.

At operation 603, after the electronic device determines to create one or more credentials, the electronic device may identify an account for which to create the one or more credentials. The electronic device may identify the account by determining one or more account numbers to associate with the one or more credentials.

The flow may then proceed to operation 604 where the electronic device may authenticate the account holder. The authentication may involve multi-factor authentication. For example, the electronic device may have a communication address that is associated with the account holder, such as an email, and may transmit a one-time password to the communication address and then prompt for the one time password that

Next, the flow may proceed to operation 605 where the electronic device may create an NFT with an associated smart contract. The electronic device may use information associated with the account to create the NFT. The flow may then proceed to operation 606 where the electronic device may store the NFT and/or the smart contract on one or more blockchains. Next, the flow may proceed to operation 607 where the electronic device may provide access to the NFT to the account holder before the flow proceeds to operation 608.

At operation 608, the electronic device may determine whether or not one or more requests that require authorization are received. If not, the flow may return to operation 601 and the electronic device may continue to operate. Otherwise, the flow may proceed to operation 609.

At operation 609, after the electronic device determines that one or more requests that require authorization are received, the electronic device may determine whether or not the request is authorized. This may be performed by determining whether or not an NFT associated with a smart contract authorizing performance of the request is associated with a token wallet associated with the requestor. If the electronic device determines that the request is authorized, the flow may proceed to operation 610 where the electronic device may fulfill the request before the flow returns to operation 601 and the electronic device continues to operate. Otherwise, the flow may proceed to operation 611 where the electronic device may deny the request before the flow returns to operation 601 and the electronic device continues to operate.

By way of example, an airline web site may use NFTs as credentials for using frequent flier awards. As such, when a customer earns a frequent flier award, the airline web site may identify the customer's account, authenticate the customer by sending a one-time password to the customer's email address on file and then prompting for the password, creating a token wallet associated with the customer's email address (of which the customer may not be aware and to which the customer may not have access), and then create the NFT for the frequent flier award and associate it with the token wallet. Subsequently, when the user looks up his frequent flier award status, the electronic device may access the token wallet and display award information for any NFTs in the token wallet.

In various examples, this example method 600 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 600 is illustrated and described as including particular operations performed in a particular order, it is understood that this is an example. In various implementations, various orders of the same, similar, and/or different operations may be performed without departing from the scope of the present disclosure.

For example, the method 600 is illustrated and described as identifying an account after determining to create one or more credentials. However, it is understood that this is an example. In various implementations, the electronic device may determine to create one or more credentials as part of creating a new account. As such, the operation of identifying the account may be omitted. Various configurations are possible and contemplated without departing from the scope of the present disclosure.

Further, the method 600 is illustrated and described as both creating the credentials and determining whether or not requests are authorized. However, it is understood that this is an example. In some implementations, these operations may be performed by different devices. Various configurations are possible and contemplated without departing from the scope of the present disclosure.

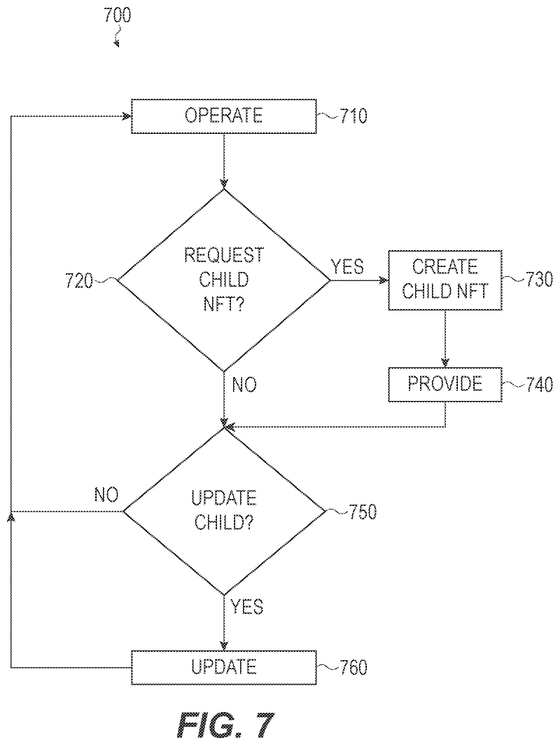

FIG. 7 depicts a flow chart illustrating a fifth example method 700 for operating an NFT authentication system. This method 700 may be performed by the system 100 of FIG. 1A.

At operation 710, an electronic device (such as one or more computing devices associated with the host platform 101 of FIG. 1A, the issuer instance 102 of FIG. 1A, the user platform 103 of FIG. 1A, and/or another device or system) may operate.

The flow may then proceed to operation 720 where the electronic device determines whether or not one or more requests for one or more child NFTs are received. The one or more child NFTs may be requested by the holder of an NFT (which may be a parent NFT once the one or more child NFTs are created) associated with a smart contract that authorizes creation of the one or more child NFTs. For example, a content delivery system may use NFTs to prove authorization to access content delivery system content. A single NFT may be provided to the account holder for the account holder's use, but the associated smart contract may allow the account holder to request the one or more child NFTs to provide to others for use. The associated smart contract may specify the kind of access that is associated with the one or more child NFTs, how many child NFTs may be created, any charge for creating the one or more child NFTs, how long before created child NFTs expire, and so on. If one or more child NFT requests are received, the flow may proceed to operation 730. Otherwise, the flow may proceed to operation 750.

At operation 730, after the electronic device determines that one or more requests for one or more child NFTs are received, the electronic device may create the one or more child NFTs. The flow may then proceed to operation 740 where the electronic device may provide the created one or more child NFTs before the flow proceeds to operation 750.

At operation 750, the electronic device may determine whether or not to update one or more created child NFTs. The electronic device may determine to update the one or more child NFTs if the one or more child NFTs have been stolen, have been misused, were created from a parent NFT that is no longer valid, have expired, and so on. Updating may include revoking, replacing, and/or otherwise modifying the authorization associated with the one or more child NFTs. If a determination to update one or more created child NFTs is made, the flow may proceed to operation 760 where the electronic device may update the one or more child NFTs before the flow returns to operation 710 and the electronic device continues to operate. Otherwise, the flow may proceed directly to operation 710 and the electronic device continues to operate.

By way of illustration, a cellular service may use NFTs to authorize use of cellular devices on a cellular network instead of SIM (subscriber identity module) cards. Each subscriber may be allowed to pay a fee to create up to five child NFTs that the subscriber may provide to others to use a more limited version of the cellular network than the one to which the subscriber has access. However, the subscriber may cancel his account. In such a case, the cellular service may revoke both the parent NFT held by the subscriber as well as the child NFTs associated with the parent NFT. Various configurations are possible and contemplated without departing from the scope of the present disclosure.

In various examples, this example method 700 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 700 is illustrated and described as including particular operations performed in a particular order, it is understood that this is an example. In various implementations, various orders of the same, similar, and/or different operations may be performed without departing from the scope of the present disclosure.

For example, the method 700 is illustrated and described as determining whether or not to update one or more child NFTs after determining whether or not one or more requests to create one or more child NFTs are received. However, it is understood that this is an example. In various implementations, such operations may be performed in different orders, omitted, and so on. Various configurations are possible and contemplated without departing from the scope of the present disclosure.

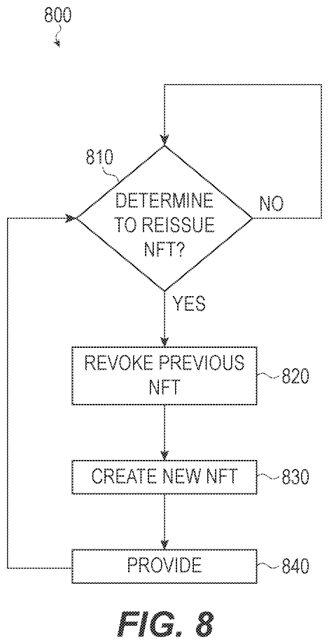

FIG. 8 depicts a flow chart illustrating a sixth example method 800 for operating an NFT authentication system. This method 800 may be performed by the system 100 of FIG. 1A.

At operation 810, an electronic device (such as one or more computing devices associated with the host platform 101 of FIG. 1A, the issuer instance 102 of FIG. 1A, the user platform 103 of FIG. 1A, and/or another device or system) may determine whether or not to reissue an existing NFT. For example, an electronic device may determine to reissue an NFT used to prove authorization to perform one or more actions because the NFT has been lost. If the determination is not to reissue an existing NFT, the flow may return to operation 810 where the electronic device may again determine whether or not to reissue an existing NFT. Otherwise, the flow may proceed to operation 820.

At operation 820, the electronic device may revoke the previous existing NFT. The flow may then proceed to operation 830 where the electronic device may create the new NFT. Next, the flow may proceed to operation 840 where the electronic device may provide the new NFT.

The flow may then return to operation 810 where the electronic device may continue to operate.

For example, a grocery store may use NFTs to prove authorization for a frequent buyer club program. However, a customer may lose access to a token wallet where the authorization NFT is stored. The customer may prove his identity using various techniques such as a login and password and inform the grocery store that the token wallet is no longer accessible. In response, the grocery store may revoke the previous existing NFT, create a new NFT, and provide the new NFT to the customer. Various configurations are possible and contemplated without departing from the scope of the present disclosure.

In various examples, this example method 800 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 800 is illustrated and described as including particular operations performed in a particular order, it is understood that this is an example. In various implementations, various orders of the same, similar, and/or different operations may be performed without departing from the scope of the present disclosure.

For example, the method 800 is illustrated and described as revoking a previous existing NFT. However, it is understood that this is an example. In various implementations, the previous existing NFT may already be unusable (such as where the previous existing NFT is already expired) and the operation of revoking the previous existing NFT may be omitted. Various configurations are possible and contemplated without departing from the scope of the present disclosure.

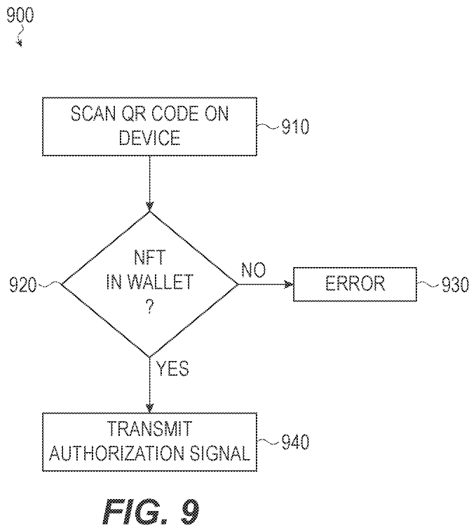

FIG. 9 depicts a flow chart illustrating a seventh example method 900 for operating an NFT authentication system. This method 900 may be performed by the system 100 of FIG. 1A.

At operation 910, an electronic device (such as one or more computing devices associated with the host platform 101 of FIG. 1A, the issuer instance 102 of FIG. 1A, the user platform 103 of FIG. 1A, and/or another device or system) may scan a QR code displayed on a device. For example, the QR code may be displayed on a television by a streaming service in order to enable configuration of the streaming service to allow the television to display content from the streaming service on the television. The configuration may associate the television with a streaming service account that is authorized to access the content from the streaming service. Scanning the QR code may cause the electronic device to decode the QR code and execute one or more instructions that begin configuring the streaming service to allow the television to display the content.

At operation 920, the electronic device may determine whether one or more NFTs that authorize use of the television with the streaming service are associated with a token wallet associated with the electronic device. If not, the flow may proceed to operation 930 where the electronic device may determine that an error occurred. Otherwise, the flow may proceed to operation 940 where the electronic device may transmit an authorization signal to the streaming service to cause the streaming service to configure itself to allow the television to display the content.

In various examples, this example method 900 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 900 is illustrated and described as including particular operations performed in a particular order, it is understood that this is an example. In various implementations, various orders of the same, similar, and/or different operations may be performed without departing from the scope of the present disclosure.

For example, the method 900 is illustrated and described as transmitting an authorization signal to the streaming service to cause the streaming service to configure itself to allow the television to display the content. However, it is understood that this is an example. In various implementations, the electronic device may notify the streaming service that the configuration is authorized without transmitting an authorization signal. In still other implementations, the streaming service may itself verify authorization. Various configurations are possible and contemplated without departing from the scope of the present disclosure.

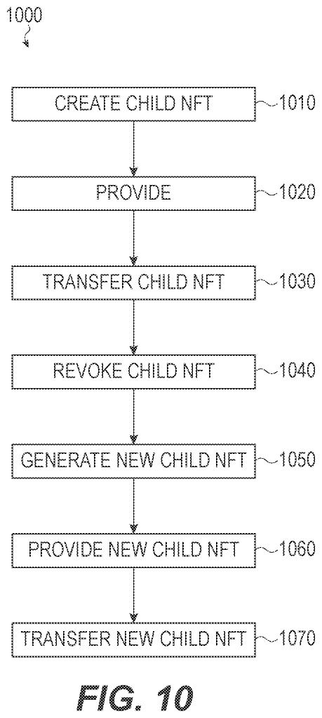

FIG. 10 depicts a flow chart illustrating an eighth example method 1000 for operating an NFT authentication system. This method 1000 may be performed by the system 100 of FIG. 1A.

At operation 1010, an electronic device (such as one or more computing devices associated with the host platform 101 of FIG. 1A, the issuer instance 102 of FIG. 1A, the user platform 103 of FIG. 1A, and/or another device or system) may create a child NFT. The flow may then proceed to operation 1020 where the electronic device may provide the child NFT. Next, the flow may proceed to operation 1030 where the electronic device may transfer the child NFT. The flow may then proceed to operation 1040 where the electronic device may revoke the NFT. Next, the flow may proceed to operation 1050 where the electronic device may generate a new child NFT. The flow may then proceed to operation 1060 where the electronic device may provide the new child NFT. Finally, the flow may proceed to operation 1070 where the electronic device may transfer the new child NFT.

By way of illustration, a WiFi network may use NFTs to authorize use of the WiFi network. The administrator of the WiFi network may be authorized to administer the WiFi network using a parent NFT. Users of the WiFi network may be authorized using one or more child NFTs created using the parent NFT. The WiFi network may only support a particular number of users at a particular time. As such, the WiFi administrator may request child NFTs, transfer the child NFTs to the users that the administrator has granted access, remove the transferred NFTs when access is to be ended, and request and then transfer new child NFTs to grant access to new users. Various configurations are possible and contemplated without departing from the scope of the present disclosure.

In various examples, this example method 1000 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 1000 is illustrated and described as including particular operations performed in a particular order, it is understood that this is an example. In various implementations, various orders of the same, similar, and/or different operations may be performed without departing from the scope of the present disclosure.

For example, the method 1000 is illustrated and described in the context of a child NFT. However, it is understood that this is an example. In various implementations, the method 1000 may be performed in the context of a parent NFT and/or other NFT rather than a child NFT and/or in addition to being performed in the context of a child NFT. Various configurations are possible and contemplated without departing from the scope of the present disclosure.

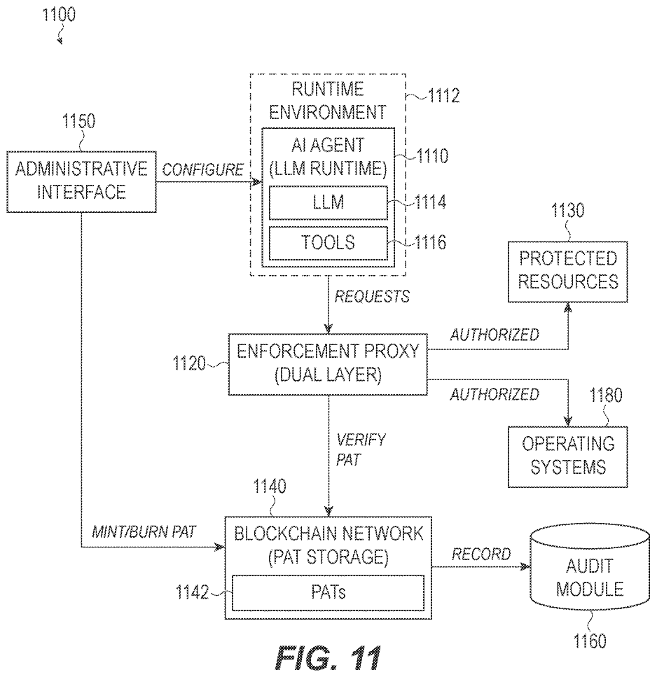

FIG. 11 depicts a blockchain-authenticated dynamic authorization system 1100 (hereinafter “the system 1100”) for governing the actions of artificial intelligence agents. The system 1100 may include an AI agent 1110 operating within a runtime environment 1112; an enforcement proxy 1120 interposed between the AI agent 1110 and one or more protected resources 1130 and/or operating systems 1180; a blockchain network 1140 storing permission access tokens (PATs) 1142; an administrative interface 1150 through which human administrators define and manage permissions; and an audit module 1160 that records authorization events as immutable blockchain transactions.

The AI agent 1110 may be an autonomous software system powered by a large language model (LLM) 1114 that may be capable of processing natural language instructions, reasoning about tasks, and executing actions through a defined set of tools 1116. Tools 1116 may include, but are not limited to: file read/write operations, shell command execution, network request transmission, message sending via various channels, browser control and automation, and sub-agent spawning. The AI agent 1110 may not have direct access to the operating system 1180 or to the protected resources 1130; rather, all interactions may be mediated through the runtime environment 1112 and the enforcement proxy 1120.

The enforcement proxy 1120 may be a software component that intercepts all requests originating from the AI agent 1110 destined for the protected resources 1130. For each intercepted request, the enforcement proxy 1120 may perform a series of verification operations, described in detail below, to determine whether the request is authorized under the permissions encoded in the PAT 1142 associated with the requesting agent session. The enforcement proxy 1120 may be deployed in at least two configurations: as a plugin (middleware) operating external to the runtime environment 1112, or as a kernel-level module embedded within the runtime environment 1112 itself. Both configurations are described in detail below.

The blockchain network 1140 may serve as the authoritative, immutable ledger for permission records. The system 1100 may be designed to be chain-agnostic, operating on any blockchain network that supports non-fungible digital asset creation with metadata encoding capability. Supported blockchain types may include: public blockchain networks (e.g., Algorand, Ethereum and its Layer 2 networks such as Base, Solana, and other public ledgers); private or permissioned blockchain networks (e.g., Hyperledger Fabric, R3 Corda, Quorum, and enterprise-specific chains); and hybrid blockchain architectures that combine public and private components. The system 1100 architecture may abstract blockchain-specific implementation details through a chain-agnostic verification proxy, as described below, enabling operation on additional blockchain networks without modification to the core verification logic.

### Permission Access Token (PAT) Structure

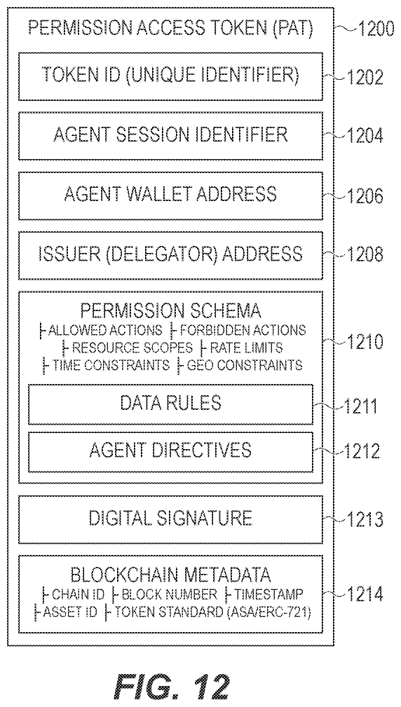

Referring to FIGS. 11 and 12, each Permission Access Token (PAT) 1142 may be a non-fungible digital asset stored on the blockchain network 1140. The PAT 1142 may encode one or more data elements, which may include:
(a) Token Identifier 1202: An identifier for the PAT on the blockchain network, which may be unique and may conform to the token standard of the underlying blockchain (e.g., ASA ID on Algorand, token ID on ERC-721, a unique asset identifier on a private chain's asset registry);
(b) Agent Session Identifier 1204: A cryptographic identifier that may uniquely identify the AI agent session to which the PAT is bound. The agent session identifier 1204 may be generated during session initialization, as described below, and may be embedded in the PAT at the time of minting;
(c) Agent Wallet Address 1206: The blockchain wallet address that may be assigned to the AI agent session. The agent wallet address 1206 may be the on-chain identity of the agent and may be used for PAT ownership verification;
(d) Issuer (Delegator) address 1208: The blockchain wallet address that may be assigned to the issuer. The issuer (delegator) address 1208 may be the on-chain identity of the issuer and may be used for PAT verification;
(e) Permission Schema 1210: A structured data object that may define the scope of authorized actions. The permission schema 1210 may include:
   (e)(i) Data Rules 1211 (Hard Enforcement): Machine-enforceable rules that may constrain the data and actions available to the agent. Data rules 1211 may include, but are not limited to:—return_fields: an allowlist of data fields that may be returned to the agent in response to queries;—exclude_fields: a blocklist of data fields that may be excluded from responses; redaction_patterns: one or more patterns (such as one or more regular expression patterns) that may define data that may be redacted from responses (e.g., Social Security number patterns, credit card number patterns, and so on);—allowed_recipients: an allowlist of recipient identifiers (email addresses, channel IDs, phone numbers) to which the agent may direct communications; blocked_recipients: a blocklist of recipient identifiers to which the agent may be prohibited from directing communications;—required_prefixes: string prefixes that may be prepended to outgoing communications;—rate_limits: maximum number of requests or actions permitted within a defined time window;—max_results: maximum number of results that may be returned in response to a single query;—temporal_constraints: time-of-day, day-of-week, temporal window restrictions governing when the permission is active, and so on; geographic_constraints: jurisdictional, data residency, network origin restrictions governing where the permission applies, and so on;
(e)(ii) Agent Directives 1212 (Soft Enforcement): Behavioral instructions that may be communicated to the AI agent alongside data responses. Agent directives 1212 may include, but are not limited to:—purpose_statement: a natural language description of the intended purpose for which the agent may be authorized to use the data or resource;—allowed_behaviors: a list of actions the agent may be permitted to perform with the accessed data;—forbidden_behaviors: a list of actions the agent may be explicitly prohibited from performing;—disclosure_text: text that may be included in any output derived from the accessed data;—audit_level: a specification of the granularity of audit logging for actions taken with the accessed data.
(f) Issuer Signature 1213: A digital signature (such as an Ed 25519 signature) by the issuing authority over the PAT contents, ensuring integrity and provenance;
(g) Blockchain Metadata 1214: Metadata that may include, but is not limited to, a chain identifier, a block number, a timestamp, an asset identifier, a token standard, and so on.

Additionally and/or alternatively, the PAT 1142 may encode one or more other data elements. Such other data elements may include, but are not limited to:

Issuance Timestamp: The blockchain-attested timestamp at which the PAT was minted, derived from the block timestamp rather than a self-reported clock;

Expiration Conditions: Conditions under which the PAT may automatically become invalid, including temporal expiration, maximum usage count, event-triggered expiration, and so on;

Parent Token Reference: An optional reference to a parent PAT from which this PAT was delegated, enabling hierarchical delegation chains as described below;

Delegation Constraints: An optional specification of whether and how the PAT holder may further delegate permissions to sub-agents, including maximum delegation depth and permitted delegation scope.

The permission schema 1210 may be encoded in a machine-readable format, such as in JSON, and stored in the token metadata field of the blockchain asset. The specific storage mechanism may vary by blockchain implementation. On public chains, the schema may be stored in a token metadata field, an associated smart contract state, referenced via a metadata URI (uniform resource identifier), and so on. On private or permissioned chains, the schema may be stored in the chain's native asset registry, a chaincode state database, an on-chain key-value store, and so on. The chain-agnostic verification proxy may abstract these implementation details, as described below.

### AI Agent Session Binding

Referring to FIGS. 11-13, an AI agent session binding process 1300 may cryptographically bind a PAT 1142 to a specific AI agent session, which may ensure that the PAT 1142 cannot be used by any other agent session even if the token data is copied or intercepted.

An agent runtime 1306 (such as the runtime environment 1112 of the AI agent 1110) may initialize an AI agent session by contacting a proxy 1308 (such as the enforcement proxy 1120) and requesting a PAT 1142 from an administrator 1302 or automated provisioning system. When the AI agent session is initialized, the agent runtime 1306 may generate a new Ed25519 and/or other key pair including a private key and a corresponding public key. The private key may be held exclusively within the runtime environment's secure memory and may never be exposed to the LLM 1114 or to any external interface.

The agent runtime 1306 may generate a unique agent session identifier by computing a cryptographic hash (e.g., SHA-256) and (over) the concatenation of: the Ed25519 and/or other public key, a runtime-generated nonce, and a timestamp. This agent session identifier may serve as the unique, non-forgeable identity of the agent session.

The administrator 1302 or automated provisioning system may initiate the minting of a PAT 1142 on a blockchain 1304. The minting transaction may embed the unique agent session identifier, an agent wallet address, and so on within the PAT 1142 metadata. The PAT 1142 may be transferred to the agent wallet address.

Subsequent requests from the agent runtime 1306 to the proxy 1308 may include a challenge-response authentication. This challenge-response authentication may include the proxy 1308 generating a random nonce and transmitting the random nonce it to the agent runtime 1306 whereupon the agent runtime 1306 may sign the nonce with the agent session's Ed25519 private key. The proxy 1308 may verify the signature against the Ed25519 and/or other public key (which may be embedded in the PAT 1142), thereby confirming that the requesting agent session is the same session to which the PAT was originally bound.

This session binding mechanism may ensure that: (a) a PAT 1142 copied to another agent's wallet may be useless because the other agent cannot produce valid Ed25519 and/or other signatures matching (or corresponding to) the public key embedded in the PAT 1142; (b) replay attacks may be prevented because each verification may include a fresh nonce; and (c) the binding may be non-forgeable because Ed25519 and/or other signatures may be computationally infeasible to forge without the private key.

### Dual-Layer Enforcement Architecture

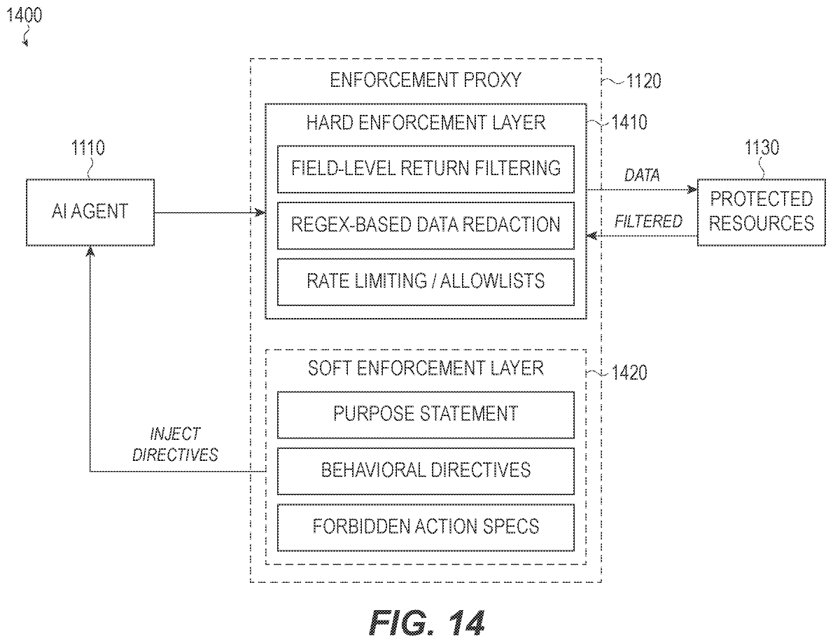

Referring to FIGS. 11 and 14, a dual-layer enforcement architecture 1400 is depicted. The architecture 1400 may include at least two distinct enforcement layers that may operate cooperatively but independently. These two distinct enforcement layers may include a hard enforcement layer 1410 and a soft enforcement layer 1420.

The hard enforcement layer 1410 may operate at the enforcement proxy 1120, which may be positioned architecturally between the AI agent 1110 and the protected resources 1130. The hard enforcement layer 1410 may operate entirely outside the AI agent's runtime and control. The AI agent 1110 may have no mechanism to bypass, disable, modify, or circumvent the hard enforcement layer 1410. This architectural separation differs from prior art systems that enforce permissions within an agent itself.

The hard enforcement layer 1410 may process both outbound requests from the AI agent 1110 and inbound responses from the protected resources 1130. For outbound requests, the hard enforcement layer 1410 may apply:
(a) Request Authorization: The enforcement proxy 1120 may parse the request to determine the requested action (e.g., read, write, send, execute) and the target resource. The requested action may be compared against a permission schema encoded in the PAT 1142. If the requested action is not within the authorized scope, the request may be denied and an audit event may be recorded;
(b) Recipient Filtering: For communication actions (e.g., sending messages, emails), the enforcement proxy 1120 may compare specified recipients against allowed_recipients and blocked_recipients lists. Communications to blocked recipients or recipients not on the allowlist (when an allowlist is specified) may be denied;
(c) Rate Limiting: The enforcement proxy 1120 may maintain a counter of requests within a time window specified by rate_limits encoded in the PAT 1142. Requests exceeding the rate limit may be denied;
(d) Required Prefix Enforcement: For outgoing communications, the enforcement proxy 1120 may verify that required_prefixes encoded in the PAT 1142 are present and, if not, prepend them automatically;
(e) Temporal Constraint Enforcement: The enforcement proxy 1120 may evaluate temporal_constraints encoded in the PAT 1142 against a current time, using a timestamp source independent of the AI agent 1110 (e.g., the enforcement proxy's own system clock or a network time protocol source). If the current time is outside a permitted temporal window encoded in the PAT 1142, the request may be denied regardless of whether it would otherwise be authorized;
(f) Geographic Constraint Enforcement: The enforcement proxy 1120 may evaluate geographic_constraints encoded in the PAT 1142 against the request context, which may include the network origin of the request, the jurisdictional classification of the target data, any data residency requirements, and so on. Requests that would violate geographic or jurisdictional constraints may be denied.

For inbound responses, the hard enforcement layer 1410 may apply:
(a) Field-Level Filtering: The enforcement proxy 1120 may parse the response data and filter it according to return_fields (retaining only specified fields) encoded in the PAT 1142 or exclude_fields (removing specified fields) encoded in the PAT 1142. The filtered response may then be forwarded to the AI agent 1110;
(b) Regex-Based Data Redaction (or other pattern-based redaction): The enforcement proxy 1120 may apply redaction patterns encoded in the PAT 1142 to the response data, replacing any matching (or corresponding) content with a redaction marker (e.g., “[REDACTED]”). This may ensure that sensitive data patterns (e.g., Social Security numbers, credit card numbers, personal health information) may never be exposed to the AI agent 1110, regardless of the AI agent's instructions or intentions;
(c) Result Limitation: The enforcement proxy 1120 may truncate response data to a max_results threshold encoded in the PAT 1142, which may prevent the AI agent 1110 from ingesting more data than authorized.

The soft enforcement layer 1420 may operate by injecting behavioral directives into a data stream received by the AI agent 1110. After the hard enforcement layer 1410 has filtered and sanitized a response, the soft enforcement layer 1420 may append or prepend agent directives encoded in the PAT 1142 to the response data. These directives may be formatted as natural language instructions that the LLM 1114 of the AI agent 1110 may be expected to interpret and follow.

The soft enforcement layer 1420 may be explicitly recognized as advisory rather than deterministic. The agent directives encoded in the PAT 1142 may rely on the AI agent's LLM 1114 to interpret and comply with the instructions. A well-functioning AI agent 1110 may adhere to the directives; however, a compromised, jailbroken, or malfunctioning AI agent 1110 may disregard them. This is precisely why the architecture 1400 may place all security-critical constraints in the hard enforcement layer 1410 while using the soft enforcement layer 1420 for behavioral guidance that enhances, but may not be relied upon, for security.

The combination of the hard enforcement layer 1410 and soft enforcement layer 1420 may provide a defense-in-depth approach wherein: (i) security-critical constraints may be enforced at a layer the AI agent 1110 cannot influence; (ii) behavioral intent may be communicated to guide compliant AI agent 1110 behavior; and (iii) the system may degrade gracefully. In other words, when the soft enforcement layer 1420 is disregarded by a compromised AI agent 1110, the hard enforcement layer 1410 may still prevent data exfiltration, unauthorized communication, scope violations, and so on.

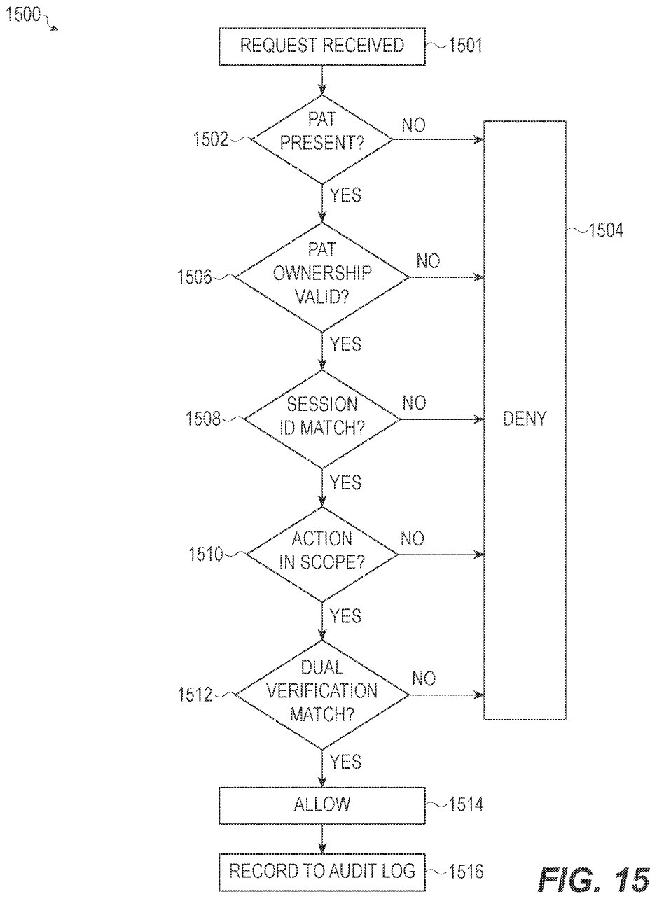

FIG. 15 illustrates a request verification process 1500 at an enforcement proxy. The request verification process may include PAT ownership verification, permission scope verification, dual verification check, fail-closed decision logic, and so on.

At operation 1501, a request may be received. The request may be received by an enforcement proxy. The enforcement proxy may intercept the request originating from an AI agent destined for a protected resource.

The flow may proceed to operation 1502 where it may be determined whether or not a PAT is present. The enforcement proxy may determine whether or not the PAT is present. The PAT may be present when the PAT is associated with a token wallet associated with the AI agent that submitted the request. If not, the flow may proceed to operation 1504 where the request may be denied, such as by the enforcement proxy. Otherwise, the flow may proceed to operation 1506.

At operation 1506, it may be determined whether or not the PAT ownership is valid. The enforcement proxy may determine whether or not the PAT ownership is valid. If the PAT ownership is not valid, the flow may proceed to operation 1504 where the request may be denied, such as by the enforcement proxy. Otherwise, the flow may proceed to operation 1508.

At operation 1508, it may be determined whether or not the session identifiers match (or correspond). The enforcement proxy may determine whether or not the session identifiers match. If the session identifiers do not match, the flow may proceed to operation 1504 where the request may be denied, such as by the enforcement proxy. Otherwise, the flow may proceed to operation 1510.

At operation 1510, it may be determined whether or not the requested action is in the scope of authority encoded in the PAT. The enforcement proxy may determine whether or not the requested action is in the scope of authority encoded in the PAT. If the requested action is not within the scope of authority encoded in the PAT, the flow may proceed to operation 1504 where the request may be denied, such as by the enforcement proxy. Otherwise, the flow may proceed to operation 1512.

At operation 1512, it may be determined whether or not dual verifications match (or correspond). The dual verification is described in more detail below. The enforcement proxy may determine whether or not the dual verifications match. If not, the flow may proceed to operation 1504 where the request may be denied, such as by the enforcement proxy. Otherwise, the flow may proceed to operation 1514.

At operation 1514, the request may be allowed. The enforcement proxy may allow the request. The flow may then proceed to operation 1516 where the allowed request may be recorded to an audit log, such as by an audit module. The allowed request may be recorded to the audit log by the enforcement proxy.

### Kernel-Level Runtime Integration

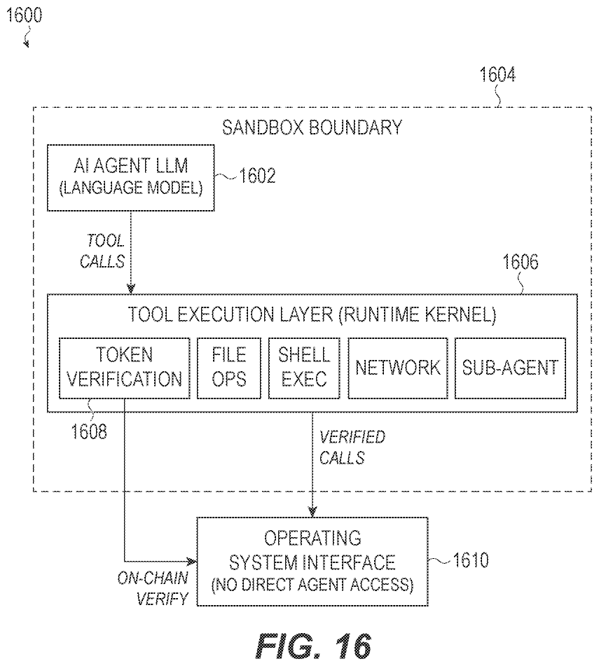

Referring to FIGS. 11 and 16, in some embodiments, a token verification module 1600 may be integrated directly into the AI agent's runtime environment 1112, hereinafter referred to as kernel-level integration or kernel mode.

The runtime environment 1112 may include: an AI agent LLM interface 1602, which may communicate with the large language model 1114; a tool execution layer 1606, which may receive tool call requests from the LLM 1114 and dispatch them for execution; the token verification module 1608, which may intercept all tool call requests at the tool execution layer 1606; and an operating system interface 1610, which may be the exclusive pathway between the runtime environment 1112 and the operating system 1180.

In kernel mode operation, every tool call generated by the LLM 1114 may pass through the following verification pipeline:

The LLM 1114 may generate a tool call request specifying a tool name (e.g., “file_read,” “shell_exec,” “network_request,” “message_send,” “browser_control,” “subagent_spawn”) and associated parameters.

The tool execution layer 1606 may intercept the tool call request before execution and pass it to the token verification module 1608.

The token verification module 1608 may perform on-chain verification by: (a) retrieving the PAT 1142 associated with the current agent session from the blockchain network 1140; (b) verifying that the PAT 1142 is still valid (not burned, not clawed back, not expired); (c) parsing the permission schema from the PAT 1142; (d) determining whether the requested tool call is within the authorized scope defined by the permission schema; and (e) recording the verification event on the blockchain network 1140.

If verification succeeds, the tool call may be dispatched to the operating system interface 1610 for execution. If verification fails, the tool call may be denied, an error may be returned to the LLM 1114, and the denial may be recorded on the blockchain.

The AI agent 1110 in kernel mode may operate in a sandboxed environment 1604, which may have the following constraints:
(a) The LLM 1114 may have no direct access to the operating system 1180. All interactions with the operating system—file operations, process execution, network communication—may be mediated exclusively through the tool execution layer 1606 and the operating system interface 1610;
(b) The operating system user account under which the runtime environment 1112 executes may have no SSH (secure shell) access. The runtime environment 1112 may be the sole interface to the operating system 1180 for the AI agent's user account;
(c) The runtime environment 1112 may be the only process authorized to execute on behalf of the AI agent's user account. No external shell, remote access, or alternative execution path may be available.

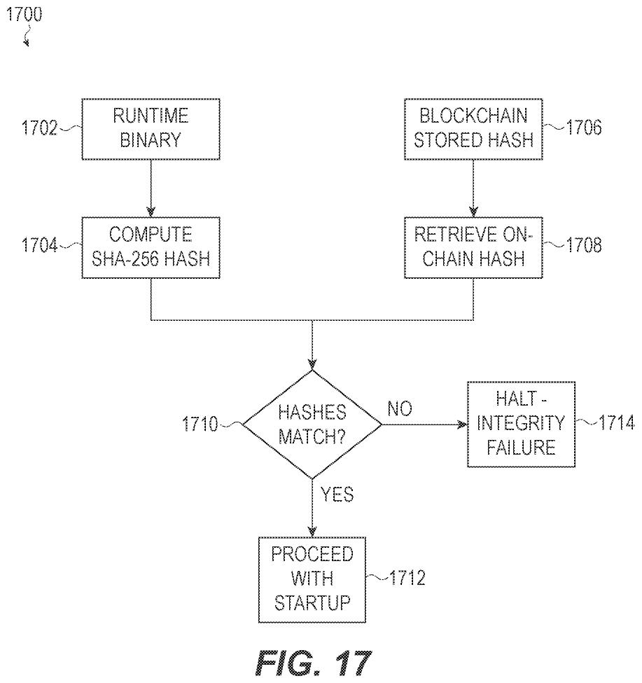

Referring to FIGS. 11 and 17, the runtime environment 1112 may implement a binary integrity self-check 1700 at startup. The binary integrity self-check 1700 may include steps 1702, 1704, 1706, 1708, 1710, 1712, and/or 1714, which will now be described.

At step 1702, the runtime environment 1112 may initialize using its own binary executable runtime binary. At step 1704, the runtime environment 1112 may compute a cryptographic hash (e.g., SHA-256). The cryptographic hash may be a hash of its own binary executable.

At step 1706, an expected hash value may be stored the blockchain network 1140, such as by an authorized software distributor. At step 1708, the runtime environment 1112 may retrieve he expected hash value from the blockchain network 1140.

At step 1710, the runtime environment 1112 may compare the computed hash against the expected hash. If the hashes match (or correspond), the runtime environment 1112 may proceed with normal initialization and startup at step 1712. If the hashes do not match, the runtime environment 1112 may terminate immediately without executing any agent operations at a halt-integrity failure at step 1714. A halt-integrity failure (or “integrity violation alert”) may also recorded on the blockchain network 1140.

This binary integrity self-check 1700 may ensure that the runtime environment 1112 has not been tampered with. For example, any modification to the runtime binary (e.g., to disable a token verification module) may result in a hash mismatch and prevent execution.

### Multi-Chain Token Verification

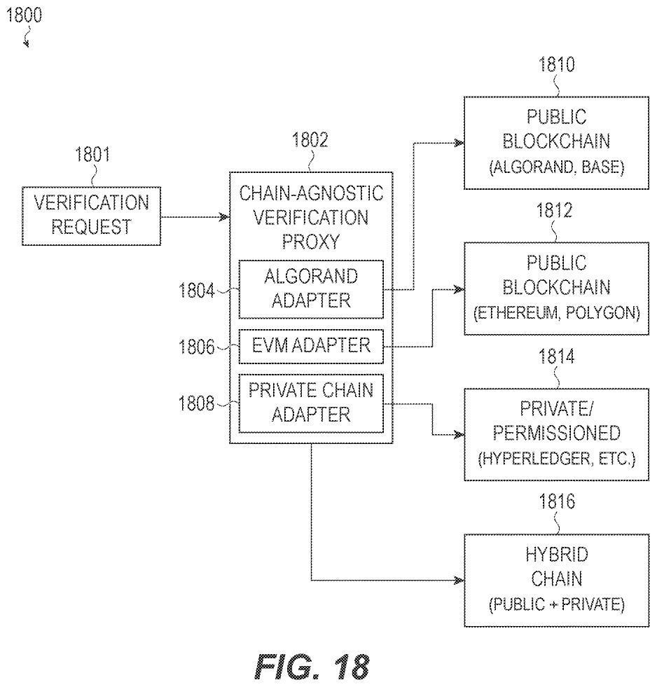

Referring to FIGS. 11 and 18, the system 1100 may implement multi-chain token verification architecture 1800, which may enable PATs 1142 to be deployed on any of a plurality of supported blockchain networks while maintaining a uniform verification interface.

The multi-chain token verification architecture 1800 may include a chain-agnostic verification proxy 1802 that may provide a unified API for token verification operations regardless of the underlying blockchain. The chain-agnostic verification proxy 1802 may interface with one or more blockchain-specific adapter modules 1804, 1806, 1808. Each of the blockchain-specific adapter modules 1804, 1806, 1808 may implement the chain-specific logic for a particular blockchain network.

The system 1100 may support at least three categories of blockchain networks:
(a) Public Blockchain Adapters: Adapters for public, permissionless blockchain networks where any participant may read the ledger and verify token state. Exemplary public blockchain adapters include:
(a)(i) Algorand Adapter 1810: interfaces with the Algorand blockchain network.
PATs 1142 may be implemented as Algorand Standard Assets (ASAs). The Algorand adapter may support: ASA creation (minting) with metadata encoding the permission schema; ASA transfer to agent wallet addresses; ASA ownership verification via the Algorand indexer API; clawback-based revocation (described in detail below); and ASA destruction (burning);
(a)(ii) Ethereum L2/Base Adapter 1812: interfaces with Ethereum Layer 2 networks, specifically the Base network. PATs 1142 may be implemented as ERC-721 tokens via a deployed smart contract. The Ethereum L2/Base adapter may support: ERC-721 minting with metadata encoding the permission schema via token URI or on-chain storage; token transfer; ownership verification via ownerOf queries; and burn-based revocation via the token's burn function;
(a)(iii) Additional public blockchain adapters may be implemented for any public chain supporting non-fungible digital assets with metadata capabilities, including but not limited to Solana (using the Metaplex NFT standard), Polygon, Avalanche, and other EVM-compatible chains;
(b) Private/Permissioned Blockchain Adapters 1814: Adapters for private or permissioned blockchain networks where participation is restricted to authorized entities and consensus is achieved among a defined set of validator nodes. Exemplary private blockchain adapters include:
(b)(i) Hyperledger Fabric Adapter 1816: interfaces with Hyperledger Fabric networks. PATs 1142 may be implemented as assets managed by chaincode (smart contracts) deployed on the Hyperledger Fabric network. The adapter may implement: chaincode invocation for PAT 1142 minting with permission schema encoding in the world state database; ownership verification via chaincode queries; channel-based access control for verification operations; and revocation via chaincode state updates. The adapter may authenticate with the Hyperledger Fabric network's certificate authority and membership service provider;
(b)(ii) Enterprise Private Chain Adapter: a configurable adapter framework for enterprise-specific private blockchain implementations. The adapter may accept configuration parameters specifying: the chain's API endpoint and authentication mechanism; the asset creation and query interfaces; the metadata storage format; and the revocation mechanism, that may enable deployment on bespoke enterprise blockchains without requiring a purpose-built adapter;
(c) Hybrid Blockchain Adapters: Adapters for hybrid blockchain architectures that combine public and private components to balance transparency with confidentiality. In a hybrid configuration:
(c)(i) PAT 1142 minting and revocation transactions may be recorded on a public blockchain network, providing independent verifiability of authorization lifecycle events (creation, update, revocation) without revealing the content of the permissions;
(c)(ii) The permission schema content and detailed verification events may be recorded on a private or permissioned blockchain network, which may ensure that the specific authorization rules and access patterns remain confidential to authorized parties;
(c)(iii) The chain-agnostic verification proxy 1810 may coordinate between the public and private components, verifying token existence and validity on the public chain while retrieving permission schemas from the private chain.

The hybrid approach may enable organizations to satisfy regulatory requirements for independent auditability (via the public chain record) while maintaining the confidentiality of their authorization policies and agent activity patterns (via the private chain).

The chain-agnostic verification proxy 1802 may present a uniform interface to an enforcement proxy. The uniform interface may include the following operations:
(a) verifyOwnership(agentWalletAddress, tokenId, chainId): returns a Boolean indicating whether the specified wallet address owns (e.g., is associated with) the specified token on the specified chain;
(b) getPermissionSchema(tokenId, chainId): returns the permission schema encoded in the specified token on the specified chain;
(c) isTokenValid(tokenId, chainId): returns a Boolean indicating whether the token exists, has not been burned or clawed back, and has not expired;
(d) recordAuditEvent(eventData, chainId): records an audit event as a transaction on the specified chain.

The token format—specifically the permission schema structure—may be identical across all supported chains, whether public, private, or hybrid. The chain-agnostic token format may enable: (i) migration of agent authorization from one chain to another without modifying the permission schema; (ii) operation of agents across multiple chains simultaneously; (iii) the addition of new chain support without modification to the core verification logic; and (iv) organizations to select the blockchain network best suited to their regulatory, performance, and confidentiality requirements.

### LLM-Powered Permission Parsing

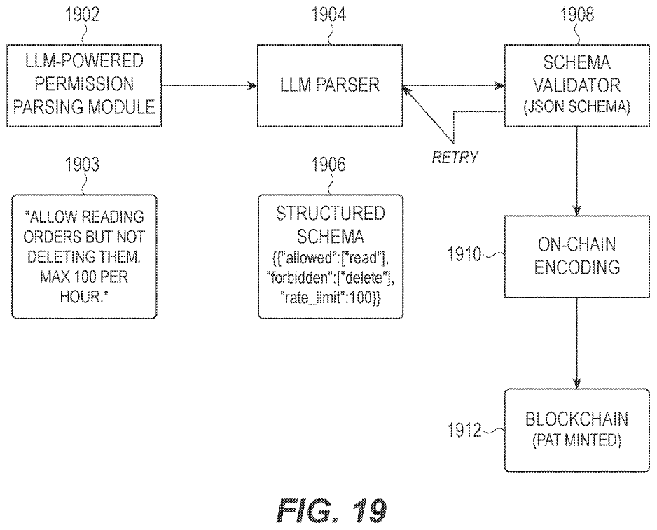

Referring to FIG. 19, the system 1100 may include an LLM-powered permission parsing module 1902 that enables administrators to specify complex permission schemas using natural language.

An administrator may accesses the LLM-powered permission parsing module via the administrative interface 1150 and provide a natural language description 1903 of the desired permissions. For example: “This agent can read emails from the claims inbox but cannot see attachments. It can only send emails to internal addresses ending in @agency. gov. Maximum 50 email sends per day. It must disclose that it is an AI system in all outgoing emails. It cannot forward any emails containing PII.”

The permission parsing module 1902 may transmit the natural language description 1903 to an LLM parser 1904. The permission parsing module 1902 may transmit the natural language description 1903 to the LLM parser 1904 along with a structured prompt template 1906 that may define the target permission schema format. The prompt template 1906 may specify the available permission fields (such as data rules, agent directives, and so on), their data types, valid values, and semantic constraints.

The LLM parser 1904 may process the natural language description and generate a structured permission schema in JSON or other format, which may use a schema validator 1908.

The permission parsing module 1902 may present the generated structured permission schema to the administrator for review and approval. The administrator may modify the structured permission schema manually or provide additional natural language refinements.

Upon administrator approval, the LLM-powered permission parsing module 1902 may encode the approved structured permission schema into a PAT 1142 at 1910 and initiate a minting transaction on the blockchain network 1140 at 1912.

The LLM-powered permission parsing module 1902 may provide several advantages:
(a) administrators without technical expertise in permission schema syntax may be able to define complex, nuanced permissions; (b) natural language descriptions may capture intent more accurately than manual form-filling; (c) the LLM parser 1904 may identify ambiguities or conflicts in the natural language description and prompt the administrator for clarification; and
(d) the review step may ensure that the automated parsing is verified by a human before being committed to the blockchain network 1140.

### Atomic Reissue

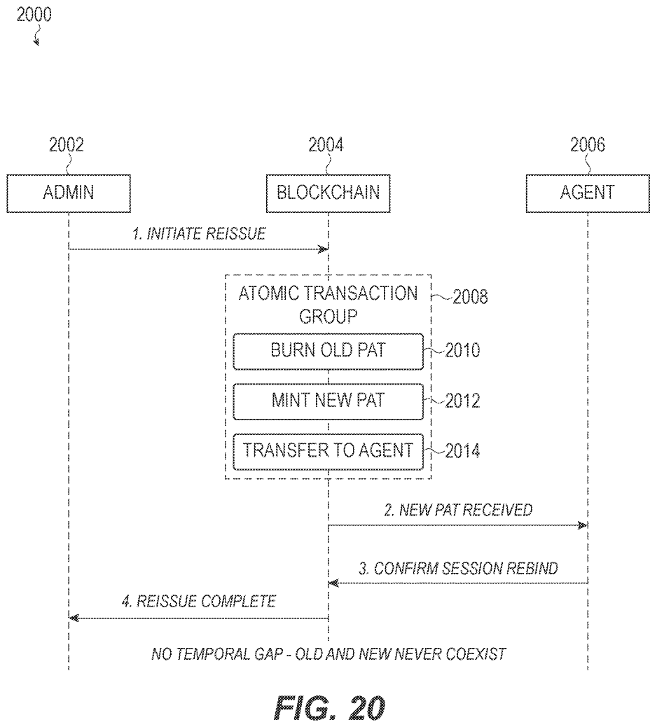

Referring to FIGS. 11 and 20, the system 1100 may implement atomic reissue 2000 for updating the permissions associated with an AI agent session.

When an administrator 2002 determines that an agent's permissions should be modified (e.g., expanding scope, restricting access, changing rate limits), the administrator 2002 may cause the system 1100 to execute the following atomic operations that may be submitted as an atomic transaction group 2008 to the blockchain 2004:

First, the administrative interface 1150 may prepare at least two transactions: a burn/revoke transaction 2010 for the existing PAT (old PAT 1142) and a mint transaction 2012 for a new PAT (new PAT 1142) encoding the updated permission schema. A transfer to agent transaction 2014 may also be prepared.

On blockchain networks supporting native atomic transaction groups (e.g., Algorand), the platform's built-in atomicity guarantee may be utilized. On blockchain networks using smart contracts (e.g., Ethereum L2/Base), a smart contract function may execute the burn/revoke transaction 2010, the mint transaction 2012, and/or the transfer to agent transaction 2014 within a single transaction. On private chains, the chaincode or smart contract implementation may ensure atomicity within a single endorsed transaction.

The blockchain 2004 may process the atomic transaction group 2008. If successful, the old PAT 1142 may be simultaneously revoked (burned or clawed back) and the new PAT 1142 may be minted and transferred to the wallet address of the agent 2006.

The atomicity of this operation may ensure:
(a) No Gap: there may be no temporal window during which the agent holds neither the old permissions nor the new permissions. At every point in time, the agent may have exactly one valid PAT;
(b) No Overlap: there may be no temporal window during which the agent holds both the old and new permissions simultaneously, which could be exploited to use old permissions that were intentionally revoked;
(c) Rollback Safety: if the mint of the new PAT 1142 fails for any reason (e.g., network issue, insufficient funds), the burn of the old PAT 1142 may also not execute, leaving the agent 2006 with existing permissions intact.

### Dual Verification Requirement

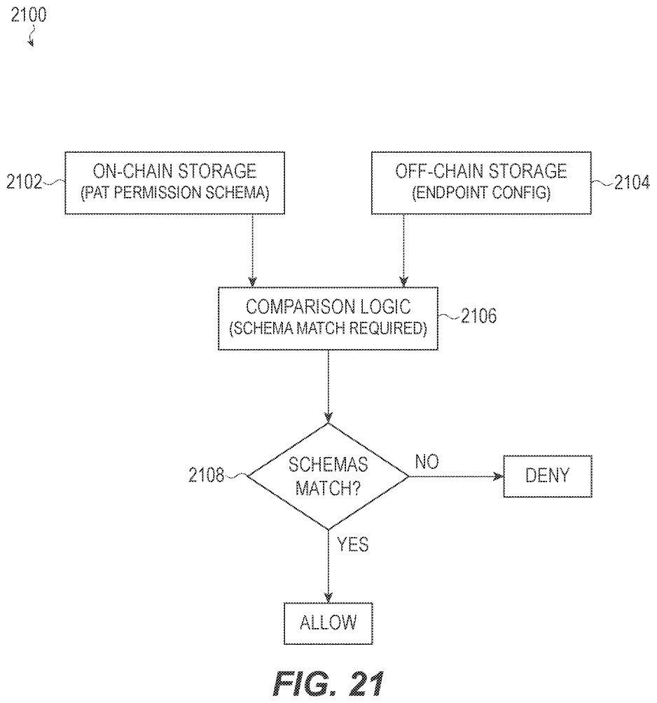

Referring to FIGS. 11 and 21, the system 1100 may implement a dual verification requirement 2100 as a defense-in-depth mechanism.

Under the dual verification requirement 2100, the permission schema governing an AI agent's access to a protected resource 1130 may be stored in at least two independent locations. These may include:
(a) On-Chain Permission Record stored at On-Chain Storage 2102: the permission schema encoded within the PAT 1142 on the blockchain network 1140, as described above;
(b) Off-Chain Endpoint Configuration stored at Off-Chain Storage 2104: a copy of the permission schema stored at or associated with the protected resource 1130, maintained independently of the blockchain network 1140. The off-chain storage 2104 may be stored in: a configuration database at the protected resource 1130; an API gateway configuration; an environment variable set at the protected resource 1130 endpoint; or a separate access control system.

During verification, an enforcement proxy may retrieve both the on-chain permission record and the off-chain endpoint configuration and use comparison logic 2106 to compare them. At 2108, if the two records match (or correspond), verification may proceed (subject to the other verification checks). If the records do not match, access may be denied regardless of whether either record individually would authorize the request.

The dual verification requirement 2100 may provide the following security properties:
(a) Defense in Depth: an attacker may need to compromise both the On-Chain Permission Record (requiring private key compromise or consensus attack) and the Off-Chain Endpoint Configuration (requiring infrastructure access) to grant unauthorized access. Compromising either one alone may be insufficient;
(b) Emergency Lockout: the Off-Chain Endpoint Configuration may be updated immediately to revoke access, even before an on-chain revocation transaction is confirmed. This may provide a rapid response capability for security incidents. For example, an endpoint administrator may modify the Off-Chain Endpoint Configuration to create a mismatch, which may immediately deny access;
(c) Tamper Detection: if an attacker modifies the On-Chain Permission Record, the mismatch with the Off-Chain Endpoint Configuration may trigger access denial and alert the administrator.

### Instant Revocation Mechanisms

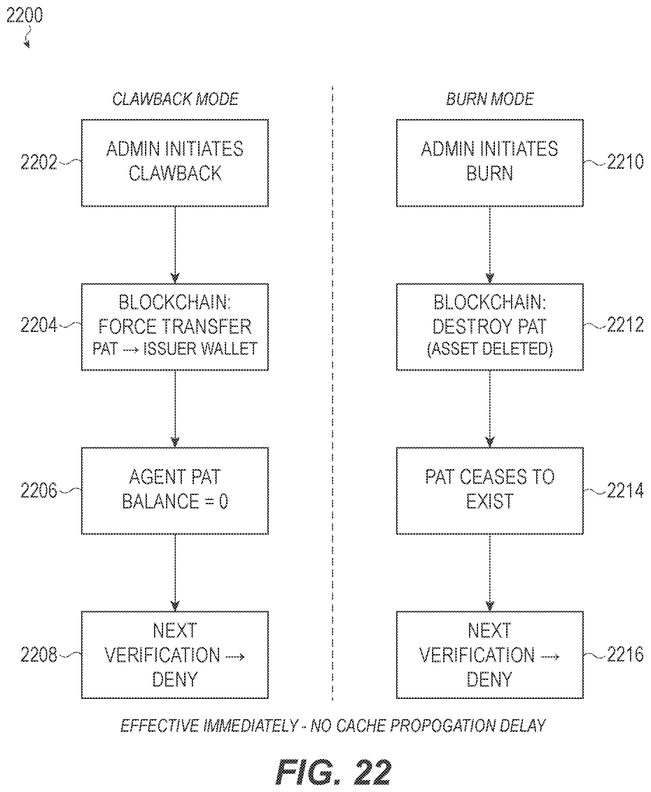

Referring to FIGS. 11 and 22, the system 1100 may support multiple revocation mechanisms 2200 depending on the capabilities of the underlying blockchain network. These multiple revocation mechanisms may include a clawback mode (illustrated as including steps 2202, 2204, 2206, and 2208), a burn mode (illustrated as including operations 2210, 2212, 2214, and 2216), and so on.

On blockchain networks supporting native clawback or forced-transfer functionality (e.g., Algorand's clawback feature), the issuing authority may retain a clawback address for all PATs 1142 minted on that network. To revoke an agent's permissions, the issuing authority may submit a single clawback transaction that transfers the PAT from the agent wallet address back to the issuer address. This transaction may:
(a) execute as a single atomic transaction, with confirmation time dependent on the blockchain's consensus mechanism (e.g., approximately 4 seconds on Algorand);
(b) immediately remove the PAT 1142 from the agent's wallet, such that subsequent ownership verification queries return negative;
(c) require no cache invalidation, session management, or propagation delay—the revocation may be effective as soon as the transaction is confirmed on the blockchain;
(d) be recorded as an immutable transaction on the blockchain, which may provide a permanent, timestamped record of the revocation.

On blockchain networks using burn-based revocation (e.g., ERC-721 on Ethereum L2), the issuing authority or an authorized operator may call a burn function on the smart contract that destroys the PAT 1142, permanently removing it from circulation.

On private or permissioned blockchain networks, revocation may be implemented through chaincode state updates that mark the PAT 1142 as revoked, with the specific mechanism determined by the chain's asset management framework.

In all cases, the revocation mechanism may provide near-instantaneous permission termination compared to traditional token revocation mechanisms that may suffer minutes to hours of propagation delay in distributed systems.

### Comprehensive On-chain Audit Trail

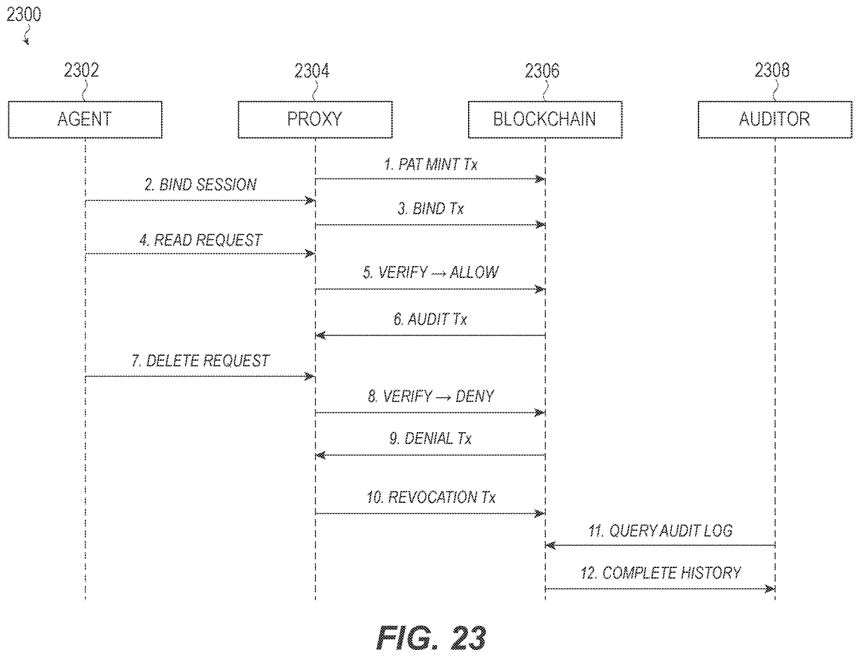

Referring to FIGS. 11 and 23, the audit module 1160 may record all authorization-related events as immutable transactions on the blockchain network 1140, which may create a comprehensive on-chain audit trail 2300. The comprehensive on-chain audit trail 2300 may include interactions between agents 2302, proxies 2304, blockchains 2306 and auditors 2308.

The following event types may be recorded:
(a) Authorization Grant: when a PAT 1142 is minted and transferred to an agent wallet, which may include the full permission schema, agent session identifier, and issuing authority identity;
(b) Verification Allowed: when an agent request passes verification and is authorized, which may include the request type, target resource, timestamp, and agent session identifier;
(c) Verification Denied: when an agent request fails verification and is denied, which may include the request type, target resource, denial reason, timestamp, and agent session identifier;
(d) Permission Update: when a PAT 1142 is reissued via atomic reissue, which may include the old and new permission schemas, the timestamp, and the administering authority identity;
(e) Revocation: when a PAT 1142 is revoked (burned or clawed back), which may include the timestamp, revoking authority identity, and reason;
(f) Integrity Violation: when a binary integrity check fails or a dual verification mismatch is detected, which may include the nature of the violation, timestamp, and affected agent session;
(g) Delegation Event: when a hierarchical delegation is created or revoked, which may include the parent and child token identifiers, the delegated permission scope, and the delegating authority identity.

Each audit event may be recorded as a blockchain transaction containing structured metadata (in JSON or other format) in the transaction's note or data field. The transaction may be signed by the recording authority (an enforcement proxy, a token verification module, and so on) using its own blockchain identity, which may provide non-repudiation.

The on-chain audit trail may provide:
(a) Immutability: audit records may not be altered, deleted, or backdated after recording;
(b) Independent Verifiability: any third party with access to the blockchain (e.g., auditors, regulators, compliance officers) may independently retrieve and verify the audit trail without requesting records from a system operator;
(c) Completeness: every authorization event may be recorded, including both allowed and denied actions, which may provide a complete picture of agent behavior;
(d) Tamper Evidence: any attempt to retroactively alter the audit trail may require modifying confirmed blockchain transactions, which may be computationally infeasible.

Dual Product Architecture (Plugin Mode vs. Kernel Mode)

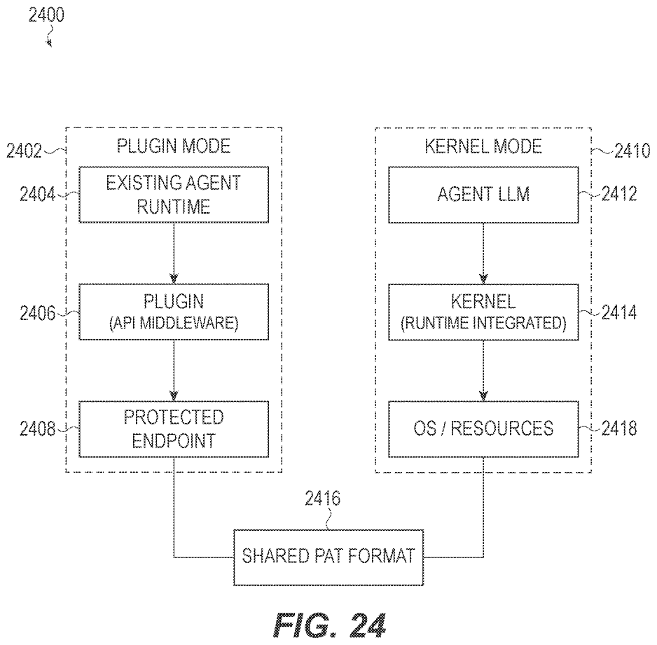

Referring to FIGS. 11 and 24, the system 1100 may support at least two deployment architectures 2400. These may include a plugin mode 2402 architecture and a kernel mode 2410 architecture.

Plugin mode 2402 may encompass the existing AI agent's runtime environment 2404, a plugin 2406, and the protected endpoint 2408. The kernel mode 2410 may encompass the agent LLM 2412, the kernel 2414, and OS/resources 2418.

Plugin Mode 2402 may deploy an enforcement proxy as a middleware layer external to the AI agent's runtime environment 2404. In plugin mode 2402:
(a) the enforcement proxy 1120 may operate as a separate process, container, or network service that intercepts network traffic between the AI agent 1110 and the protected resources 1130;
(b) the AI agent's runtime environment 2404 may be unmodified—no changes to the runtime may be required for deployment;
(c) a hard enforcement layer may operate at a network boundary, filtering requests and responses as they traverse the enforcement proxy;
(d) plugin mode 2402 may be suitable for deployment with existing AI agent platforms where runtime modification is not possible or practical;
(e) plugin mode 2402 may provide strong security for network-mediated interactions but may not control local operations (file system, shell commands) unless those operations are also routed through the enforcement proxy 1120.

Kernel mode 2410 may embed a token verification module directly within the AI agent's runtime execution layer, as described above. In kernel mode 2410:
(a) every tool call may pass through on-chain verification before execution that may include local operations;
(b) the AI agent 1110 may be fully sandboxed with no direct operating system 1180 access;
(c) the binary integrity self-check may prevent tampering with the runtime;
(d) kernel mode 2410 may provide a highest level of security assurance but may require a compatible runtime environment.

The shared PAT format 2416 and permission schema may be identical in both plugin mode 2402 and kernel mode 2410. An agent's permissions may be encoded in the same blockchain token regardless of whether in plugin mode 2402 or kernel mode 2410. This may enable a seamless upgrade path from plugin mode 2402 to kernel mode 2410. An organization may initially deploy in plugin mode 2402 with existing agent infrastructure, then migrate to kernel mode 2410 when a compatible runtime is adopted, without reissuing any PATs.

### Document Integrity System

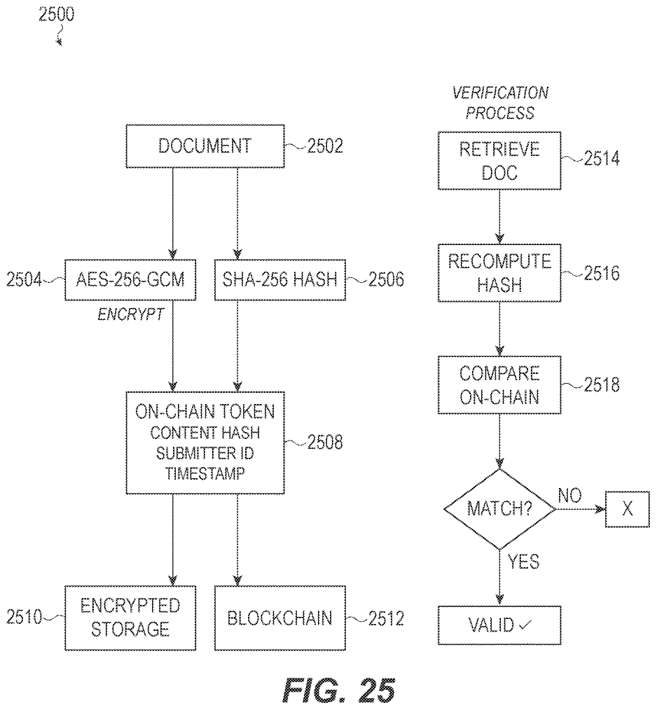

Referring to FIGS. 11 and 25, the system 1100 may include a document integrity subsystem 2500 that may provide tamper-proof chain of custody for documents and data submissions.

A document 2502 or data submission may be received from a submitting party.

The document may be encrypted using AES-256-GCM 2504 (Advanced Encryption Standard with Galois/Counter Mode) with a unique encryption key. AES-256-GCM 2504 may provide both confidentiality and authentication of the encrypted data.

A SHA-256 hash 2506 of the original (pre-encryption) document may be computed. The SHA-256 hash 2506 may serve as a unique fingerprint of the document content.

The submitting party may sign the SHA-256 hash 2506 using their Ed25519 and/or other private key, producing a submitter signature that may cryptographically bind the submitting party's identity to the document content.

The authorized submitter (e.g., a receiving authority, notary, or system administrator) may countersign the submission using their Ed25519 and/or other private key, attesting to the receipt and acceptance of the submission.

A blockchain token 2508 may be minted on the blockchain network 1140 containing: content_hash: the SHA-256 hash 1506 of the document;—submitter_identity: the Ed25519 and/or other public key and signature of the submitting party;—authorized_submitter_signature: the Ed25519 and/or other signature of the authorized submitter;—block_timestamp: the blockchain-attested timestamp of the minting transaction (not self-reported);—record_type: a classification of the record type (e.g., “death_certificate,” “financial_statement,” “medical_record”).

The encrypted document may be stored in a secure storage system (e.g., encrypted database 2510, object storage, and so on).

For subsequent verification, any party with appropriate access may:
(a) at 2514, retrieve the encrypted document from storage and decrypt it with the appropriate key;
(b) at 2516, recompute the SHA-256 hash 2506 of the decrypted document;
(c) at 2518, compare the recomputed hash against the content_hash stored on the blockchain 2512. A match (or correspondence) may confirm that the document has not been modified since tokenization. A mismatch may prove tampering.

For additional subsequent verification, any party with appropriate access may also:
(d) verify the submitter signature and authorized submitter signature to confirm the identities of the parties involved in the submission;
(e) check the block_timestamp to confirm when the submission was recorded, with the timestamp being attested by the blockchain consensus mechanism rather than reported by the submitting party.

The document integrity subsystem may be particularly applicable to regulated record-keeping in government and healthcare contexts, where chain-of-custody integrity and tamper detection may be required by law or regulation.

### Fail-Closed Architecture

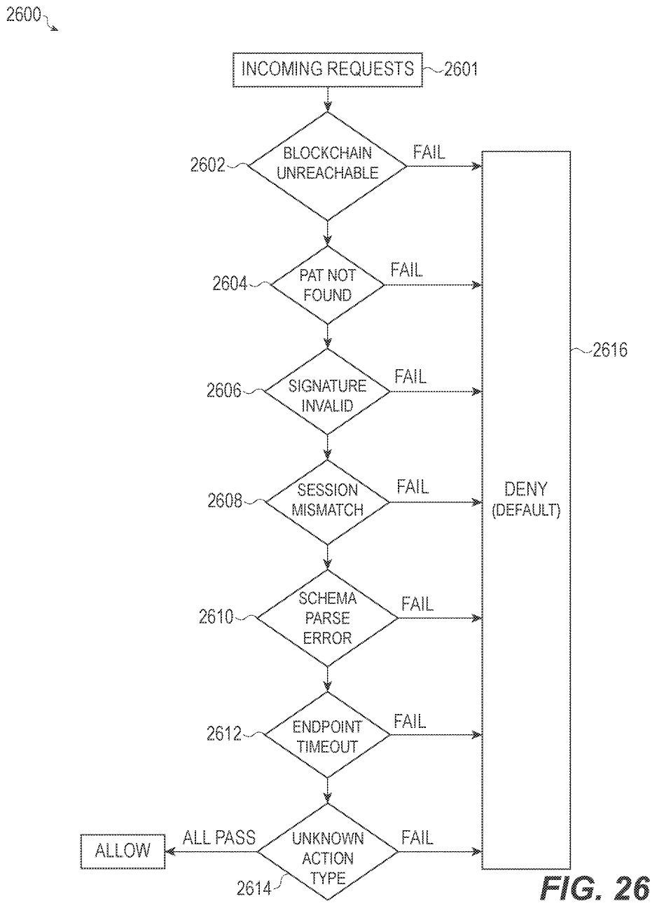

Referring to FIGS. 11 and 26, the system 1100 may implement a fail-closed architecture 2600 wherein every failure condition may default to access denial.

The fail-closed architecture 2600 may apply to the following failure conditions:
(a) Blockchain Unreachable 2602: if the enforcement proxy 1120 or the token verification module cannot reach the blockchain network 1140 to verify token ownership, validity, or permission schema, the request may be denied 2616;
(b) Token Not Found 2604: if no PAT 1142 is found for the requesting agent session on the blockchain, the request may be denied 2616;
(c) Signature Verification Failure 2606: if the Ed25519 and/or other signature challenge-response fails for any reason (invalid signature, timeout, malformed response), the request may be denied 2616;
(d) Session Mismatch 2608: if the session does not match, the request may be denied 2616;
(e) Permission Schema Parse Error 2610: if the permission schema retrieved from the PAT 1142 cannot be parsed or is malformed, the request may be denied 2616;
(f) Endpoint Timeout 2612: if the endpoint times out, the request may be denied 2616;
(g) Unknown Action Type 2614: if the action type is unknown, the request may be denied 2616.

The fail-closed architecture 2600 may also apply to the following additional failure conditions:

Dual Verification Mismatch: if the on-chain and off-chain permission records do not match, the request may be denied 2616;

Rate Limit Exceeded: if the agent has exceeded its rate limit, the request may be denied 2616;

Binary Integrity Failure: if the runtime binary integrity check fails, the entire runtime terminates and the request may be denied 2616;

Temporal or Geographic Constraint Violation: if the current time is outside the permitted temporal window or the request violates geographic constraints, the request may be denied 2616;

Any Unexpected Error: for any error condition not specifically enumerated above, including network timeouts, database failures, parsing errors, or unanticipated exceptions, the request may be denied 2616.

The fail-closed architecture 2600 may ensure that the system 1100 never fails open. In other words, the system 1100 nay never grant access due to a failure condition. This may be a significant security property for regulated environments where unauthorized data access may need to be prevented even at the cost of service availability.

### Compliance and Regulatory Alignment

The system 1100 may align with multiple regulatory and compliance frameworks. These may include:
(a) SOC 2 (Service Organization Control 2): the comprehensive on-chain audit trail and fail-closed architecture 2600 may support SOC 2 Trust Services Criteria for security, availability, processing integrity, confidentiality, and privacy;
(b) GDPR (General Data Protection Regulation): the field-level filtering and redaction capabilities of the hard enforcement layer, combined with the purpose_statement in agent directives, may support GDPR principles of data minimization, purpose limitation, and the right to be forgotten (such as by excluding personal data from agent access);
(c) HIPAA (Health Insurance Portability and Accountability Act): The encryption (AES-256-GCM), access controls (PAT-based), audit logging (on-chain), and data filtering capabilities may align with HIPAA Security rule requirements for electronic protected health information (ePHI).

### Example Use Case: Government Agency AI Agent Governance

In an exemplary embodiment, the system 1100 may be deployed at a government agency for governing AI agents used in fraud detection:

An AI agent may be deployed to assist in processing death record verifications and detecting potential fraud in benefit payments. The administrator may define the agent's permissions in natural language via the administrative interface: “This agent can read death records from the vital statistics database. It cannot access Social Security numbers directly—they must be masked. It can flag records for human review but cannot modify any records. It must log all access at the full audit level. Maximum 1000 records per day.”

The LLM-powered permission parsing module may convert this to a structured permission schema with: allowed_actions=[“records.read”, “records.flag_review”]; exclude_fields=[ ]; redaction_patterns=[“--]; rate_limits={“records.read”: {“max”: 1000, “window”: “24 h”}}; agent_directives including purpose_statement=“Fraud detection in death record verification” and audit_level=“full”.

The PAT 1142 may be minted on the organization's selected blockchain network 1140 with appropriate revocation authority retained by the agency. The agent may operate in kernel mode with all tool calls verified on-chain. If the agent is compromised via prompt injection, the hard enforcement layer may prevent it from accessing social security numbers (redacted), modifying records (not in allowed_actions), or exfiltrating data (no unauthorized send capability). If the agent must be decommissioned, a single revocation transaction may terminate all access within seconds.

All authorization events—every record access, every flagged review, every denied attempt—may be recorded on the blockchain network 1140 and be available for independent audit by the Office of Inspector General without requesting records from the agency.

### Hierarchical Token Delegation

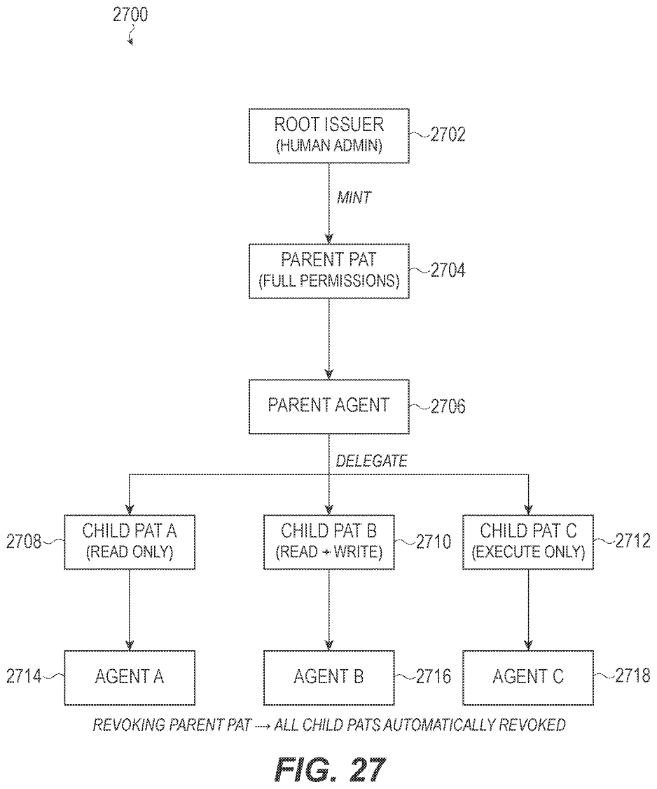

Referring to FIGS. 11 and 27, the system 1100 may include a hierarchical delegation module 2700 that may enable structured delegation of permissions across multi-agent architectures.

In enterprise deployments, AI agent systems frequently include multiple agents operating in hierarchical relationships. For example, a supervisory agent may coordinate the activities of multiple task-specific sub-agents, each using a subset of the supervisory agent's permissions. The hierarchical delegation module 2700 may provide a cryptographically enforced mechanism for this delegation.

A first AI agent (the “delegating agent”) holding a first PAT 1142 may submit a delegation request to the hierarchical delegation module. The delegation request may specify: a target agent session identifier for the agent to receive the delegated permissions; and a delegated permission scope that may be required to be a strict subset of the permission schema encoded in the first PAT 1142.

The hierarchical delegation module 2700 may validate the delegation request by: (a) verifying that the delegating agent currently holds a valid PAT 1142; (b) verifying that the delegated permission scope is a strict subset of the permission schema (i.e., every permission in the delegated scope is present in and no broader than the corresponding permission schema); and (c) verifying that the first PAT 1142's delegation constraints permit further delegation (i.e., the delegation depth has not been exceeded).

Upon successful validation, the hierarchical delegation module may mint a second PAT 1142 on the blockchain network 1140 encoding: the delegated permission scope as its permission schema; the target agent session identifier; a parent token reference pointing to the first PAT 1142; and a delegation depth indicator incremented from the parent's depth.

The second PAT 1142 may be transferred to the wallet address of the target agent session.

The hierarchical delegation module may enforce the following invariants:
(a) Subset Enforcement: a delegated PAT may never encode permissions broader than its parent PAT. The system 1100 may perform a formal comparison of permission schemas to prevent privilege escalation through delegation.
(b) Cascading Revocation: revocation of a parent PAT may automatically invalidate all descendant PATs 1142 in the delegation chain. The enforcement proxy 1120, upon verifying any PAT 1142 with a parent token reference, may traverse the delegation chain to confirm that all ancestor PATs 1142 remain valid. If any ancestor has been revoked, the descendant PAT 1142 may be treated as invalid.
(c) Delegation Depth Limits: the delegation constraints may specify a maximum delegation depth, preventing unbounded chains of delegation that could complicate audit trails or introduce verification latency.
(d) Audit Linkage: all actions performed by a delegate agent may be linked in the audit trail to both the delegate's PAT 1142 and the delegating agent's PAT 1142, providing end-to-end visibility into delegation-based agent activities.

As shown, a root issuer 2702 may mint a parent PAT 2704 that includes full permissions and provide such to a parent agent 2706. The parent agent 2706 may create child PATs A 2708, B 2710, and C 2712 that include a subset of the full permissions and provide such respective to agents A 2714, B 2716, and C 2718.

### Temporal and Geographic Permission Scoping

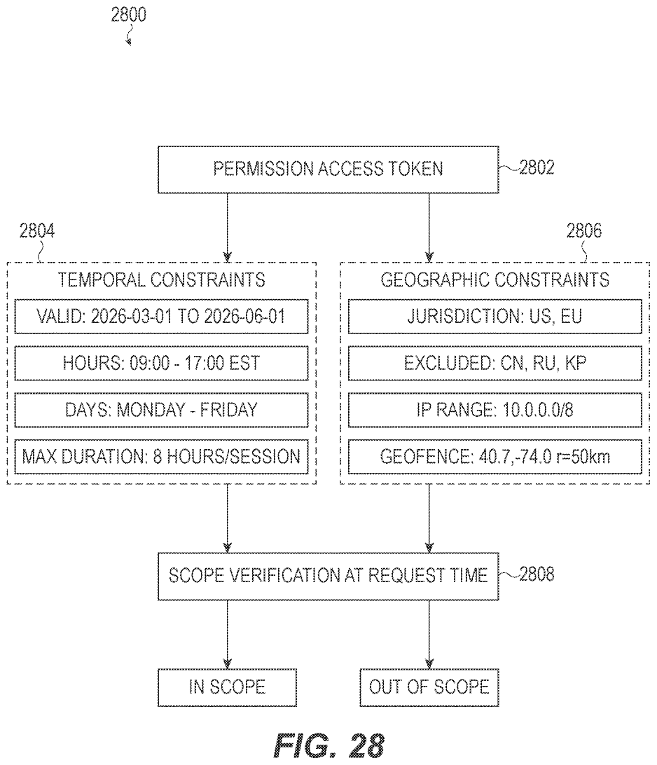

Referring to FIGS. 11 and 28, the system 1100 may provide temporal and geographic permission scoping 2800 that constrains when and where agent permissions are active.

Temporal constraints 2804 may be encoded within the permission schema of the PAT 2802 and be evaluated by the enforcement proxy 1120 for every request, which may be performed along with scope verification at request time 2808. Temporal constraints 2804 may include:
(a) Time-of-Day Restrictions: permissions may be active only during specified hours (e.g., 08:00-17:00 in a specified time zone). This may enable organizations to restrict AI agent access to business hours, which may prevent unauthorized after-hours activity.
(b) Day-of-Week Restrictions: permissions may be active only on specified days (e.g., Monday through Friday). Combined with time-of-day restrictions, this may provide fine-grained temporal scoping.
(c) Temporal Windows: permissions may be active only between a specified start datetime and end datetime. This may enable time-limited authorization for specific tasks or projects.
(d) Time Zone Specification: all temporal constraints may include a time zone identifier to eliminate ambiguity in distributed systems operating across time zones.

The enforcement proxy 1120 may evaluate temporal constraints using a timestamp source independent of the AI agent, which may ensure that a compromised agent cannot manipulate time-related checks.

Geographic constraints 2806 may be similarly encoded and enforced. Geographic constraints 2806 may include:
(a) Permitted Jurisdictions: data access may be restricted to data classified under specified jurisdictions. For example, an agent authorized to process EU-resident data may be prohibited from accessing data classified under other jurisdictions.
(b) Data Residency Requirements: response data may not be forwarded, stored, or processed outside specified geographic regions. The enforcement proxy 1120 may enforce this by restricting the destinations to which the agent may transmit data.
(c) Network Origin Restrictions: requests may be authorized only when originating from specified IP address ranges or geographic regions, as determined by the enforcement proxy's network-level inspection.

Temporal and geographic constraints may interact with the fail-closed architecture. Violations may result in immediate request denial with full audit logging.

### Permission Composition for Multi-Token Agents

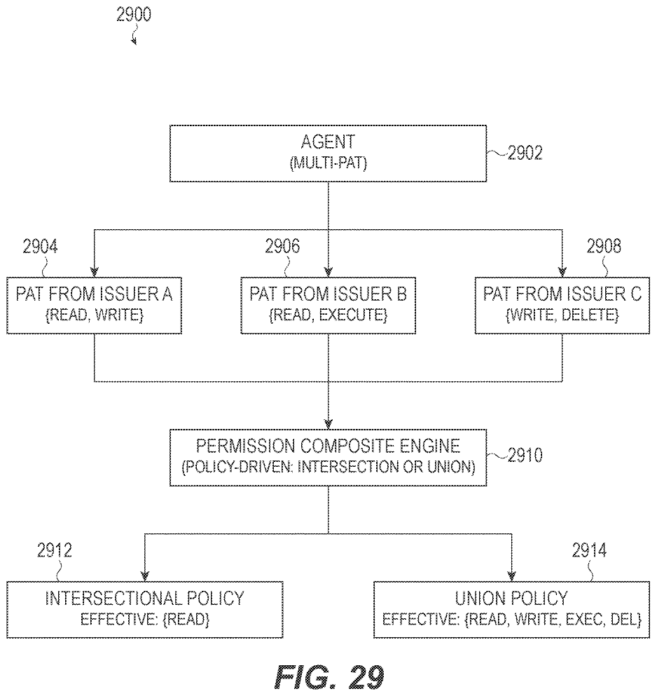

Referring to FIGS. 11 and 29, the system 1100 may support permission composition 2900 for AI agents 2902 that hold multiple PATs 1142 issued by different issuing authorities 2904, 2906, 2908.

In complex enterprise environments, an AI agent may be authorized by multiple authorities. For example, a compliance agent might hold one PAT 1142 from the IT security team (granting system access) and another from the legal department (granting document access). The permission composition module may compute the agent's effective permissions from all held PATs 1142.

The system may support two composition policies:
(a) Intersection Policy 2912: the effective permission scope may include actions authorized by all held PATs 1142. This may be the most restrictive composition and may be the default. Under intersection policy 2912, if any issuing authority has not granted a particular permission, the agent may not be able to perform that action.
(b) Union Policy 2914: the effective permission scope may include actions authorized by any held PAT 1142. This may be less restrictive and may be used when each PAT 1142 represents independent, non-overlapping authorization domains.

The composition policy may be specified by the system 1100 administrator and may be configured per-agent or per-protected-resource. For each authorization event, the audit module 1160 may record which PATs 1142 contributed to the authorization decision, which may maintain full traceability.

When PATs 1142 from different issuers contain conflicting directives (e.g., different rate limits for the same action), the system 1100 may apply the most restrictive constraint under intersection policy 2912 or the least restrictive under union policy 2914.

### Privacy-Preserving Verification

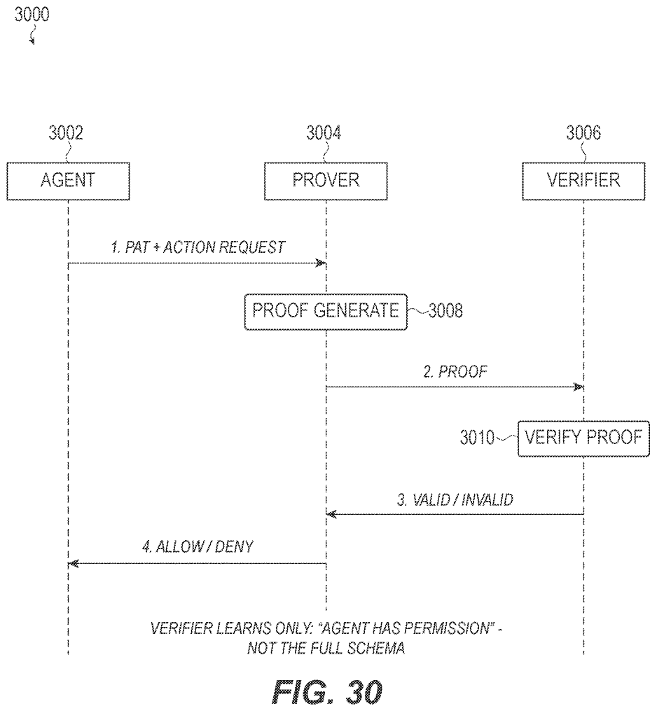

Referring to FIGS. 11 and 30, the system 1100 may include a privacy-preserving verification module 3000 that may enable authorization verification without revealing the complete permission schema to the verifying party.

As shown, an agent 3002 may submit a PAT 1142 and an action request to a prover 3004. The prover 3004 may generate a proof 3008 and provide such to a verifier 3006, who may verify the proof 3008, which may be a zero-knowledge proof. The verifier 3006 may return whether the proof 3008 is valid or invalid and the prover 3004 may then allow or deny.

In certain deployments, the full permission schema may be confidential (e.g., the specific data fields an agent is authorized to access may reveal sensitive information about the organization's data architecture). The privacy-preserving verification module may use zero-knowledge proof techniques to prove that a specific requested action is authorized by the PAT 1142 without revealing the full scope of the PAT's 1142 permissions.

The enforcement proxy may formulate a verification query: “Is action X authorized by PAT Y?”

The privacy-preserving verification module may generate a zero-knowledge proof demonstrating that the permission schema encoded in the PAT 1142 includes authorization for action X. The proof may be generated using a zero-knowledge proof system (e.g., zk-SNARKs, zk-STARKs, or Bulletproofs) and may reveal only the binary authorization decision (authorized or not) without disclosing any other permissions in the schema.

The enforcement proxy 1120 (or the protected resource 1130) may verify the zero-knowledge proof. If the proof is valid, the request may be authorized. If the proof is invalid or cannot be generated (because the action is not authorized), the request may be denied.

Privacy-preserving verification may be particularly valuable in multi-party environments where the protected resource 1130 operator perhaps should not learn the full extent of the agent's authorization, or in competitive environments where permission schemas may reveal strategic information.

### Cached Verification with Time-Bounded Local Authorization

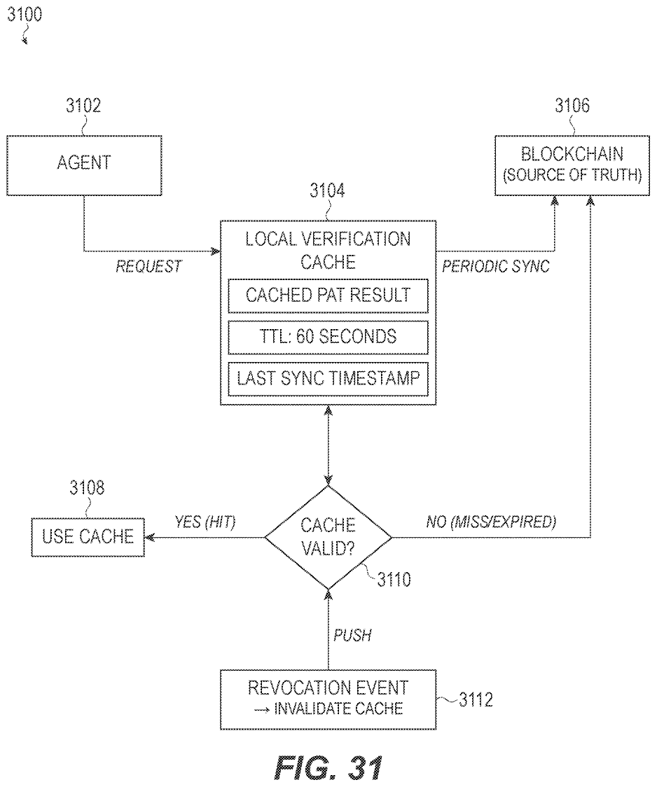

Referring to FIGS. 11 and 31, the system 1100 may include a cached verification module 3100 that may provide performance optimization for high-frequency tool call scenarios while maintaining security guarantees.

In kernel mode operation, where every tool call may require on-chain verification, blockchain query latency may impact AI agent 3102 performance for workflows requiring rapid sequential tool calls. The cached verification module may address this by maintaining a time-bounded local verification cache 3104.

Requests from the AI agent 3102 may be submitted to the local verification cache 3104, which may be synched with the blockchain 3106. If the local verification cache 3104 is determined to be valid 3108, the local verification cache 3104 may be used 3110. A revocation event 3112 may invalidate the local verification cache 3104.

Upon the first verification for an agent session, the enforcement proxy 1120 or token verification module may query the blockchain 3106 and retrieve the PAT 1142 and its permission schema.

The verification result and permission schema may be stored in the local verification cache 3104 with a time-to-live (TTL) value. The TTL may be set by the issuing authority as part of the PAT 1142 metadata and may not be modifiable by the AI agent 3102. Typical TTL values may range from 5 seconds to 60 seconds.

For subsequent requests within the TTL period, the enforcement proxy 1120 or token verification module may evaluate the request against the cached permission schema in the local verification cache 3104 without querying the blockchain 3106. This may eliminate blockchain 3106 query latency for high-frequency operations.

The local verification cache 3104 may be invalidated upon any of: (a) TTL expiration, triggering a fresh on-chain verification; (b) receipt of a revocation event from a blockchain 3106 subscription or webhook, which may ensure that revocations take effect within the TTL window at most; or (c) detection of a network connectivity restoration after a period of unreachability, which may trigger mandatory re-verification.

The cached verification module may maintain the fail-closed architecture. If the local verification cache 3104 is empty or expired and the blockchain 3106 is unreachable, the request may be denied. The local verification cache 3104 may never be populated from any source other than a verified on-chain query.

### Cross-Agent Permission Inheritance for Multi-Agent Workflows

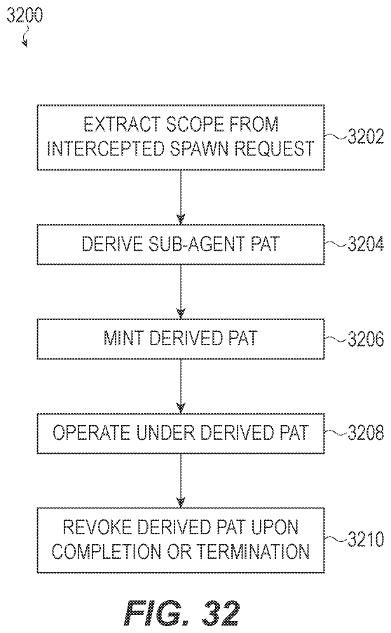

Referring to FIGS. 11 and 32, the system 1100 may provide cross-agent permission inheritance 3200 for multi-agent workflow scenarios in which a primary AI agent 1110 spawns one or more sub-agents to perform delegated tasks.

Cross-agent permission inheritance may differ from hierarchical delegation in that cross-agent permission inheritance may be automatic and workflow-driven rather than administratively pre-configured. When a primary AI agent 1110 spawns a sub-agent within its runtime environment 1112, the following steps may be performed.

At step 3202, the runtime environment 1112 may intercept the sub-agent spawn request and extract the intended scope of the sub-agent's operations from the spawn parameters.

At step 3204, a cross-agent permission inheritance module may derive a sub-agent PAT 1142 from the spawning agent's PAT 1142. The derived PAT 1142 may encode: a permission schema that may be the intersection of the spawning agent's permission schema and the intended sub-agent scope; the sub-agent's session identifier; a parent token reference linking to the spawning agent's PAT 1142; and a delegation depth indicator.

At step 3206, the derived PAT 1142 may be minted on the blockchain network 1140 and transferred to the sub-agent's wallet address. The minting may be recorded as a delegation event in the audit trail, which may be linked to the spawning agent's PAT 1142.

At step 3208, the sub-agent may operate under the derived PAT 1142, which may be subject to all the same enforcement mechanisms (dual-layer, fail-closed, etc.) as any other AI agent 1110 in the system.

At step 3210, when the sub-agent completes its task or the spawning agent terminates the sub-agent, the derived PAT 1142 may be automatically revoked.

The cross-agent permission inheritance module may enforce that: (a) a sub-agent's permissions may never exceed its spawning agent's permissions; (b) revocation of the spawning agent's PAT 1142 may cascade to all sub-agent PATs 1142; (c) all sub-agent actions may be linked in the audit trail to the spawning agent, which may provide end-to-end workflow traceability; and (d) sub-agents may not be able to further spawn sub-sub-agents beyond the delegation depth limit specified in the originating PAT 1142.

### Emergency Override Protocol

Referring again to FIG. 11, the system 1100 may include an emergency override protocol for situations requiring immediate deviation from normal authorization workflows. Examples of such situations may include, but are not limited to, security incidents, regulatory emergencies, or critical system failures.

The emergency override protocol may operate as follows:
(a) Multi-Party Authorization: an emergency override may require authorization from M of N designated emergency authorities, where M and N may be configured by a system administrator. No single party may be able to unilaterally invoke an emergency override.
(b) Scope: an emergency override may: (i) immediately revoke all PATs 1142 associated with a specified AI agent 1110, AI agent 1110 group, or issuing authority; (ii) temporarily suspend all agent operations pending investigation; or (iii) grant time-limited emergency access to a specifically designated human operator.
(c) Enhanced Audit: all actions taken during an emergency override may be logged with an elevated audit level, including the identities of all authorizing parties, the justification for the override, and a complete record of all actions taken.
(d) Automatic Expiration: emergency overrides may be time-limited and automatically expire after a configured duration (e.g., 4 hours), after which normal authorization procedures may resume. Extension may require re-authorization from M of N authorities.
(e) Immutable Record: the emergency override itself—its invocation, scope, authorizing parties, duration, and all actions taken—may be recorded as an immutable blockchain transaction. This may ensure that emergency powers may be subject to the same audit and accountability mechanisms as normal operations.

The emergency override protocol may not disable or bypass the audit trail. Even during an emergency, all actions may be fully logged and independently verifiable.

In various implementations, a system for authorizing actions of an artificial intelligence agent may include a permission access token stored as a non-fungible digital asset on at least one blockchain network, the permission access token encoding a permission schema defining a scope of authorized actions for the artificial intelligence agent, the permission access token further encoding an agent session identifier and an agent wallet address, the agent session identifier being cryptographically bound to the permission access token by a digital signature such that the permission access token is non-transferable to a different agent session; an enforcement proxy interposed between the artificial intelligence agent and one or more protected resources that intercepts a request from the artificial intelligence agent directed to at least one of the one or more protected resources; verifies, via the at least one blockchain network, that the agent wallet address is associated with a current session of the artificial intelligence agent associated with the permission access token; verifies that the agent session identifier encoded in the permission access token corresponds to the current session of the artificial intelligence agent by performing a signature challenge-response verification; determines whether the request is within the scope of authorized actions defined by the permission schema; authorizes the request at least when the agent wallet address is associated with the current session of the artificial intelligence agent associated with the permission access token, the agent session identifier encoded in the permission access token corresponds to the current session of the artificial intelligence agent, and the request is within the scope of authorized actions defined by the permission schema; and denies the request at least when the agent wallet address is not associated with the current session of the artificial intelligence agent associated with the permission access token, the agent session identifier encoded in the permission access token does not correspond to the current session of the artificial intelligence agent, or the request is not within the scope of authorized actions defined by the permission schema; and an audit module that records verification events and authorization events as immutable transactions on the at least one blockchain network.

In some examples, the enforcement proxy may implement a hard enforcement layer that enforces data rules at the enforcement proxy external to the artificial intelligence agent, the data rules being non-bypassable by the artificial intelligence agent, and a soft enforcement layer that injects behavioral directives into data responses provided to the artificial intelligence agent. In a number of such examples, the data rules of the hard enforcement layer may include at least one of field-level return filtering specifying fields to include or exclude from the data responses; redaction patterns applied to the data responses; an allowed recipients list limiting recipients to which the artificial intelligence agent may direct communications; a blocked recipients list prohibiting the artificial intelligence agent from directing communications to specified recipients; rate limits specifying a maximum number of requests within a defined time window; or a maximum results threshold limiting a quantity of records returned in a single response. In various such examples, the behavioral directives of the soft enforcement layer may include at least one of a purpose statement defining an authorized purpose for use of accessed data by the artificial intelligence agent; an allowed behaviors list specifying permitted actions; a forbidden behaviors list specifying prohibited actions; a disclosure text requirement for inclusion in agent-generated output; or an audit level specification. In some such examples, the data rules of the hard enforcement layer may be enforced at the enforcement proxy.

In a number of examples, the system may further include a token verification module embedded within a runtime execution layer of the artificial intelligence agent that intercepts tool calls generated by a large language model of the artificial intelligence agent and performs on-chain verification of the permission access token prior to execution of the tool calls. In various such examples, the tool calls intercepted by the token verification module may include at least one of a file read operation; a file write operation; a shell command execution; a network request; a message transmission; a browser control action; and a sub-agent spawning. In some such examples, the artificial intelligence agent may operate in a sandboxed environment in which the large language model lacks direct access to an operating system of a host computing device; the runtime execution layer of the artificial intelligence agent may be an exclusive interface between the large language model and the operating system; and secure shell access to an operating system user account under which the runtime execution layer of the artificial intelligence agent executes may be unavailable to the artificial intelligence agent. In a number of such examples, the runtime execution layer of the artificial intelligence agent may perform a binary integrity self-check at startup by computing a cryptographic hash of a binary executable of the runtime execution layer of the artificial intelligence agent; retrieving an expected hash value from the at least one blockchain network; and terminating the runtime execution layer of the artificial intelligence agent prior to executing any agent operations responsive to a lack of correspondence between the cryptographic hash and the expected hash.

In various examples, the at least one blockchain network may include multiple blockchain networks and the system may further include a chain-agnostic verification proxy that interfaces with multiple blockchain-specific adapter modules, each of the multiple blockchain-specific adapter modules implementing chain-specific verification logic for a respective blockchain network of the multiple blockchain networks and presenting a unified verification interface to the enforcement proxy regardless of which of the multiple blockchain networks stores the permission access token. In some such examples, the multiple blockchain networks may include at least two of a public blockchain network; a private blockchain network; a permissioned blockchain network; and a hybrid blockchain network including both public and private components; wherein each of the multiple blockchain networks supports non-fungible digital asset creation with metadata encoding capability. In a number of such examples, the permission schema encoded in the permission access token may have an identical format in the multiple blockchain networks. In various such examples, the multiple blockchain networks may include at least one private blockchain network or permissioned blockchain network that operates a consensus mechanism among a defined set of validator nodes and the chain-specific verification logic implemented by a blockchain-specific adapter module for the at least one private blockchain network or permissioned blockchain network of the multiple blockchain-specific adapter modules includes authentication with an access control layer of the at least one private blockchain network or permissioned blockchain network. In a number of such examples, the multiple blockchain networks may include a hybrid blockchain architecture in which permission access token minting and revocation transactions are recorded on a public blockchain network and permission schema content and verification events are recorded on a private blockchain network or a permissioned blockchain network.

In some examples, the system may further include a hierarchical delegation module that receives, from a first permission access token holder, a delegation request specifying a subset of a first permission schema of a first permission access token; mints a second permission access token encoding the subset of the permission schema of the first permission access token as a delegated permission schema, the second permission access token further encoding a reference to the first permission access token as a parent token identifier; transfers the second permission access token to a second agent wallet address of a second artificial intelligence agent; and enforces that the delegated permission schema of the second permission access token is a strict subset of the first permission schema of the first permission access token. In various such examples, the hierarchical delegation module may implement cascading revocation where revocation of the first permission access token invalidates the second permission access token and any further descendant permission access tokens in a delegation chain.

In a number of examples, the permission schema may further encode temporal constraints including at least one of a time-of-day restriction specifying hours during which the permission access token is valid; a day-of-week restriction specifying days during which the permission access token is valid; and a temporal window defining a start time and end time between which the permission access token is active; wherein the enforcement proxy denies the request responsive to a timestamp source independent of the artificial intelligence agent indicating that a current time is outside the temporal constraints. In various examples, the permission schema may further encode geographic constraints or jurisdictional constraints specifying at least one of permitted jurisdictions from which data may be accessed; data residency requirements restricting where response data may be processed or stored; and network origin restrictions specifying permitted IP address ranges or geographic regions; wherein the enforcement proxy denies the request responsive to a violation of the geographic constraints or the jurisdictional constraints. In some examples, the artificial intelligence agent may be associated with permission access tokens issued by different issuing authorities; the enforcement proxy may compute an effective permission scope by applying a composition policy to the permission access tokens, the composition policy being one of an intersection policy or a union policy, and authorization events may be recorded against a respective permission access token of the permission access tokens. In a number of examples, the system may further include a privacy-preserving verification module that generates a zero-knowledge proof demonstrating that the permission access token authorizes a specific requested action and verifies the zero-knowledge proof at the enforcement proxy to authorize the request or deny the request based at least on the validity of the zero-knowledge proof.

In various examples, the system may further include a cached verification module that stores, in a local cache at the enforcement proxy, a time-bounded verification result including a cached permission schema and a time-to-live value, the time-to-live value being set by an issuing authority and being non-modifiable by the artificial intelligence agent; for subsequent requests within the time-to-live value, authorizes the request or denies the request based at least on the cached permission schema without querying the blockchain network; and invalidates the cached verification result responsive to receipt of a revocation event from the blockchain network or expiration of the time-to-live value. In some examples, the artificial intelligence agent may spawn one or more sub-agents and the system may further include a cross-agent permission inheritance module that derives, from a spawning agent permission access token of the artificial intelligence agent, a respective sub-agent permission access token for each of the one or more sub-agents, the respective sub-agent permission access token encoding a subset permission schema that is a subset of a spawning agent permission schema of the artificial intelligence agent; links the respective sub-agent permission access token to the spawning agent permission access token via a parent token reference on the blockchain network; and records, in the audit module, a linked audit trail associating actions of each of the one or more sub-agents with the spawning agent's permission access token.

In some examples, the system may further include a large language model-powered permission parsing module that receives a natural language description of permissions from an administrator; processes the natural language description using a large language model to generate a structured permission schema in a machine-readable format; and encodes the structured permission schema into the permission access token on the at least one blockchain network. In various such examples, the large language model-powered permission parsing module may present the structured permission schema to the administrator prior to encoding the structured permission schema into the permission access token.

In a number of examples, the permission schema may be stored on-chain within the permission access token on the at least one blockchain network and off-chain at off-chain storage associated with the at least one protected resource; wherein the enforcement proxy denies the request responsive to lack of correspondence between the permission schema stored on-chain and the permission schema stored off-chain. In some such examples, the permission schema stored on-chain may be updatable independently of the permission schema stored off-chain.

In various examples, the system may further include an atomic reissue module that updates the permission schema by executing an atomic transaction group on the at least one blockchain network, the atomic transaction group including a revocation transaction revoking the existing permission access token and a minting transaction minting a new permission access token encoding an updated permission schema. In some examples, the enforcement proxy may deny the request responsive to any of the at least one blockchain network being unreachable; a failure to find the permission access token on the at least one blockchain network or of the signature challenge-response verification; a parse error in the permission schema; or an unexpected error condition. In a number of examples, the at least one blockchain network may support a native clawback mechanism and the system may further include an instant revocation module that revokes the permission access token by executing a clawback transaction that transfers the permission access token from the agent wallet address to an issuer address, the clawback transaction being executable without consent of the artificial intelligence agent. In various examples, for each of the authorization events the audit module may create recorded authorization events by recording at least an actor identity; a timestamp attested by the at least one blockchain network; an action description; and a result indication; wherein the recorded authorization events are independently verifiable by a third party having access to the at least one blockchain network without requiring records from an operator of the system. In a number of examples, the enforcement proxy may be deployable in a plugin mode where the enforcement proxy operates as a middleware layer external to a runtime environment of the artificial intelligence agent or a kernel mode where a token verification module is embedded within the runtime environment of the artificial intelligence agent; wherein the permission access token format and the permission schema are identical in both the plugin mode and the kernel mode.

In some implementations, a method for authorizing actions of an artificial intelligence agent may include minting a permission access token as a non-fungible digital asset on a blockchain network, the permission access token encoding a permission schema defining a scope of authorized actions and an agent session identifier cryptographically bound to the permission access token by a digital signature; transferring the permission access token to an agent wallet address associated with a session of the artificial intelligence agent; intercepting, at an enforcement proxy interposed between the artificial intelligence agent and one or more protected resources, a request from the artificial intelligence agent directed to at least one of the one or more protected resources; verifying, by the enforcement proxy via the blockchain network, that the agent wallet address is associated with the permission access token and that the agent session identifier corresponds to the session of the artificial intelligence agent; determining, by the enforcement proxy, whether the request is within the scope of authorized actions defined by the permission schema; responsive to successful verification and the request being within the scope of authorized actions, authorizing the request and forwarding the request to the at least one of the one or more protected resources; responsive to failed verification or the request being outside the scope of authorized actions, denying the request; and recording the verifying and the authorizing as at least one immutable transaction on the blockchain network.

In various examples, the method may further include applying, by the enforcement proxy, hard enforcement data rules to the request and a response from the at least one of the one or more protected resources, the hard enforcement data rules being applied at the enforcement proxy external to the artificial intelligence agent and being non-bypassable by the artificial intelligence agent and injecting, by the enforcement proxy, soft enforcement behavioral directives into an artificial intelligence agent response prior to providing the artificial intelligence agent response to the artificial intelligence agent. In a number of such examples, applying the hard enforcement data rules may include at least one of filtering fields from the response from the at least one of the one or more protected resources according to a field-level filter specification; redacting data from the response matching one or more redaction patterns; denying the request responsive to a specified recipient being on a blocked recipients list or not on an allowed recipients list; and denying the request responsive to a rate limit being exceeded.

In some examples, the method may further include intercepting, at a token verification module embedded within a runtime execution layer of the artificial intelligence agent, tool calls generated by a large language model of the artificial intelligence agent; for each respective tool call of the tool calls, performing on-chain verification of the permission access token prior to execution of the respective tool call; and denying the respective tool call responsive to the on-chain verification failing. In various such examples, the method may further include at startup of the runtime execution layer of the artificial intelligence agent, computing a cryptographic hash of a binary executable of the runtime execution layer of the artificial intelligence agent; retrieving an expected hash value from the blockchain network; and terminating the runtime execution layer of the artificial intelligence agent prior to executing any agent operations responsive to the cryptographic hash not corresponding to the expected hash.

In a number of examples, the method may further include receiving, from an administrator, a natural language description of permissions; processing the natural language description using a large language model to generate a structured permission schema; and encoding the structured permission schema into the permission access token on the blockchain network. In various examples, the method may further include storing the permission schema on-chain within the permission access token and off-chain at an off-chain storage associated with the at least one of the one or more protected resources and denying the request responsive to the permission schema stored on-chain not corresponding to the permission schema stored off-chain. In some examples, the method may further include updating the permission schema by executing an atomic transaction group on the blockchain network including a revocation of the permission access token and a minting of a new permission access token encoding an updated permission schema. In a number of examples, the method may further include denying the request responsive to the blockchain network being unreachable. In various examples, the method may further include revoking the permission access token by executing a clawback transaction on the blockchain network that transfers the permission access token from the agent wallet address to an issuer address without consent of the artificial intelligence agent.

In a number of implementations, a non-transitory computer-readable medium may store instructions that, when executed by one or more processors, cause the one or more processors to mint a permission access token as a non-fungible digital asset on a blockchain network, the permission access token encoding a permission schema defining a scope of authorized actions for an artificial intelligence agent and an agent session identifier cryptographically bound to the permission access token by a digital signature; intercept a request from the artificial intelligence agent directed to a protected resource; verify, via the blockchain network, that the permission access token is associated with a session of the artificial intelligence agent and that the agent session identifier corresponds to the session of the artificial intelligence agent; apply a hard enforcement layer that enforces data rules at a proxy layer external to the artificial intelligence agent, the data rules being non-bypassable by the artificial intelligence agent; apply a soft enforcement layer that injects behavioral directives to the artificial intelligence agent; authorize or deny the request based at least on the permission schema and verifying that the permission access token is associated with the session of the artificial intelligence agent and that the agent session identifier corresponds to the session of the artificial intelligence agent; and record authorization of the request as an immutable transaction on the blockchain network.

In various examples, execution of the instructions by the one or more processors may further cause the one or more processors to embed a token verification module within a runtime execution layer of the artificial intelligence agent to cause tool calls generated by a large language model of the artificial intelligence agent to pass through on-chain token verification prior to execution and the artificial intelligence agent operates in a sandboxed environment lacking direct operating system access. In some examples, execution of the instructions by the one or more processors may further cause the one or more processors to receive a natural language description of permissions from an administrator; process the natural language description using a large language model to generate the permission schema; and encode the permission schema into the permission access token. In a number of examples, execution of the instructions by the one or more processors may further cause the one or more processors to deny the request responsive to occurrence of a failure condition that includes the blockchain network being unreachable or inability to find the permission access token; a signature verification failure; or a parse error in the permission schema.

In various implementations, a system for maintaining tamper-proof integrity of electronic records using blockchain tokenization may include an encryption module configured to encrypt an electronic document; a hashing module configured to compute a hash of the electronic document; a signature module configured to generate, using a submitting party key pair of a submitting party, a submitter signature and the hash of the electronic document and generate, using an authorized receiving party key pair of an authorized receiving party, an authorized submitter signature and the hash of the electronic document; and a tokenization module configured to mint a blockchain token on a blockchain network, the blockchain token encoding at least one of the hash of the electronic document, the submitter signature, the authorized submitter signature, a block timestamp attested by consensus of the blockchain network, and a record type classification.

In some examples, the system may further include a verification module configured to retrieve the blockchain token from the blockchain network; decrypt the electronic document; compute a computed hash of the decrypted document; compare the computed hash of the decrypted document to the hash of the electronic document encoded in the blockchain token; and output a verification result indicating whether the electronic document has been modified since tokenization. In a number of examples, the block timestamp may be derived from a consensus mechanism of the blockchain network. In various examples, the record type classification may be one of a death certificate; a financial statement; a medical record; a legal filing; or a regulatory submission. In some examples, the blockchain token, the submitter signature, and the authorized submitter signature may collectively establish a chain of custody that is independently verifiable by a third party having access to the blockchain network.

Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to blockchain-authenticated dynamic authorization for AI agents. The blockchain-authenticated dynamic authorization may combine cryptographic session binding, dual-layer enforcement architecture, kernel-level runtime integration, multi-chain token verification across public, private, and hybrid blockchain networks, LLM-powered permission parsing, dual verification requirements, atomic token reissue, fail-closed operation, hierarchical delegation, temporal and geographic permission scoping, permission composition, privacy-preserving verification, and/or cross-agent permission inheritance.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A system for authorizing actions of an artificial intelligence agent, the system comprising:
a permission access token stored as a non-fungible digital asset on at least one blockchain network, the permission access token encoding a permission schema defining a scope of authorized actions for the artificial intelligence agent, the permission access token further encoding an agent session identifier and an agent wallet address, the agent session identifier being cryptographically bound to the permission access token by a digital signature such that the permission access token is non-transferable to a different agent session;
an enforcement proxy interposed between the artificial intelligence agent and one or more protected resources that:
intercepts a request from the artificial intelligence agent directed to at least one of the one or more protected resources;
verifies, via the at least one blockchain network, that the agent wallet address is associated with a current session of the artificial intelligence agent associated with the permission access token;
verifies that the agent session identifier encoded in the permission access token corresponds to the current session of the artificial intelligence agent by performing a signature challenge-response verification;
determines whether the request is within the scope of authorized actions defined by the permission schema;
authorizes the request at least when the agent wallet address is associated with the current session of the artificial intelligence agent associated with the permission access token, the agent session identifier encoded in the permission access token corresponds to the current session of the artificial intelligence agent, and the request is within the scope of authorized actions defined by the permission schema; and
denies the request at least when the agent wallet address is not associated with the current session of the artificial intelligence agent associated with the permission access token, the agent session identifier encoded in the permission access token does not correspond to the current session of the artificial intelligence agent, or the request is not within the scope of authorized actions defined by the permission schema; and
an audit module that records verification events and authorization events as an immutable transactions on the at least one blockchain network.

2. The system of claim 1, wherein the enforcement proxy implements:
a hard enforcement layer that enforces data rules at the enforcement proxy external to the artificial intelligence agent, the data rules being non-bypassable by the artificial intelligence agent; and
a soft enforcement layer that injects behavioral directives into data responses provided to the artificial intelligence agent.

3. The system of claim 2, wherein the data rules of the hard enforcement layer comprise at least one of:
field-level return filtering specifying fields to include or exclude from the data responses;
redaction patterns applied to the data responses;
an allowed recipients list limiting recipients to which the artificial intelligence agent may direct communications;
a blocked recipients list prohibiting the artificial intelligence agent from directing communications to specified recipients;
rate limits specifying a maximum number of requests within a defined time window; or
a maximum results threshold limiting a quantity of records returned in a single response.

4. The system of claim 2, wherein the behavioral directives of the soft enforcement layer comprise at least one of:
a purpose statement defining an authorized purpose for use of accessed data by the artificial intelligence agent;
an allowed behaviors list specifying permitted actions;
a forbidden behaviors list specifying prohibited actions;
a disclosure text requirement for inclusion in agent-generated output; or
an audit level specification.

5. The system of claim 2, wherein the data rules of the hard enforcement layer are enforced at the enforcement proxy.

6. The system of claim 1, further comprising a token verification module embedded within a runtime execution layer of the artificial intelligence agent that:
intercepts tool calls generated by a large language model of the artificial intelligence agent; and
performs on-chain verification of the permission access token prior to execution of the tool calls.

7. The system of claim 6, wherein the tool calls intercepted by the token verification module comprise at least one of:
a file read operation;
a file write operation;
a shell command execution;
a network request;
a message transmission;
a browser control action; and
a sub-agent spawning.

8. The system of claim 6, wherein the artificial intelligence agent operates in a sandboxed environment in which:
the large language model lacks direct access to an operating system of a host computing device;
the runtime execution layer of the artificial intelligence agent is an exclusive interface between the large language model and the operating system; and
secure shell access to an operating system user account under which the runtime execution layer of the artificial intelligence agent executes is unavailable to the artificial intelligence agent.

9. The system of claim 6, wherein the runtime execution layer of the artificial intelligence agent performs a binary integrity self-check at startup by:
computing a cryptographic hash of a binary executable of the runtime execution layer of the artificial intelligence agent;
retrieving an expected hash value from the at least one blockchain network; and
terminating the runtime execution layer of the artificial intelligence agent prior to executing any agent operations responsive to a lack of correspondence between the cryptographic hash and the expected hash value.

10. The system of claim 1, wherein:
the at least one blockchain network comprises multiple blockchain networks, and
the system further comprises a chain-agnostic verification proxy that:
interfaces with multiple blockchain-specific adapter modules, each of the multiple blockchain-specific adapter modules implementing chain-specific verification logic for a respective blockchain network of the multiple blockchain networks; and
presents a unified verification interface to the enforcement proxy regardless of which of the multiple blockchain networks stores the permission access token.

11. The system of claim 10, wherein the multiple blockchain networks comprise at least two of:
a public blockchain network;
a private blockchain network;
a permissioned blockchain network; and
a hybrid blockchain network comprising both public and private components;
wherein each of the multiple blockchain networks supports non-fungible digital asset creation with metadata encoding capability.

12. The system of claim 10, wherein the permission schema encoded in the permission access token has an identical format in the multiple blockchain networks.

13. The system of claim 10, wherein:
the multiple blockchain networks comprise at least one private blockchain network or permissioned blockchain network that operates a consensus mechanism among a defined set of validator nodes; and
the chain-specific verification logic implemented by a blockchain-specific adapter module for the at least one private blockchain network or permissioned blockchain network of the multiple blockchain-specific adapter modules includes authentication with an access control layer of the at least one private blockchain network or permissioned blockchain network.

14. The system of claim 10, wherein the multiple blockchain networks comprise a hybrid blockchain architecture in which:
permission access token minting and revocation transactions are recorded on a public blockchain network; and
permission schema content and verification events are recorded on a private blockchain network or a permissioned blockchain network.

15. The system of claim 1, further comprising a hierarchical delegation module that:
receives, from a first permission access token holder, a delegation request specifying a subset of a first permission schema of a first permission access token;
mints a second permission access token encoding the subset of the permission schema of the first permission access token as a delegated permission schema, the second permission access token further encoding a reference to the first permission access token as a parent token identifier;
transfers the second permission access token to a second agent wallet address of a second artificial intelligence agent; and
enforces that the delegated permission schema of the second permission access token is a strict subset of the first permission schema of the first permission access token.

16. The system of claim 15, wherein the hierarchical delegation module implements cascading revocation where revocation of the first permission access token invalidates the second permission access token and any further descendant permission access tokens in a delegation chain.

17. The system of claim 1, wherein the permission schema further encodes temporal constraints comprising at least one of:
a time-of-day restriction specifying hours during which the permission access token is valid;
a day-of-week restriction specifying days during which the permission access token is valid; and
a temporal window defining a start time and an end time between which the permission access token is active;
wherein the enforcement proxy denies the request responsive to a timestamp source independent of the artificial intelligence agent indicating that a current time is outside the temporal constraints.

18. The system of claim 1, wherein the permission schema further encodes geographic constraints or jurisdictional constraints specifying at least one of:
permitted jurisdictions from which data may be accessed;
data residency requirements restricting where response data may be processed or stored; and
network origin restrictions specifying permitted IP address ranges or geographic regions;
wherein the enforcement proxy denies the request responsive to a violation of the geographic constraints or the jurisdictional constraints.

19. The system of claim 1, wherein:
the artificial intelligence agent is associated with permission access tokens issued by different issuing authorities;
the enforcement proxy computes an effective permission scope by applying a composition policy to the permission access tokens, the composition policy being one of:
an intersection policy; or
a union policy; and
authorization events are recorded against a respective permission access token of the permission access tokens.

20. The system of claim 1, further comprising a privacy-preserving verification module that:
generates a zero-knowledge proof demonstrating that the permission access token authorizes a specific requested action; and
verifies the zero-knowledge proof at the enforcement proxy to authorize the request or deny the request based at least on the validity of the zero-knowledge proof.

21. The system of claim 1, further comprising a cached verification module that:
stores, in a local cache at the enforcement proxy, a time-bounded verification result comprising a cached permission schema and a time-to-live value, the time-to-live value being set by an issuing authority and being non-modifiable by the artificial intelligence agent;
for subsequent requests within the time-to-live value, authorizes the request or denies the request based at least on the cached permission schema without querying the at least one blockchain network; and
invalidates the cached time-bounded verification result responsive to receipt of a revocation event from the blockchain network or expiration of the time-to-live value.

22. The system of claim 1, wherein:
the artificial intelligence agent spawns one or more sub-agents; and
the system further comprises a cross-agent permission inheritance module that:
derives, from a spawning agent permission access token of the artificial intelligence agent, a respective sub-agent permission access token for each of the one or more spawned sub-agents, the respective sub-agent permission access token encoding a subset permission schema that is a subset of a spawning agent permission schema of the spawning artificial intelligence agent;
links the respective sub-agent permission access token to the spawning agent permission access token via a parent token reference on the blockchain network; and
records, in the audit module, a linked audit trail associating actions of each of the one or more spawned sub-agents with the spawning agent's permission access token.

23. The system of claim 1, further comprising a large language model-powered permission parsing module that:
receives a natural language description of permissions from an administrator;
processes the natural language description using a large language model to generate a structured permission schema in a machine-readable format; and
encodes the structured permission schema into the permission access token on the at least one blockchain network.

24. The system of claim 23, wherein the large language model-powered permission parsing module presents the structured permission schema to the administrator prior to encoding the structured permission schema into the permission access token.

25. The system of claim 1, wherein the permission schema is stored:
on-chain within the permission access token on the at least one blockchain network; and
off-chain at off-chain storage associated with the at least one of the one or more protected resource;
wherein the enforcement proxy denies the request responsive to lack of correspondence between the permission schema stored on-chain and the permission schema stored off-chain.

26. The system of claim 25, wherein the permission schema stored on-chain is updatable independently of the permission schema stored off-chain.

27. The system of claim 1, further comprising an atomic reissue module that updates the permission schema by executing an atomic transaction group on the at least one blockchain network, the atomic transaction group comprising:
a revocation transaction revoking an existing permission access token; and
a minting transaction minting a new permission access token encoding an updated permission schema.

28. The system of claim 1, wherein the enforcement proxy denies the request responsive to any of:
the at least one blockchain network being unreachable;
a failure to find the permission access token on the at least one blockchain network or of the signature challenge-response verification;
a parse error in the permission schema; or
an unexpected error condition.

29. The system of claim 1, wherein:
the at least one blockchain network supports a native clawback mechanism, and
the system further comprises an instant revocation module that revokes the permission access token by executing a clawback transaction that transfers the permission access token from the agent wallet address to an issuer address, the clawback transaction being executable without consent of the artificial intelligence agent.

30. The system of claim 1, wherein for each of the authorization events the audit module creates recorded authorization events by recording at least:
an actor identity;
a timestamp attested by the at least one blockchain network;
an action description; and
a result indication;
wherein the recorded authorization events are independently verifiable by a third party having access to the at least one blockchain network without requiring records from an operator of the system.

31. The system of claim 1, wherein the enforcement proxy is deployable in:
a plugin mode where the enforcement proxy operates as a middleware layer external to a runtime environment of the artificial intelligence agent; or
a kernel mode where a token verification module is embedded within the runtime environment of the artificial intelligence agent;
wherein a permission access token format and the permission schema are identical in both the plugin mode and the kernel mode.

32. A method for authorizing actions of an artificial intelligence agent, the method comprising:
minting a permission access token as a non-fungible digital asset on a blockchain network, the permission access token encoding a permission schema defining a scope of authorized actions and an agent session identifier cryptographically bound to the permission access token by a digital signature;
transferring the permission access token to an agent wallet address associated with a session of the artificial intelligence agent;
intercepting, at an enforcement proxy interposed between the artificial intelligence agent and one or more protected resources, a request from the artificial intelligence agent directed to at least one of the one or more protected resources;
verifying, by the enforcement proxy via the blockchain network, that the agent wallet address is associated with the permission access token and that the agent session identifier corresponds to the session of the artificial intelligence agent;
determining, by the enforcement proxy, whether the request is within the scope of authorized actions defined by the permission schema;
responsive to successful verification and the request being within the scope of authorized actions, authorizing the request and forwarding the request to the at least one of the one or more protected resources;
responsive to failed verification or the request being outside the scope of authorized actions, denying the request; and
recording the verifying and the authorizing as at least one immutable transaction on the blockchain network.

33. The method of claim 32, further comprising:
applying, by the enforcement proxy, hard enforcement data rules to the request and a response from the at least one of the one or more protected resources, the hard enforcement data rules being applied at the enforcement proxy external to the artificial intelligence agent and being non-bypassable by the artificial intelligence agent; and
injecting, by the enforcement proxy, soft enforcement behavioral directives into an artificial intelligence agent response prior to providing the artificial intelligence agent response to the artificial intelligence agent.

34. The method of claim 33, wherein applying the hard enforcement data rules comprises at least one of:
filtering fields from the response from the at least one of the one or more protected resources according to a field-level filter specification;
redacting data from the response matching one or more redaction patterns;
denying the request responsive to a specified recipient being on a blocked recipients list or not on an allowed recipients list; and
denying the request responsive to a rate limit being exceeded.

35. The method of claim 32, further comprising:
intercepting, at a token verification module embedded within a runtime execution layer of the artificial intelligence agent, tool calls generated by a large language model of the artificial intelligence agent;
for each respective tool call, performing on-chain verification of the permission access token prior to execution of the respective tool call; and
denying the respective tool call responsive to the on-chain verification failing.

36. The method of claim 35, further comprising:
at startup of the runtime execution layer of the artificial intelligence agent, computing a cryptographic hash of a binary executable of the runtime execution layer of the artificial intelligence agent;
retrieving an expected hash value from the blockchain network; and
terminating the runtime execution layer of the artificial intelligence agent prior to executing any agent operations responsive to the cryptographic hash not corresponding to the expected hash.

37. The method of claim 32, further comprising:
receiving, from an administrator, a natural language description of permissions;
processing the natural language description using a large language model to generate a structured permission schema; and
encoding the structured permission schema into the permission access token on the blockchain network.

38. The method of claim 32, further comprising:
storing the permission schema on-chain within the permission access token and off-chain at an off-chain storage associated with the at least one of the one or more protected resources;
and denying the request responsive to the permission schema stored on-chain not corresponding to the permission schema stored off-chain.

39. The method of claim 32, further comprising updating the permission schema by executing an atomic transaction group on the blockchain network comprising:
a revocation of the permission access token; and
a minting of a new permission access token encoding an updated permission schema.

40. The method of claim 32, further comprising denying the request responsive to the blockchain network being unreachable.

41. The method of claim 32, further comprising revoking the permission access token by executing a clawback transaction on the blockchain network that transfers the permission access token from the agent wallet address to an issuer address without consent of the artificial intelligence agent.

42. A non-transitory computer-readable medium storing instructions that, when executed by one or more processors, cause the one or more processors to:
mint a permission access token as a non-fungible digital asset on a blockchain network, the permission access token encoding a permission schema defining a scope of authorized actions for an artificial intelligence agent and an agent session identifier cryptographically bound to the permission access token by a digital signature;
intercept a request from the artificial intelligence agent directed to a protected resource;
verify, via the blockchain network, that the permission access token is associated with a session of the artificial intelligence agent and that the agent session identifier corresponds to the session of the artificial intelligence agent;
apply a hard enforcement layer that enforces data rules at a proxy layer external to the artificial intelligence agent, the data rules being non-bypassable by the artificial intelligence agent;
apply a soft enforcement layer that injects behavioral directives to the artificial intelligence agent;
authorize or deny the request based at least on the permission schema and verifying that the permission access token is associated with the session of the artificial intelligence agent and that the agent session identifier corresponds to the session of the artificial intelligence agent; and
record authorization of the request as an immutable transaction on the blockchain network.

43. The non-transitory computer-readable medium of claim 42, wherein:
execution of the instructions by the one or more processors further causes the one or more processors to embed a token verification module within a runtime execution layer of the artificial intelligence agent to cause tool calls generated by a large language model of the artificial intelligence agent to pass through an on-chain token verification prior to execution; and
the artificial intelligence agent operates in a sandboxed environment lacking direct operating system access.

44. The non-transitory computer-readable medium of claim 42, wherein execution of the instructions by the one or more processors further causes the one or more processors to:
receive a natural language description of permissions from an administrator;
process the natural language description using a large language model to generate the permission schema; and
encode the permission schema into the permission access token.

45. The non-transitory computer-readable medium of claim 42, wherein execution of the instructions by the one or more processors further causes the one or more processors to deny the request responsive to occurrence of a condition that includes:
the blockchain network being unreachable;
a failure to find the permission access token;
a signature verification failure; or
a parse error in the permission schema.

46. A system for maintaining tamper-proof integrity of electronic records using blockchain tokenization, comprising:
an encryption module configured to encrypt an electronic document;
a hashing module configured to compute a hash of the electronic document;
a signature module configured to:
generate, using a submitting party key pair of a submitting party, a submitter signature and the hash of the electronic document; and
generate, using an authorized receiving party key pair of an authorized receiving party, an authorized submitter signature and the hash of the electronic document; and
a tokenization module configured to mint a blockchain token on a blockchain network, the blockchain token encoding at least one of the hash of the electronic document, the submitter signature, the authorized submitter signature, a block timestamp attested by consensus of the blockchain network, and a record type classification.

47. The system of claim 46, further comprising a verification module configured to:
retrieve the blockchain token from the blockchain network;
decrypt the electronic document;
compute a computed hash of the decrypted document;
compare the computed hash of the decrypted document to the hash of the electronic document encoded in the blockchain token; and
output a verification result indicating whether the electronic document has been modified since tokenization.

48. The system of claim 47, wherein the block timestamp is derived from a consensus mechanism of the blockchain network.

49. The system of claim 47, wherein the record type classification is one of:
a death certificate;
a financial statement;
a medical record;
a legal filing; or
a regulatory submission.

50. The system of claim 47, wherein the blockchain token, the submitter signature, and the authorized submitter signature collectively establish a chain of custody that is independently verifiable by a third party having access to the blockchain network.
